(19) United States
(12) Patent Application Publication
(10) Pub. No.: US 2002/0109879 A1
(43) Pub. Date: Aug. 15, 2002

(54) Co-channel modulation

(76) Inventor: John Ling Wing So, Plano, TX (US)

Correspondence Address: TEXAS INSTRUMENTS INCORPORATED, P O BOX 655474, M/S 3999, DALLAS, TX, 75265

(21) Appl. No.: 09/938,220

(22) Filed: Aug. 23, 2001

Related U.S. Application Data
(60) Provisional application No. 60/227,325, filed on Aug. 23, 2000.

(51) Int. Cl. H04B 10/20; H04J 14/00; H04J 14/02

(52) U.S. Cl. 359/118; 359/124

(57) ABSTRACT

A method and system for providing network configuration and control information. The configuration and control information is encoded and used to modulate the data-carrying optical signal. Later network elements demodulate and decode the data to determine configuration and control commands and requests. A method of providing network configuration data comprises receiving a data-carrying optical signal; providing control information; modulating the data-carrying optical signal using the control information such that the optical signal carries both the data and the control information; and transmitting the modulated optical signal. A spatial light modulator, typically a micromirror array, may be used to modulate the optical signal.

### FIELD OF THE INVENTION

This invention relates to the field of optical communication systems, more particularly to methods of providing configuration and control data to dynamic communications systems.

### BACKGROUND OF THE INVENTION

The need for higher and higher speed data transmissions is heightening demand for new technologies in optical networking that optimize performance. Over the last two years, DWDM (Dense Wavelength Division Multiplexing) has proven to be a cost-effective means of increasing the bandwidth of installed fiber plant. While the technology originally only served to increase the size of the fiber spans, it is quickly becoming the foundation for networks that will offer customers a new class of high-bandwidth and broadband capabilities.

Sales of DWDM systems were expected to reach $6 billion in North America by the end of 2000. This revenue roughly translates into tens of thousands of wavelengths deployed within optical networks, either as point-to-point connections or in ring topologies. In addition, several millions of wavelengths are projected to be deployed in enterprise, metropolitan, regional, and long haul networks by 2007 in the United States alone.

These wavelengths will require routing, add/drop, and protection functions, which can only be achieved through the implementation of network-wide management and monitoring capabilities. Current-generation DWDM networks is monitored, managed and protected within the digital domain, using SONET and its associated support systems. However, to leverage the full potential of wavelength-based networking, the provisioning, switching, management and monitoring functions have to move from the digital domain to the optical domain. Efficiently managing (e.g., adding, dropping, routing, protecting, and restoring) the growing number of traffic-bearing wavelengths can only be achieved through a new breed of optical networking element. This network element is the optical switch that includes the optical Add/Drop Multiplexer. Along with the optical switch come the issues of wavelength (Lambda) switching, optical amplifier gain and transient power control.

Optical switching is the next logical step in a long history of switching technology that started with manual “plug board” operators, evolved to mechanical crossbar and finally digital switching. Optical switching will enable transparent optical networks. Optical networks will greatly simplify the architecture of both the network and the network nodes by establishing end-to-end optical paths across the network. An end-to-end optical path behaves as a transparent “clear channel”, so that there is virtually nothing in the path to limit the throughput of the fibers. What is needed is a method and system to configure and control optical communication networks that provides flexibility for the future while supporting legacy systems and components.

### SUMMARY OF THE INVENTION

A method and system for providing network configuration and control information. The configuration and control information is encoded and used to modulate the data-carrying optical signal. Later network elements demodulate and decode the data to determine configuration and control commands and requests. According to one embodiment of the present invention, a method of providing network configuration data is provided. The method comprises receiving a data-carrying optical signal; providing control information; modulating the data-carrying optical signal using the control information such that the optical signal carries both the data and the control information; and transmitting the modulated optical signal. A spatial light modulator, typically a micromirror array, may be used to modulate the optical signal.

### BRIEF DESCRIPTION OF THE DRAWINGS

FIG. 1 is a schematic diagram of an optical network with typical switching network elements.

FIG. 2 is a schematic diagram of an optical network node comprised of an IP Router and an optical cross-connect switch.

FIG. 3 is a schematic diagram of an optical network for IP and OXC data.

FIG. 4 is a schematic diagram of an embodiment of an addressing scheme in an optical network.

FIG. 5 is a schematic diagram of an embodiment of an optical cross connect systems architecture.

FIG. 6 is a schematic diagram of an embodiment of a network with a TI-LSR domain surrounded by an edge set of TC-LSRs.

FIG. 7 is a diagram showing the format of a generalized request in RSVP.

FIG. 8 is a diagram showing the format of a generalized request in CR-LDP.

FIG. 9 is a diagram showing the format of a generalized label in RSVP.

FIG. 10 is a diagram showing the format of a generalized label in CR-LDP.

FIG. 11 is a diagram showing the format of a port and wavelength label.

FIG. 12 is a diagram showing the generalized label format in the context of waveband switching.

FIG. 13 is a diagram showing the format of a LabelSet in RSVP.

FIG. 14 is a diagram showing the format of a LabelSet in CR-LDP.

FIG. 15 is a schematic diagram showing label contention.

FIG. 16 is a schematic diagram showing label contention resolution without resource restrictions.

FIG. 17 is a schematic diagram showing label contention resolution with resource restrictions.

FIG. 18 is a block diagram of an optical network model.

FIG. 19 is a block diagram showing a direct interface.

FIG. 20 is a schematic diagram showing a legacy optical network model.

FIG. 21 is a block diagram showing the evolution of a DWDM network model.

FIG. 22 is a block diagram of an intelligent DWDM Software Architecture.

FIG. 23 is a block diagram showing optical lightpath modulation and signaling.

FIG. 24 is a plot showing co-channel lambda-selective data synchronization preamble and control.

FIG. 25 is a plot showing co-channel lambda-selective data synchronization and control demodulation.

FIG. 26 is a plot showing co-channel 1-out-of-n IM Modulation.

FIG. 27 is a plot showing co-channel 1-out-of-16 IM demodulation.

FIG. 28 is a plot showing co-channel 1-out-of-8 IM demodulation.

FIG. 29 is a plot showing co-channel linear hex digit demodulation.

FIG. 30 is a co-channel linear hex digit coding table.

FIG. 31 is a plot showing a return-to-zero (RZ) co-channel modulation format.

FIG. 32 is a plot showing a non-return-to-zero (NRZ) co-channel modulation format.

FIG. 33 is a schematic drawing showing a return-to-zero (RZ) co-channel modulation format.

FIG. 34 is a schematic drawing showing a non-return-to-zero (NRZ) co-channel modulation format.

FIG. 35 is a plot showing a preamble synchronizing symbol and signaling header.

FIG. 36 is a schematic diagram showing co-channel modulation and demodulation.

FIG. 37 is a schematic diagram showing co-channel modulation and demodulation for multi-lambda DWDM.

FIG. 38 is a schematic diagram showing co-channel demodulation for multi-lambda DWDM.

FIG. 39 is a block diagram showing co-channel modulation for multi-lambda DWDM.

FIG. 40 is a block diagram showing a co-channel modulation micromirror-based signaling modulator for DWDM.

FIG. 41 is a schematic view of a fiber illuminating a micromirror array.

FIG. 42 is a plot representing an acceleration algorithm for DWDM micromirror-based signaling modulator.

FIG. 43 is a schematic view showing inter-link communication with a DWDM micromirror-based signaling modulator.

FIG. 44 is a schematic view illustrating inter-link communications and supervisory control with a micromirror-based signaling modulator.

FIG. 45 is a schematic view showing the deployment of an intelligent network architecture.

FIG. 46 is a schematic view showing an optical network having optical add/drop multiplexers.

FIG. 47 is a schematic view showing an optical network having optical cross connect switches.

FIG. 48 is a schematic view showing an optical network having an intelligent wavelength router.

FIG. 49 is a schematic view showing a legacy network management system.

FIG. 50 is a schematic view showing a DSP-based intelligent laser diode controller and performance monitoring system.

FIG. 51 is a plot showing a DSP-based intelligent laser diode bias control modulation scheme.

FIG. 52 is a plot showing an expanded view of the laser diode bias control modulation.

FIG. 53 is a plot showing the aging and performance monitoring using bias control modulation.

FIG. 54 is a block diagram showing a DSP-based intelligent lambda-selective VOA PID controller.

FIG. 55 is schematic diagram showing a generic erbium-doped fiber amplifier system.

FIG. 56 is a schematic diagram showing a DSP-based erbium doped fiber amplifier control system.

FIG. 57 is a schematic diagram showing a DSP-based erbium doped fiber amplifier control system.

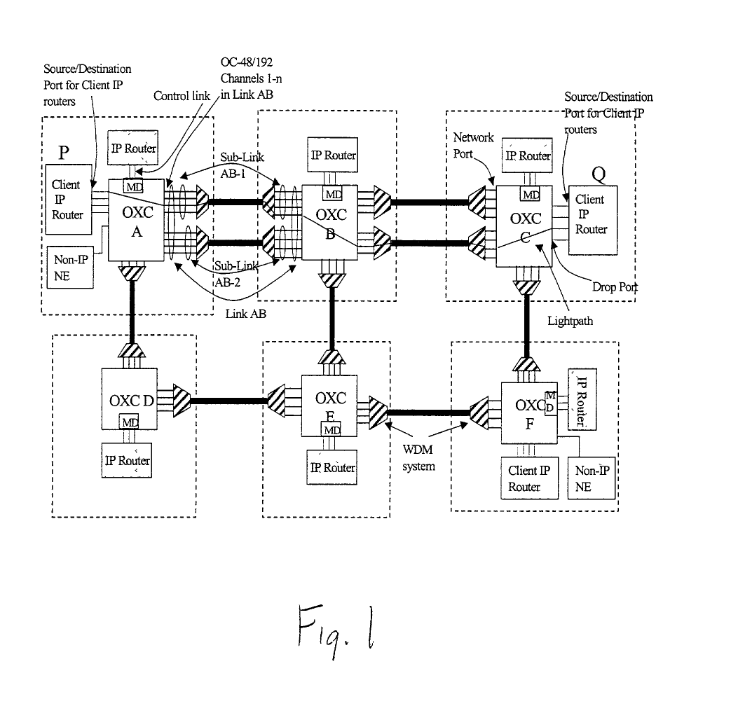

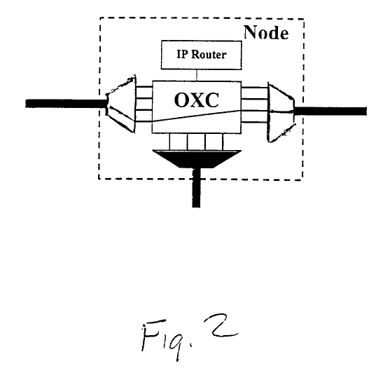

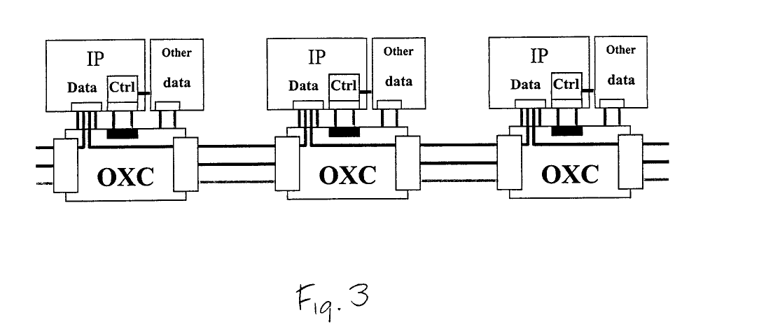

### DETAILED DESCRIPTION OF THE INVENTION

1 Optical Networking

The need for higher and higher speed data transmissions is heightening demand for new technologies in optical networking that optimize performance. Over the last two years, DWDM (Dense Wavelength Division Multiplexing) has proven to be a cost-effective means of increasing the bandwidth of installed fiber plant. While the technology originally only served to increase the size of the fiber spans, it is quickly becoming the foundation for networks that will offer customers a new class of high-bandwidth and broadband capabilities.

For the past two years, optical networking has been considered as one of the fastest growing top ten technology with the following salient features:

Technologies such as DWDM increase the capacity of a single fiber by large factors.

While Moore's law predicts the doubling of microprocessor capacity every 18 months, optical networking capacity doubles every 4.5 months primarily due to device bandwidth improvement.

Internet protocol will be transmitted directly over fiber (e.g. IP over DWDM) with wavelength routing/switching instead of packet switching.

Sales of DWDM systems were expected to reach $6 billion in North America by the end of 2000. This revenue roughly translates into tens of thousands of wavelengths deployed within optical networks, either as point-to-point connections or in ring topologies. In addition, several millions of wavelengths are projected to be deployed in enterprise, metropolitan, regional, and long haul networks by 2007 in the United States alone.

These wavelengths will require routing, add/drop, and protection functions, which can only be achieved through the implementation of network-wide management and monitoring capabilities. Current-generation DWDM networks is monitored, managed and protected within the digital domain, using SONET and its associated support systems. However, to leverage the full potential of wavelength-based networking, the provisioning, switching, management and monitoring functions have to move from the digital domain to the optical domain. Efficiently managing (e.g., adding, dropping, routing, protecting, and restoring) the growing number of traffic-bearing wavelengths can only be achieved through a new breed of optical networking element. This network element is the optical switch that includes the optical Add/Drop Multiplexer. Along with the optical switch come the issues of wavelength (Lambda) switching, optical amplifier gain and transient power control.

Optical switching is the next logical step in a long history of switching technology that started with manual “plug board” operators, evolved to mechanical crossbar and finally digital switching. Optical switching will enable transparent optical networks. Optical networks will greatly simplify the architecture of both the network and the network nodes by establishing end-to-end optical paths across the network. An end-to-end optical path behaves as a transparent “clear channel”, so that there is virtually nothing in the path to limit the throughput of the fibers.

Optical switches are often referred to as optical cross-connects (OXC). However, today's OXCs are based on electrical rather than optical switching fabrics and do not possess the optical transparency required for building optical networks in the future. Transparency implies that signals with any type of modulation schemes (analog or digital), any bit rate, and any type of format can be superimposed and transmitted without interfering with one another, and without their information being modified within the network.

Opaque networks do not have this property. A transparent channel essentially behaves like an ideal communications with almost no noise and very large bandwidth. Secondly, as the nodes in a optical network have essentially no data processing to do, they can be made extremely simple and hence very cheap. Finally, optical node simplicity also means simplicity of control and management.

The present growth, performance, and survivability requirements of the Internet (which is also becoming very mission critical) are mandating IP-centric networks to be cost effective, survivable, scalable, and to provide control capabilities that facilitate network performance optimization. Some of these requirements are being addressed by the Multi-Protocol Label Switching (MPLS) traffic engineering capabilities under development by the IETF.

The underlying optical transport network also needs to be versatile, re-configurable, cost effective, and to support a variety of protection and restoration capabilities due to the rapidly changing requirements of the Internet. A result of these trends is the evolution of optical transport networks from simple linear and ring topologies to mesh topologies. A mesh (not necessarily fully meshed) topology simply means a connected (not necessarily fully connected) network of arbitrary topology in which the node degree is typically more than two. In mesh optical networks, optical cross-connects provides versatility and re-configurability by performing switching and rearrangement functions.

Without any doubt, the next revolution in the telecommunications industry will occur within the optical domain. Now that the basic components are available to build optical networks, the most important innovations will come from adding intelligence that enables the interworking of all the network elements (Routers, ATM switches, DWDM transmission systems and optical switches). This new optical Internet infrastructure will make it possible to provision high bandwidth in seconds, turning the new optical technology into a revenue spinner for the service provider rather than just a way of saving money.

However, such an intelligent open optical network can only be built if the currently vertically layered network migrates to a horizontal model where all network elements work as peers to dynamically establish optical paths through the network. The Internet Engineering Task force (IETF) has already addressed the interworking of routers and optical switches through the Multi-Protocol Lambda Switching initiative.

Moreover, the Multi-protocol Lambda Switching initiative for simple establishment of optical paths can be expanded to include optical performance monitoring and management. The combined information that will be carried and shared between these network elements will allow the elements or element management system (EMS) to adequately assess the “health” of an optical path (which can be a wavelength or fiber strand). The routers and/or ATM switches at the edges of the optical network will then use this information to dynamically manage the millions of wavelengths available in the optical layer.

At the present time, under-scoring the importance of versatile networking capabilities in the optical domain, a number of standardization organizations and interoperability forums have initiated work items to study the requirements and architectures for re-configurable optical networks. Refer, for example, to ITU-T recommendation G.872. The Multi-Protocol Lambda Switching proposal defines a functional architecture for an optical transport network (OTN) that supports the transport of digital client signals. ITU-T G.872 refers to an OTN as “a transport network bounded by optical channel access points.” The ITU-T G.872 OTN architecture is based on a layered structure, which includes:

(a) an optical channel (OCh) layer network,

(b) an optical multiplex section (OMS) layer network, and

(c) an optical transmission section (OTS) layer network.

The optical channel layer network supports end-to-end networking of optical channel trails between access points. The OCh layer network provides the following functions: routing, monitoring, grooming, and protection and restoration of optical channels. In this situation, programmable optical cross-connects, with.

Re-arrangeable switch fabrics and relatively smart control planes, will be critical to the realization of the OCh layer functions, especially in mesh optical networks. In the data network domain, routing, monitoring, and survivability are crucial functions performed by the MPLS traffic engineering control plane.

Although we mention the ITU-T recommendation G.872, the OXC control plane design approach described here is not restricted to G.872 compliant networks. Instead, it can be applied to any mesh optical network that uses programmable and re-configurable OXCs. Other standards organizations and interoperability forums that are actively pursuing projects related to dynamically re-configurable optical networks include the ANSI T1X1.5 committee, the Optical Internetworking Forum (OIF), and now by virtue of this memo the IETF. Recent contributions to ANSI T1X1.5 emphasize the need for automation of the OCh layer network by using appropriate signaling protocols to establish optical channels in real time. The Optical Internetworking Forum (http://www.oiforum.com), an international organization engaged in the development and promotion of interoperability agreements for optical internetworking systems, is also evaluating architectural options related to re-configurable optical internetworks.

At a technical meeting held in California on Oct. 19, 1999, the Architecture Working Group of the OIF adopted a motion to define requirements for signaling protocols that allow rapid provisioning and efficient restoration in optical internetworking systems. In all these cases, the successful realization of the vision of versatile optical networking depends very much on the synthesis of appropriate control plane technologies with programmable and re-configurable OXCs. In addition to ITU-T Recommendation G.872, there is presently a draft for a new ITU-T Recommendation G.709. where as G.872 is for the architecture of optical transport networks, G.709 serves as the network node interface for the optical transport networks.

It is for the purpose of implementation of intelligent or smart optical layer and it's associated software (e.g. programmable) stack, Texas Instruments will introduce its Digital Signal Processor (DSP) solutions for optical networking. It is not an easy task to introduce DSP to such a diverse discipline as optical networking. Section 1 of this document gives an introduction to the fast changing field of optical networking.

2 Control of Lightpaths in Optical Networks

2.1 Introduction

This section describes the basics of DWDM (Dense Wavelength Division Multiplexing) for optical bandwidth management in a dynamically re-configurable optical network. This type high-level control function can be easily provided by the Generalized MPLS (Multi-Protocol Label Switching) protocol described in a later section. The basics of DWDM system-level components are described in the next section followed by their network architecture and switching requirements. Overall architectural goals are:

(a) Distributed Optical Network Control Required:

(i) Autonomous provisioning/reconfiguration trigged by client and external Management Systems.

(ii) Enhanced scalability and user tuneability.

(b) Auto-Discovery:

(i) Topology, physical resources, and capacity availability.

(ii) Critical to ensure database consistency for fast lightpath provisioning and efficient capacity utilization.

(c) Leverage Functionality from IP:

(i) Much work on appropriate functionality done in IP.

(ii) MPLS, RSVP, OSPF, and explicit routing . . .

2.2 DWDM Network Elements

The optical network consists of optical layer cross-connects (OXCs) that switch high-speed optical signals (e.g. OC-48, OC-192) from input ports to output ports. These OXCs are interconnected via WDM links. The OXCs may be purely optical or electrical or both. Every node in the network consists of an IP router and an OXC. In general, the router may be traffic bearing, or it may function purely as a controller for the optical layer and carry no IP data traffic. The node may be implemented using a stand-alone router interfacing with the OXC through a defined interface, or may be an integrated system, in which the router i part of the OXC system.

This section is only concerned with the functions of the router as they relate to the control of the optical layer. In the networks considered, it is assumed that the physical hardware is deployed, but that network connectivity is not defined until lightpaths are established within the network. A lightpath is a constant bit-rate data stream connected between two network elements such as IP routers. Lightpaths may be requested by client IP aware network elements, or by external operations systems used for IP-ignorant network elements.

Such requests may be for uni-directional or bi-directional lightpaths of a given bandwidth and with specified restoration requirements. The lightpaths are provisioned by choosing a route through the network with sufficient available capacity. The lightpath is established by allocating capacity on each link along the chosen route and appropriately configuring the OXCs. By reserving capacity on routes that are physically diverse to the primary lightpath, the network restoration function can be provided.

2.2.1 Optical Layer Cross-Connect (OXC)

An Optical layer cross-connect is a switching element that connects an optical channel from an input port to an output port. These devices are also often referred to as optical cross-connects (OXC). Note that an optical add-drop multiplexer (OADM) can be viewed as a simple OXC. The switching fabric in an OXC may be either electronic or optical. If the switching fabric is electronic, then switching would occur at a given channel rate, but the interface ports may in fact be at higher rates (e.g. multiplex multiple channels onto a single wavelength). It is important to note that because of the multiplexing function assumed in the OXC, we do not restrict the lightpaths to be identical to the Och defined in ITU-T G.872.

If the WDM systems contain transponders or if electronic OXCs are used, then it is implied that a channel associated with a specific wavelength in the WDM input can be converted to an output channel associated with a different wavelength in the WDM output (e.g. wavelength conversion is inherent). However, if the switching fabric is optical and there is no transponder function in the WDM system, then wavelength conversion is only implemented if optical to electronic conversion is performed at the input or output ports, or if optical wavelength converters are introduced to the OXC. Also, we assume that the rates in the input and output channels in an all-optical OXC are identical, implying that Time-Division-Multiplexing (TDM) is not offered within the OXC.

2.2.2 Wavelength-Division-Multiplexer (WDM)

A system that takes multiple optical inputs, converts them into narrowly spaced wavelength optical signals within an optical amplification band, and couples them onto a single fiber. The amplified signal is received at the receive end, demultiplexed and converted to multiple channels of standard wavelength to interface with other equipment. It is possible to take the wavelength specific signals directly as the inputs. In that case no wavelength conversion is necessary at the WDM system. The WDM system may or may not be integrated with an OXC.

2.2.3 Channel

A channel is a uni-directional optical tributary connecting two OXCs. Multiple channels are multiplexed optically at the WDM system. One direction of an OC-48/192 connecting two immediately neighboring OXCs is an example of a channel. A single direction of an Optical channel (Och) as defined in ITU-T G.872 between two OXCs over a WDM system is another example of a channel. A channel can generally be associated with a specific wavelength in the WDM system. However, with a WDM system with transponders the interfaces to the OXC would be a standard single color (1310 or 1550 nm). In addition, a single wavelength may transport multiple channels multiplexed in the time domain. For example, an OC-192 signal on a fiber may carry four STS-48 channels. For these reasons we define a channel which is different from wavelength although in many applications there is a one-to-one correspondence.

2.2.4 Lightpath

The elementary abstraction of optical layer connectivity between two end points is a uni-directional lightpath. A lightpath is a fixed bandwidth connection (e.g. one direction of a STM-N/OC-M payload or an Och payload) between two network elements established via the OXCs. A bi-directional lightpath consists of two associated lightpaths in opposite directions routed over the same set of nodes. Note that if the OXC is an electronic SONET/SDH line terminating equipment, the entire path need not be OC-48 for an OC-48 path. Note also that an OC-N and Och are by definition bi-directional, whilst lightpaths are by default unidirectional (anticipating asymmetric loads). Therefore it is assumed that independent lightpaths in opposite directions may use a bi-directional OC-48 or Och span.

2.2.5 Drop Port

An OXC port that connects to the end client network element (NE). The drop interface connects the client port to the OXC drop port. This is essentially a User Network Interface (UNI) connecting the end devices to the optical layer. The drop port terminates the user network interface between the client NE and the optical network. It is necessary to distinguish this type of interface from others to identify network requests originating from a client NE.

2.2.6 Network Port

An OXC port not directly interfacing with an end client NE. A Network Port in an OXC would always interface with another Network Port via a WDM system or directly via optical fibers

2.2.7 First-Hop Router

The first router within the domain of concern along the lightpath route. If the source is a router in the network, it is also its own first-hop router.

2.2.8 Last-Hop Router

The last router within the domain of concern along the lightpath route. If the destination is a router in the network, it is also its own last-hop router.

2.2.9 Mediation Device (MD)

A vendor specific controller used to control the OXC. The mediation device provides the interface between external sources and the OXC, translating logical primitives to and from the proprietary controls of the OXC. If the router is integrated with the OXC, then the mediation device is merely a function within the integrated entity, and not an explicit device.

2.2.10 Link

A link is a set of channels in a given direction connecting a particular pair of OXCs and routed along the same physical route. Multiple links may exist between the same OXCs, for example if route diversity is implemented between two OXCs. Note that links defined this way are uni-directional. There can be multiple WDMs within a link. A single WDM can be divided into multiple links (e.g. between different OXCs). The link is thus not necessarily a union of WDMs, and there is not necessarily a one-to-one correspondence between WDM systems and links.

2.2.11 Source and Source Address

A source can be a client router physically connected to an OXC by one or more OC-48/192 interfaces. A source can also be a non-IP NE connected to the OXC via an OC-48/192 interface. In the case of an IP router source, the router will have an IP address and the physical interfaces to the OXC are identified with some set of addresses (potentially a single IP address, or a unique address per port). In the case of a non-IP NE, either the NE will be assigned an IP address, or the OXC port connecting the NE will have an IP address. For non-IP aware equipment interfacing the OXC, any connection request must be originated externally via craft or external OS interfaces.

2.2.12 Destination and Destination Address

The destination is essentially the same as the source from the physical interface perspective. When a request is generated from one end, the other end client or end OXC interface becomes the destination.

2.2.13 Fiber Span

A fiber span consists of a collection of fiber cables that are located in the same conduit or right of way. If there is a cut in the fiber span, then failures would potentially be experienced on all fibers within the fiber span.

2.2.14 Shared Risk Link Group (SRLG)

For restoration and diverse routing purposes it may be necessary to associate links within a fiber span in a Shared Risk Link Group (SRLG). A SRLG is a union of all links that ride on a fiber span. Links may traverse multiple fiber spans, and thus be in multiple SRLGs.

2.3 Network Architecture

The salient feature of the network architecture is that every node in the network consists of an IP router and a re-configurable OXC. The IP router is responsible for all non-local management functions, including the management of optical resources, configuration and capacity management, addressing, routing, traffic engineering, topology discovery, exception handling and restoration. In general, the router may be traffic bearing, or it may function purely as a controller for the optical network and carry no IP data traffic. The mechanisms and requirements discussed within this document are applicable regardless of whether data traffic traverses through the routers or not. Although the IP router performs all management and control functions, lightpaths may carry arbitrary types of traffic. The IP router implements the necessary IP protocols and uses IP for signaling to establish lightpaths.

Specifically, optical resource management requires resource availability per link to be propagated, implying link state protocols such as OSPF. In subsequent discussions we assume OSPF. On each link within the network, one channel is assigned as the default routed (one hop) lightpath. The routed lightpath provides router to router connectivity over this link. These routed lightpaths reflect (and are thus identical to) the physical topology. The assignment of this default lightpath is by convention, e.g. the ‘first’ channel. All traffic using this lightpath is IP traffic and is forwarded by the router. All control messages are sent in-band on a routed lightpath as regular IP datagrams, potentially mixed with other data but with the highest forwarding priority. We assume multiple channels on each link, a fraction of which is reserved at any given time for restoration. The default routed lightpath is restored on one of these channels.

Therefore we can assume that as long as the link is functional, there is a default routed lightpath on that link.

In resource constrained parts of the network, such as the link connecting the customer premise to the network, it may not be economically feasible to reserve a channel and the associated IP interface for the default routed lightpath. Within the network, where each link has multiple channels carrying traffic from many customers, the overhead of the routed wavelength is amortized over the channels on that link. In contrast, the link connecting the customer premise to the network may typically have only a single traffic bearing channel. In this case, unless the routed lightpath is also used for IP data traffic, the overhead of an optical channel dedicated for control may be excessive.

If electronic line terminating OXCs are used, an alternative to dedicating an optical channel as the routed lightpath is to transport the IP datagrams within the framing overheads of the signals (e.g. SONET Multiplex and/or Regenerator Section Overhead). The IP router communicates with the OXC mediation device (MD) through a logical interface. The interface defines a set of basic primitives to configure the OXC, and to enable the OXC to convey information to the router. The mediation device translates the logical primitives to and from the proprietary controls of the OXC. Ideally, this interface is both explicit and open. A particular realization may integrate the router and the OXC into a single box and use a proprietary interface implementation. The crucial point is that this proprietary interface must still provide equivalent functionality to the interface. Another interface of importance is the service interface between the customers and the network. This interface determines the set of services that the optical network provides.

2.4 Optical Network Requirements

It is important to identify the services that an optical network should offer, and the functionality that must be implemented by the optical infrastructure to support these services. Within the same domain of trust, servers and other network management systems may have access to the network information available to routers, and may actively interact with the network by requesting lightpaths. These servers may for example provide authentication, risk analysis and management, and more. While this document defines mechanisms that would be used by these higher layer systems, the specifics of these advanced services are not discussed herein. The following outlines the optical network services and functionality.

2.4.1 Optical Network Services

Lightpath Services

Lightpath requests between a source and destination with the following attributes:

(a) Lightpath identifier. A globally unique identifier.

(b) Bandwidth: A limited set of bandwidth allocations is available (e.g. OC-48, OC-192).

(c) Uni-directional or bi-directional lightpath.

(d) Diversely routed lightpath group identifier(s). A globally unique group identifier defined for diversely routed lightpath groups. A convenient way to create one is by concatenating the IP address of the first-hop router, and a sequence number unique at the router. If the diversely routed lightpath group is not coordinated by the first-hop router, but instead by an external operations system, the address of the coordinating entity would be used instead.

(e) Restoration class: one of (i) restored lightpath, (ii) restored IP connectivity, (iii) not restored, (iv) not restored and preemptable. For Class (i) the lightpath must be restored using another lightpath, whose route is different from the primary. IP restored (Class (ii)) assumes that the traffic transported on the lightpath is IP, and may be restored by routing through the network routers if needed and given that routing capacity is available. Clearly, the network will attempt to restore all lost connectivity if and when possible. This is however done on a best effort basis.

Diversely Routed Lightpath Groups

A set of diversely routed non-restored lightpaths so that for any single failure, at most a given number of lightpaths out of the group fail. A lightpath belongs to one or more diversely routed lightpath group(s). The simplest form of diversely routed lightpaths is a group originating at the same first hop router. This case is handled by the first hop router.

More generally, the lightpaths of a group may potentially have different sources and destinations, and may be required to satisfy other more stringent requirements such as ensuring that particular end-points are always connected.

Risk Management

The implementation of these more elaborate risk management services is outside the scope of this section and would typically be provided by higher level management system(s) external to the network nodes.

2.4.2 Requirements on Optical Network Functionality

To cope with decreasing provisioning time scales, and to enhance scalability, it is necessary to maintain the network state in a distributed manner. This need drives most other system requirements and implementation choices, and the service requirements above imply the need for the following information and algorithms:

(a) Information on topology and inventory of physical resources (e.g. channels).

(b) Information about shared risk link groups (SRLGs). This is necessary for routing of restoration lightpaths, and for diverse routing of primary lightpaths.

(c) Information regarding the current resource allocations must be propagated throughout the network. For scalability, details of individual wavelength allocations are not distributed.

(d) An addressing and naming scheme.

(e) Algorithms for distributed state maintenance of the above.

(f) Algorithms and mechanisms for the allocation of bandwidth resources to new lightpaths, and for the reservation of restoration capacity. These algorithms and mechanisms must be able to support diversely routed lightpaths as described above.

(g) Algorithms for the management and optimizations of resource allocation; and the minimization of resources reserved for restoration. Established lightpaths may occasionally be reconfigured to optimize resource allocations.

(h) Algorithms and mechanisms to ensure diversity in routes among a set of lightpaths.

(i) Algorithms and mechanisms for fault detection and recovery (e.g., notification and exception handling).

(j) Specification of interfaces between the external systems (including client) and the network.

(k) Specification of interfaces between the router and the OXC mediation device.

2.5 Naming and Addressing

Every network addressable element must have an IP address. Typically these elements include each node and every optical link and IP router port. When it is desirable to have the ability to address individual optical channels those are assigned IP addresses as well. The IP addresses must be globally unique if the element is globally addressable. Otherwise domain unique addresses suffice.

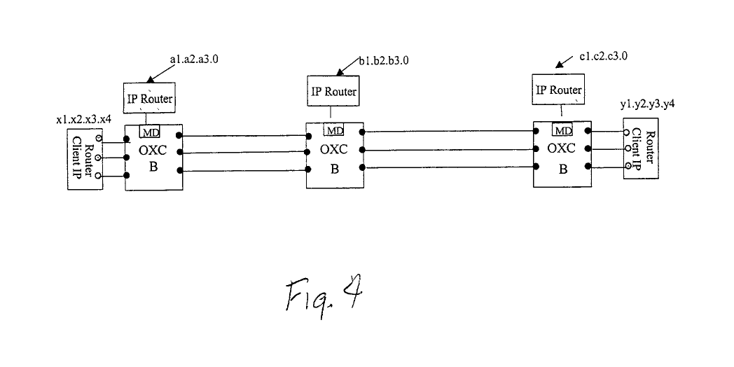

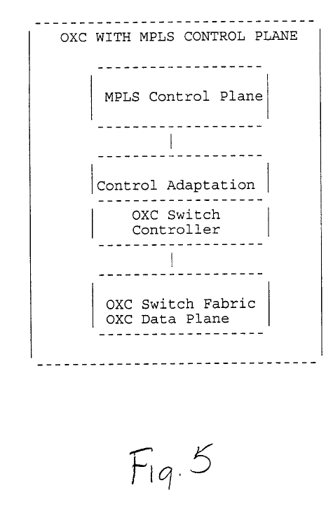

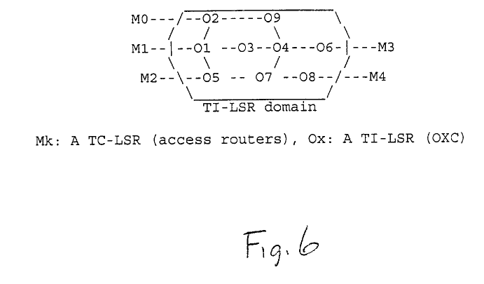

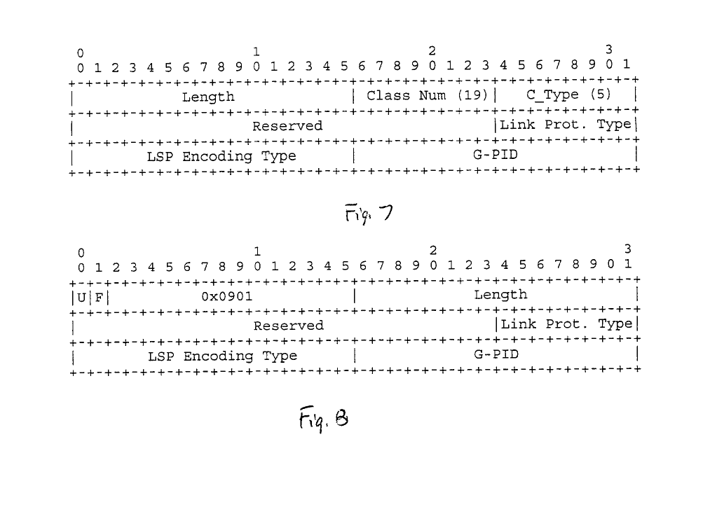

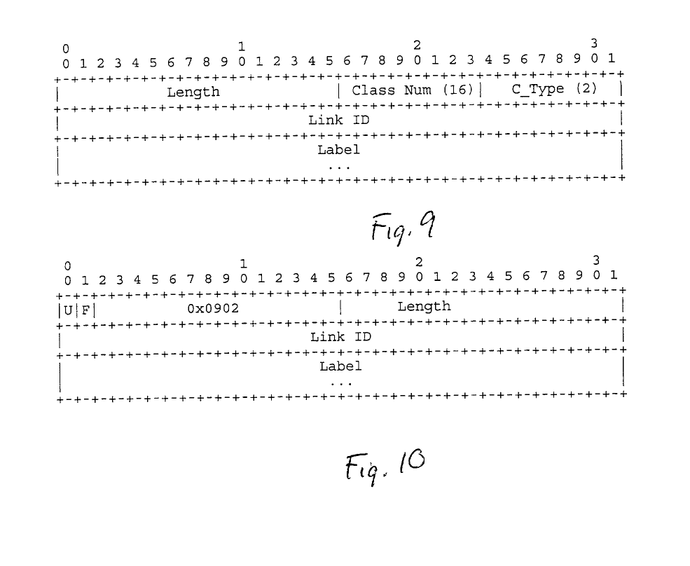

An example of how these IP addresses could be assigned is given in FIG. 4. Each IP router is assigned an IP address of the form a1.a2.a3.0, where a1, a2, a3>0. The OXC links are then assigned a unique IP address of the form a1.a2.a3.x, where x>0.

Local naming schemes can be used to identify channels within fibers, or to identify fibers within links. However, globally unique names will be required to specify routes through the network. A possible naming convention for uniquely identifying the channels used along a route through a network is proposed. This convention identifies a channel according to the OXC from which it is sourced, the link within the OXC and the channel within the link. How these values are used depends on what elements are assigned IP addresses.

If only the OXC has a unique IP address, then the naming scheme uses a pre-defined convention to identify links and channels within the OXC (e.g. OXC IP address : link number: channel number). Alternatively, if the link is also assigned an IP address, then the channel is uniquely defined by the link IP address, and the channel identifications within that link (e.g. link IP address: NULL identifier: channel number). The NULL identifier is used to indicate that a given field is invalid.

For example, in the identifier associated with the link IP address, the second field contains a NULL identifier, which is used to indicate that a link number is not required, because the IP address corresponds to a unique link. Thus, the first non-NULL identifier can be used to denote what the IP address corresponds to (e.g. OXC or link). The same applies for addresses assigned at finer granularities, e.g. for each channel. Clearly, other variants on the above naming scheme are possible.

A client must also have an IP address by which it is identified. However, optical lightpaths could potentially be established between devices that do not support IP (e.g. are not IP aware), and consequently do not have IP addresses. This could be handled by either assigning an IP address to the device or alternatively assigning an address to the OXC port to which the device is attached. To find out whether or not a client is IP aware, one can use traditional IP mechanisms.

2.6 Provisioning at the Optical Layer

2.6.1 Provisioning Lightpaths in a Network with Wavelength Converters

In an optical network with wavelength conversion, channel allocation can be performed independently on different links along a route. However, if wavelength converters are not available, then a common wavelength must be located on each link along the entire route, which requires some degree of coordination between different nodes in choosing an appropriate wavelength. A lightpath request from a source is received by the first-hop router which then creates a lightpath setup message and sends it towards the destination of the lightpath where it is received by the last-hop router. If the originator of the request is not the source, the originator tunnels the request to the first-hop router. The lightpath setup is sent from the first-hop router on the default routed lightpath as the payload of a normal IP packet with router alert. A router alert ensures that the packet is processed by every router in the lightpath.

A channel is allocated for the lightpath on the downstream link at every node traversed by the setup. The identifier of the allocated channel is written to the setup message. If no channel is available on some link, the setup fails, and a message is returned to the first-hop router informing it that the lightpath cannot be established. The ‘destination not reachable’ ICMP (Internet Control Messaging Protocol) message may be used for this, but any comparable mechanism would suffice.

For example, if all routers are MPLS capable one could use the appropriate CR-LDP (Constraint-based Routing—Label Distribution Protocol) message. If the setup fails, the first-hop router issues a release message to release resources allocated for the partially constructed lightpath. Upon failure, the first-hop router may attempt to establish the lightpath over an alternate route, before giving up on satisfying the original user request.

Note that the lightpath is established over the links traversed by the lightpath setup packet. Moreover, when electronic line terminating OXCs are used it is possible to alternatively use the channel overheads of the chosen lightpath channels to carry the lightpath setup. After a channel has been allocated at a node, the router communicates with the OXC to reconfigure the OXC to provide the desired connectivity.

After processing the setup, the destination (or the last-hop router) returns an acknowledgement to the source. The acknowledgment indicates that a channel has been allocated on each hop of the lightpath. It does not, however, confirm that the lightpath has been successfully implemented (e.g. the OXCs have been reconfigured). It may be desirable to have the acknowledgement confirm that every hop has completed the OXC configuration.

However, to verify that end-to-end connectivity has been established requires that additional mechanisms be implemented. These could for example be tandem connection identification verification, as defined in ITU-T SONET/SDH and OTN. Either way, the channel becomes available immediately after the request is sent, at the discretion of the user. Once established, the lightpath may carry arbitrary traffic, such as ATM, Frame Relay or TDM circuit.

If the user requests a restored lightpath, then capacity must be reserved within the network. This reserved capacity is shared over multiple failures and only allocated (e.g., configured in the OXC) upon failure. The capacity reservation is performed independently of the setup of the primary lightpath albeit perhaps simultaneously. It may take a significantly longer time than the lightpath setup.

The first-hop router is responsible for ensuring that restoration capacity is reserved for all restorable failures. The first-hop router informs the source once this is completed. The establishment of a restored lightpath is completed when the primary capacity is allocated and the restoration capacity is reserved.

2.6.2 Softness of State

To simplify exception handling, all network states are assumed to be soft unless otherwise stated. This applies in particular to lightpath and restoration state. Soft state has an associated time-to-live, and expires and may be discarded once that time is passed. To avoid expiration the state must be periodically refreshed. To reduce the overhead of the state maintenance, the expiration period may be increased exponentially over time to a predefined maximum.

This way the longer a state has survived the fewer the number of refresh messages that are required. For lightpaths this implies that the source must periodically resend the lightpath request. Similarly, the first-hop router must resend the lightpath setup. If the state of a lightpath expires at a particular node, the state is locally removed and all resources allocated to the lightpath are reclaimed.

2.6.3 Lightpath Routing

To satisfy the requirements of diverse routing and restoration we assert that it is necessary to use explicit routing for constructing lightpaths. In addition, explicit routes may be valuable for traffic engineering and load optimizations in the network. The route on which a new lightpath is to be established is specified in the lightpath setup message.

This route would typically be chosen by the first-hop router, but could be determined by a pre-authenticated higher level network management system. Through routing protocols the first-hop router has a representation of the full physical network topology and the available resources on each link. These are obtained and updated via OSPF link state advertisements. The explicit route might be carried directly in the IP datagram using the IP source route option, or might be carried in the packet payload as would be the case if RSVP were used for signaling lightpath requests.

The route may be specified either as a series of nodes (routers/OXCs), or in terms of the specific links used (as long as IP addresses are associated with these links). Numerous policies can be used to route lightpaths through the network, such as constraint-based routing algorithms. It is expected that using a good routing algorithm will produce better route selection and improve network resource utilization.

To ensure diversity in routes, each diversely routed lightpath group is coordinated by a single network entity. To create a diversely routed lightpath group, a user registers with a coordinator, and receives the group identifier. For groups originating through the same first-hop router, this router would typically act as the coordinator. To ensure diversity in routes, K SRLG and node disjoint routes through the network are selected, where K represents the number of diverse routes required. The corresponding lightpaths are then established independently. When a router receives a diversely routed lightpath request coordinated by another network entity, the router uses the address in the diversely routed lightpath group identifier to retrieve the explicit route for the new path from the coordinator.

2.6.4 Provisioning Bi-Directional Lightpaths

The construction of a bi-directional lightpath differs from the construction of a uni-directional lightpath above only in that upon receiving the setup request, the last-hop router returns the setup message using the reverse of the explicit route of the forward path. Both directions of a bi-directional lightpath share the same characteristics, e.g., set of nodes, bandwidth and restoration requirements. For more general bi-directional connectivity, a user simply requests multiple individual lightpaths.

2.6.5 Provisioning Lightpaths in a (Sub-)Network without Wavelength Converters

The provisioning techniques proposed earlier in this section apply to optical networks with wavelength conversion. However, future all-optical OXCs may not have the ability to convert an incoming wavelength to a different outgoing wavelength (e.g. do not implement wavelength conversion). Such OXCs may be used throughout an optical network, or may be used in only some nodes, creating all-optical sub-networks. Sections of a network that do not have wavelength converters are thus referred to as being wavelength continuous.

A common wavelength must be chosen on each link along a wavelength continuous section of a lightpath. Whatever wavelength is chosen on the first link defines the wavelength allocation along the rest of the section. A wavelength assignment algorithm must thus be used to choose this wavelength. It is plausible, although unlikely, that wavelength conversion could also be eliminated between the client and the network. Wavelength selection within the network must be performed within this subset of client wavelengths.

Optical non-linearities, chromatic dispersion, amplifier spontaneous emission and other factors together limit the scalability of an all-optical network. Routing in such networks will then have to take into account noise accumulation and dispersion to ensure that lightpaths are established with adequate signal qualities. In the following discussion we assume that the all-optical (sub-)network considered is geographically constrained so that all routes will have adequate signal quality, and physical layer attributes can be ignored during routing and wavelength assignment. However, the policies and mechanisms proposed here can be extended to account for physical layer characteristics.

One approach to provisioning in a sub-network without wavelength converters would be to propagate information throughout the network about the state of every wavelength on every link in the network.

However, the state required and the overhead involved in maintaining this information would be excessive.

By not propagating individual wavelength availability information around the network, we must select a route and wavelength upon which to establish a new lightpath, without detailed knowledge of wavelength availability.

We propose in this case to probe the network to determine an appropriate wavelength choice. We use a probe message to determine available wavelengths along wavelength continuous routes. A vector of the same size as the number of wavelengths on the first link is sent out to each node in turn along the desired route. This vector represents wavelength availability, and is set at the first node to the wavelength availability on the first link along the wavelength continuous section.

If a wavelength on a link is not available or does not exist, then this is noted in the wavelength availability vector (e.g. the wavelength is set to being unavailable). Once the entire route has been traversed, the wavelength availability vector will denote the wavelengths that are available on every link along the route. The vector is returned to the source OXC, and a wavelength is chosen from amongst the available wavelengths using an arbitrary wavelength assignment scheme, such as first-fit [8]. Note that wavelength assignment is performed here using wavelength usage information from only the links along the chosen route. Also, multiple lightpaths can be simultaneously established using the same wavelength availability information.

Alternative techniques can be used for selecting a wavelength, such as attempting to establish a lightpath on successive wavelengths in turn, or simultaneously attempting to allocate the lightpath on all wavelengths that are available at the source. The key point is that extensions of the provisioning techniques proposed in this document for optical networks with wavelength converters can be used to implement fast provisioning in networks without wavelength converters, and that the two techniques can coexist in a network with OXCs with and without wavelength conversion.

2.6.6 Lightpath Removal

A lightpath must be removed when it is no longer required. To achieve this, an explicit release request is sent by the first-hop router along the lightpath route. Each router in the path processes the release message by releasing the resources allocated to the lightpath, and removing the associated state. It is worth noting that the release message is an optimization and need not be sent reliably, as if it is lost or never issued (e.g., due to customer premise equipment failure) the softness of the lightpath state ensures that it will eventually expire and be released.

2.7 Restoration Plan

2.7.1 Restoration in a Network with Wavelength Conversion

When a restored lightpath is requested, the primary lightpath is established as described above, and the restoration capacity must be reserved. The extent to which a network provider chooses to protect the network depends on which failures can be recovered from. In this discussion we assume that recovery is guaranteed for all individual channel, link and single fiber span failures (e.g., links in a common SRLG). Recovery from node or multiple fiber span failures is not guaranteed. There are three aspects to restoration: reservation of restoration capacity, failure detection and exception handling. We treat each of these separately, as discussed in the following. We propose a distributed approach to the restoration management.

2.7.2 Failure Detection and Exception Handling

We treat the handling of failures in an optical network as equivalent to exception handling in advanced programming languages. We equate failures to exceptions. When a component receives an exception (at the lowest level detects a failure), it either handles the exception or throws it up the chain of control.

Locally, the chain of control goes from the router to the OXC. For a lightpath the chain of control goes downstream through the routers. This means that exceptions get thrown from the OXC to the local router, from there to the upstream router, and then recursively to the router further upstream until the exception is handled. This approach separates the mechanisms of exception propagation from the policy of deciding who and how the exception is handled, yielding great flexibility in the management of restoration capacity. In general, each lightpath is recovered independently. However, in some situations it may be desirable to handle multiple exceptions as a single unit. For example, if a fiber is cut, all channels may be restored in a single action.

It is worth stressing that restoration capacity is reserved, and not allocated. The capacity reserved for restoration is therefore shared and not dedicated to any particular lightpath. The restoration capacity is either idle or is used for preemptable lightpaths. The use of preemptable lightpaths enables the use of a larger percentage of the total capacity albeit for secondary services. This is particularly attractive for adaptable services, as are common in the Internet, which would benefit from exploiting the restoration capacity under normal operating conditions, but would gracefully adapt to the reduction in capacity during failure.

Since restoration capacity is only reserved, handling the exception translates into allocating the restoration lightpath on failure. This requires efficient setup mechanisms for the construction and allocation of the restoration lightpath to meet the tight restoration timing constraints. Ideally, the basic lightpath setup would be suitable for this purpose. Otherwise, a separate mechanism must be devised for this purpose. In either case, we believe that it is essential to pre-compute and store the restoration routes. The advantage of using a fast lightpath setup is that a normal setup would be issued from the exception handler, allowing all lightpath specific states, specifically the restoration state, to be stored only at the nodes traversed by the primary lightpath. This significantly reduces the maintenance of the soft restoration state.

However, other considerations may dictate which mechanisms are used for setting up the primary lightpath even if those mechanisms are poorly suited for restoration. For example, the processing of explicitly routed RSVP messages may be acceptable to setup primary lightpaths, but appears too costly for meeting restoration timing guarantees. To cope with this, the state for the restoration path may be pre-established along the restoration route, leaving out only the OXC configuration. This way a simple allocation notification (a touch message) along the restoration path is sufficient to trigger the OXC configuration.

A router can forward a notification before it is processed to avoid accumulating the processing overhead of each node, thus allowing for very rapid restoration setup. Data can then be transmitted on the restoration path immediately, with insignificant data loss. The lightpath establishment message must distinguish between a restoration lightpath and a new lightpath request, so that restoration lightpaths allocate resources out of the preemptable capacity reserved for restoration.

2.7.3 Management and Reservation of Restoration Capacity

The first-hop router selects the restoration route(s) and is responsible for reserving restoration capacity. Numerous policies may be used for determining the lightpath restoration routes. The choice of a good restoration policy is a tradeoff between simplicity, utilization and restoration speed. The simplest approach is to restore only at the first-hop router using a single end-to-end route completely SRLG and node disjoint from the primary lightpath. Such a disjoint route is sufficient for all failures along the primary route.

Even if restoring only from the first-hop router, it may be preferable to use different restoration routes depending on which hop of the primary lightpath failed. However for longer lightpaths the delay in exception propagation from the point of failure to the first-hop router may be too excessive, and thus it may be desirable to perform the restoration (handle the exception) at intermediate nodes along the path. The mechanisms above support all of these options.

The first-hop router stores all of the restoration routes for which it is responsible (e.g. for which it is the first hop of the primary lightpath). Taking into account risk groups and available resources it calculates the total restoration resources required for these routes on each link in the network and for each different link failure. This calculation can be performed on-line using a greedy algorithm, thus optimizing the choice of restoration routes conditional on the existing lightpath allocations and reserved restoration capacity. Restoration capacity is reserved on a link for the failure of each single SRLG within the network.

Thus, the number of lightpaths that use a given link for restoration will differ depending on which SRLG failure is considered. Restoration resources on a given link must thus be independently reserved for each different link failure within the network. The resources required by a first-hop router, s, on a given link, l, for restoration of a failed link i is denoted here by rₛᵢ(l). The rᵢₛ(l) values are transmitted to the links (l) at regular intervals and when restoration resource requirements are altered (e.g. for each arriving and departing restored lightpath). In a network with L links, this requires that O(L) values be transmitted to link l from first-hop router s.

The resources reserved on a link for restoration are stored locally at that link. This implies the equivalent of storing a two dimensional array of information for each link l which documents the number of channels reserved at link l for each first-hop router and every possible link failure (e.g. requires that O(NL) values be stored, where N is the number of nodes/sources, and L is the number of links in the network).

The total number of resources reserved on link l for restoration is the maximum over all possible fiber span failures (risk groups) of the sum over all first-hop nodes of restoration resources required on each link within the risk group (maxⱼ(ΣₛΣ_{i in risk group j}rₛᵢ(l)).

Once restoration routes have been determined, a restoration reservation message (in IP packets) is sent to reserve the restoration capacity on the links along the chosen routes. This is performed in a manner similar to lightpath allocations using explicit routing, with the difference that while capacity is reserved, the OXCs are not reconfigured. Instead, counts of reserved restoration capacity are updated at each of the links along the route.

As long as provisioning time-scales remain long, it is alternatively viable to do restoration management in a centralized fashion, where a centralized Risk Management Center assumes the responsibility for selecting and maintaining restoration routes. This center would subscribe to routing updates but would in addition need to be informed about the routes used for every lightpath established within the network. This last part becomes infeasible as time-scales shrink.

2.7.4 Repair and Return to Primary Lightpaths

Once a failed link or resource has been repaired, the restoration lightpath is released and the lightpath is restored on the original route. This responsibility is also delegated to the first-hop router, which periodically repeats the original lightpath request until it succeeds. For extended outages, the first-hop router may eventually give up on the primary path, and compute and allocate a new restorable primary route. Reverting back to the primary lightpath route after a failure requires that this capacity remain allocated during the time that the lightpath uses the restoration capacity.

Soft connection states are assumed so that if a lightpath refresh is not periodically received for an established lightpath, then its capacity will be de-allocated. This causes a problem in that these refresh messages will not be received along a primary route downstream of the failure. An explicit notification to the closest node downstream of the failure is needed to temporarily reduce the available capacity to ensure that this capacity is not allocated to new lightpaths during the failure.

2.7.5 Restoration in a Network without Wavelength Converters

End-to-end restoration is proposed for all-optical networks or sub-networks. If no wavelength conversion is used in the network and on the client/network interface, then the same wavelength will be required for the primary and restoration lightpaths if the client cannot retune its wavelength on failure. Whether or not the client can provide this re-tuning can be passed as a parameter in the lightpath request.

Wavelength selection on the primary and restoration lightpaths should be simultaneously performed if the same wavelength is required on both of these lightpaths. This requires that the wavelengths available on both of the lightpaths to be returned to the first-hop router and a decision made before either lightpath is established. It also requires that specific wavelengths be reserved for restoration at each node, significantly increasing the state information required. The issue becomes even more complex in a hybrid transparent and opaque OXC environment. However, we believe that we should focus on opaque OXC environment on the first phase while keeping in mind that in the future it may be required to incorporate transparent and mixed optical networks.

2.8 Network Reconfiguration

The above proposal performs the calculation of primary and restoration lightpath routes on-line as the individual requests arrive. The lightpath routes are thus chosen conditional on the existing lightpath allocations. A more optimal set of lightpath routes could be calculated off-line, with all of the requests known and their routes simultaneously calculated. However, as the lightpaths vary over time, the implementation of the optimal route choices would likely result in the reconfiguration of lightpath routes being required. Although a large number of lightpath reconfigurations may not be acceptable, it is possible that a limited number of lightpath reconfigurations could dramatically improve the network state, freeing up resources for future lightpath allocations. For restored lightpaths, rerouting would generally have to be performed within the time limits set for restoration. The lightpath allocation schemes would either be fast enough to make this achievable, or additional mechanisms would have to be employed to hide the delay in lightpath construction. The number of reconfigurations that a given lightpath experiences should be limited, to ensure that lightpaths don't suffer a constant route fluttering. Lightpath reconfigurations should also be confined only to those lightpaths that are rearrangeable.

2.9 Resource Discovery and Maintenance

Topology information is distributed and maintained using standard routing algorithms. On boot, each network node goes through neighbor discovery. By combining neighbor discovery with local configuration, each node creates an inventory of local resources and resource hierarchies, namely: channels, channel capacity, wavelengths, links and SRLGs.

2.9.1 Information Requirements

The following information should be stored at each node and must be propagated throughout the network as OSPF link-state information. Representation of the current network topology and the link states (hence the wavelength availability). This can be achieved by associating the following information with the link state:

(a) Total number of active channels (note that if a laser fails, for example, then the channels using this laser become inactive, and are not counted in the total number of active channels).

(b) Number of allocated channels (non-preemptable).

(c) Number of allocated preemptable channels.

(d) Number of reserved restoration channels (maximum allocated over all potential SRLG failures within the network).

(e) Risk groups throughout the network (e.g. which links share risk groups).

(f) Optional physical layer parameters for each link. These parameters are not expected to be required in a network with 3R signal regeneration, but may be used in all-optical networks.

All of the above information is obtained via OSPF updates, and is propagated throughout the network. Note that we do not inform nodes of which channels are available on a link. Thus, in networks with OXCs without wavelength converters, decisions at the first-hop router are made without knowledge of wavelength availability. This is done to reduce the state information that needs to be propagated within the network. In addition to this, extra information would be stored locally (e.g., in the router), including the following list (note that this is not exhaustive):

(a) IP routing tables.

(b) Additional routing table information containing currently active lightpaths passing through, sourced or destined to this node and the channels that they are allocated.

For each link exiting the OXC:

(a) Total capacity (number of channels and their bandwidth).

(b) Available capacity.

(c) Preemptable capacity.

(d) Number of channels reserved for restoration on this link for each potential link failure within the network and for each first-hop router (if distributed restoration capacity calculations are being done). Thus, if there are L links within the network and N nodes, then there are must be L*N unique values stored here.

(e) Association between channels and fibers/wavelengths. This is particularly important for OXCs without wavelength converters and for OXCs in which lower rate channels are multiplexed onto a common higher rate channel on a common fiber (e.g. four OC-48s multiplexed onto a single OC-192 for transmission).

The first-hop router maintains for each client:

(a) Client identification.

(b) Associated lightpath IDs for every established lightpath for this client.

(c) Set of primary and restoration routes associated with each lightpath ID

2.10 Attributes for a Lightpath Request

The information conveyed in a client request for lightpath connectivity should include the following parameters:

(a) Globally unique lightpath identifier.

(b) Diversely routed lightpath group identifier(s).

(c) Destination address.

(d) Source address.

(e) Bandwidth requirements (e.g. OC48 or OC192).

(f) Uni-directional/bi-directional.

(g) Security object u for authentication.

(h) Restoration class: one of (i) restored lightpath, (ii) restored IP connectivity, (iii) not restored, (iv) not restored and preemptable. For Class (i) the lightpath must be restored using another lightpath. IP restored (Class (ii)) assumes that the traffic transported on the lightpath is IP, and may be restored by routing through the network routers if needed and given that routing capacity is available.

(i) Wavelength rearrangeability (optional parameter required only for client/network interfaces without wavelength conversion).

Note that the unique lightpath identifier can be assigned by the customer when the lightpath is requested, or can be assigned by the network once the lightpath has been established.

2.11 Interface Primitives for IP Router and OXC

Interface primitives for communication between the router and the OXC within a node:

(a) Connect (input link, input channel, output link, output channel):

Commands sent from the router to the OXC requesting that the OXC cross-connect input channel on the input link to the output channel on the output link. Note that one end of the connection can also be a drop port. This is true for the following connection primitives as well.

(b) Disconnect (input link, input channel, output link, output channel):

Command sent from the router to the OXC requesting that it disconnect the output channel on the output link from the connected input channel on the input link.

(c) Bridge (input link, input channel, output link, output channel):

Command sent from the router controller to the OXC requesting the bridging of a connected input channel on input link to another output channel on output link.

(d) Switch (old input link, old input channel, new input link, new input channel, output link, output channel):

Switch output port from the currently connected input channel on the input link to the new input channel on the new input link. The switch primitive is equivalent to atomically implementing a Disconnect (old input channel, old input link, output channel, output link) followed by a Connect (new input link, new input channel, output link, output channel).

(e) Alarm (exception, object):

Command sent from the OXC to the router informing it of a failure detected by the OXC. The object represents the element for which the failure has been detected.

Note that IP packets are also passed by the OXC to the router in the network when the control packets from clients are transmitted within the framing overheads.

3 Performance Monitoring in Optical Networks

3.1 Introduction

Realizing the important role that optical switches can play in data-centric networks, work has been going on within the IETF to combine the control plane of MPLS (more specifically traffic engineering, TE) with the management of emerging optical switches. The ultimate goal is to provide a framework for real-time provisioning of optical channels and allow the use of a uniform interface for network management operations and control in hybrid networks consisting of optical switches and label switching routers (LSRs). While this approach is particularly advantageous for data-centric optical internetworking systems, it can easily be expanded to include basic transmission services. Similarly, it can be expanded beyond simple bandwidth provisioning to include optical performance monitoring.

This section outlines this initiative for DWDM, OADM (Optical Add/Drop multiplexer) and ATM systems. It goes beyond simple establishment of optical paths and includes optical performance monitoring and management. The combined path routing and performance information that will be carried and shared between these network elements will allow the elements or element management system (EMS) to adequately assess the “health” of an optical path (which can be a wavelength or fiber strand). The routers and/or ATM switches at the edges of the optical network will then use this information to dynamically manage the millions of wavelengths available in the all-optical layer. As a summary, the following functions need to be covered:

(a) Dynamic Bandwidth Provisioning.

(b) Optical Performance Monitoring.

(c) Signaling for (a) and (b).

3.2 Dynamic Bandwidth Provisioning

All-optical networks use optical switches and optical transmission equipment to provide point-to-point connections to attached internetworking devices. These connections will typically take the shape of dedicated wavelengths, but can also be SONET leased line services or gigabit Ethernet connections. While the optical network will typically provide these bandwidth services to IP routers, the model should be extended to include ATM switches.

While the idea of bandwidth-on-demand is certainly not new, existing networks do not support instantaneous service provisioning. Current provisioning of bandwidth is painstakingly static. Activation of large pipes of bandwidth takes anything from weeks to months. The imminent introduction of optical switches in the transport networks opens new perspectives. Combining the bandwidth provisioning capabilities of optical switches with the traffic engineering capabilities of MPLS, will allow routers and ATM switches to request bandwidth where and when they need it.

To make this work, however, requires more than simply advertising the availability of routes by the optical switches to the routers and/or switches. They will also need to provide information about the characteristics and performance of the paths. Adequately assessing the status and health of an optical path through the optical network requires a detailed cooperation between the optical switches and the transmission systems providing the basic transport capabilities in the long-haul network.

3.3 Performance Monitoring

Service providers to date have limited the role of DWDM in the network to creating “virtual fiber”, e.g., the straightforward increase in capacity of the fiber plant, even if this meant a dramatic increase in complexity since each virtual fiber required the deployment of its own SONET equipment. The reason behind this restricted role is the worry about network management, alarm monitoring and protection capabilities of DWDM systems and the optical layer in general. Current performance monitoring in optical networks requires termination of a channel (wavelength) at an OEO (optical-electrical-optical conversion) point to detect bits related to the bit error rate (BER) of the payload or frame (e.g., SONET LTE monitoring). For example, one form of error checking can be carried out at the SONET level by monitoring the overhead bytes of the SONET stream for error detection. However, while these bits indicate if errors have been received, they do not supply channel-performance data. This makes it very difficult to assess the actual cause of the degraded performance.

The premise of optical networks requires the availability of tools to measure and control the smallest granular component of such networks—the wavelength channel. These functions include the monitoring of amplifiers and switches at add/drop sites, the deployment and commissioning of DWDM routes, as well as the restoration and protection of networks. This must be accomplished with speed and accuracy over an extended period of time. Fast and accurate determination of the various performance measures of a wavelength channel implies that measurements have to be done while leaving it in optical format. In the remainder of this section we will refer to this as “optical performance monitoring” (OPM). One possible way of achieving this is by tapping a portion of the optical power from the main channel using a low loss tap of less than 10%. In this scenario, the most basic form of OPM will utilize a power-averaging receiver to detect loss of signal (LOS) at the optical power tap point. Current DWDM systems use Optical time-domain reflectometers (OTDR) to measure the parameters of the optical links.

As optical networks mature, it will be desirable to generate a more detailed picture of the channel “health” in a manner that can be communicated to the EMS and other network control entities, as well as between other network elements. By monitoring various OPM parameters, one can attempt to estimate the BER, detect gradual or sudden performance degradation, and report these to local or global NMS entities, and to internetworking devices attached. Also, fiber spans are typically characterized, or calibrated, during the provisioning process on DWDM systems, as fiber manufacturer, fiber type etc. all have a bearing on how the various DWDM spectrums should be populated. It would be useful to have the calibrated data for each fiber span available as part of the overall information on the optical layer. All the available information can then be correlated across the network to make decisions on fault isolation and take appropriate actions such as rerouting the connection or adaptively downgrading or upgrading the bit-rate of a channel.

When deploying an optical network it is common practice to document the baseline for all operating parameters, such as signal power, bit-error rate, optical signal-to-noise ratio (OSNR), etc., prior to network turn-on. During normal operation, network elements equipped with OPM capabilities can report any degradation events of the optical channel to the network operations center (NOC) and to the other network elements. The element management system (EMS) can document the degradation of the optical layer in time by saving optical performance monitoring data in an archival database. As channels are added, removed or re-routed, the NOC can continuously monitor and analyze the status as channels are dynamically managed. With the advent of an open optical network, there will be leasing channels or wavelengths that span multiple networks. This will require optical interconnects between various networks. Invariably, as channels are handed off between carriers, problems can occur which require monitoring to resolve conflicts. Most of these issues occur at network boundaries. In addition, if service providers offer various levels of quality of service (QoS), both networks will have a way of negotiating the end-to-end QoS of the channels per the service contract. Here again, independent monitoring is needed to ensure quality and continuity of service.

The issue of effective OPM sensitivity will impact how pervasive each technique is used in a network due to cost and complexity. Certain techniques may require an optical amplifier at the tap point resulting in OPM module sensitivity equivalent to that of the final path termination point. Other issues that need to be addressed include definition of OPM at the section, line and path levels. Since monitoring can be in principal performed at any point within the network, traditional use of LTE points does not carry over.

Another problem related to transparency lies in determining the threshold values for the various parameters at which alarms must be declared. Very often these values depend on the bit rate on the channel and should ideally be set depending on the bit rate. However, in a truly transparent network, one may have to set alarms to correspond to the highest possible bit rate that can be present on a channel. In addition, since a signal is not terminated at an intermediate node, if a wavelength fails, all nodes along the path downstream of the failed wavelength could trigger an alarm. This can lead to a large number of alarms for a single failure, and makes it somewhat more complicated to determine the cause of the alarm (alarm correlation).

The following OPM functions will have to be monitor, measured and managed:

(a) Dispersion (chromatic and polarization mode):

The distortion or spreading of bits due to variations in propagation velocity of different wavelengths and polarization modes in the fiber and other network elements.

(b) Optical signal-to-noise ratio (OSNR):

The ratio of optical power in a primary data channel to the power in optical background noise accumulated during transmission and switching. This ratio is usually specified within some optical bandwidth of a receiver filter. The OSNR of a channel at the destination receiver will set the limit of the final detected SNR.

(c) Bit-rate:

The data rate of the channel in a transparent system will be necessary to make decisions on other performance metrics.

(d) Q-Factor:

A measure of the signal-to-noise ratio (SNR) assuming Gaussian noise statistics.

(e) Wavelength registration:

The determination of which wavelengths are present on a given fiber.

(f) Wavelength selective component drift:

The drift of a laser, filter, multiplexer or other wavelength selective component relative to the ITU grid.

(g) Optical cross-talk:

Two types of cross talk are of interest, in-band and out-of-band. In-band cross talk is seen as at the same wavelength as the primary channel and appears as cross talk in the electronic domain. Out-of-band cross talk appears as a different wavelength in the presence of the primary wavelength and appears as cross talk in the optical domain.

(h) Optical power transients:

Changes in the optical powers that are not due to normal bit transitions. These changes may be due to optical amplifier gain transients or other transient non-linearity in the system.

(i) Bit-error-rate:

In a SONET environment BER can be directly measured on the channel using means to look at its within the data stream. However, in a purely optical network there will typically not be access to the data streams carried over the channel. However, by interpreting the other optical parameters, the system should be able to estimate the BER with relatively good accuracy, as well as guarantee bit error rate performance to the users of the channel.

(j) Jitter:

Random fluctuations in the location of rising and falling edges of bits relative to a local or recovered clock reference. As line speeds continue to increase, jitter will become a critical performance parameter.

(k) Insertion loss:

Indicates the input to output loss of a network element. When examining excessive power loss along the path of a channel the ability to measure insertion loss of individual network elements is very useful, specifically when compared against an archival database.

(l) Optical power level:

In addition to verifying the service level provided by the network to the user, performance monitoring is also necessary to ensure that the users of the network comply with the requirements that were negotiated between them and the network operator. For example, one function may be to monitor the wavelength and power levels of signals being input to the network to ensure that they meet the requirements imposed by the network.

To make any Performance Measurement metrics meaningful, major effort should be on conducting serious testing to draw correlation between the proposed Optical measurement metrics with the quality of the signals (electrical).

3.4 High-Level Signaling for Network Management

The vast majority of installed communication networks uses framing and data formatting overhead as the means to communicate between network elements and management systems. It is clear however, that truly transparent and open optical networks can only be built with transparent signaling support. Arguments in favor of transparency include, but are certainly not limited to:

(a) Framing and formatting makes the network opaque and as such inhibits the creation of bit rate and protocol transparent networks. As overhead information is processed in the digital domain, it requires an optical-to-electrical and electrical-to-optical conversion at every point in the network where traffic is inserted or dropped and at each point where management and monitoring is required. This imposes severe limitations and is probably the single biggest inhibitor of growth in current optical networks.

(b) Attached internetworking equipment and customer equipment may not support the framing overheads.

(c) In today's optical network (e.g., SONET) the service and infrastructure layer are inseparable. As a result, “optical-network-ignorant” protocols such as 10 gigabit Ethernet, fiber channel or ESCON cannot be transported without being translated in the infrastructure layer. Hence the need for adaptations such as “gigabit Ethernet over SONET”, “packet over SONET” etc.

However, there are issues with a separate control channel. For example, there may be instances where some “embedded” wavelength routing information is required. One such instance is in existing networks where DWDM junctions are “hard-wired” and the end-to-end path may consist of different wavelengths. It is worth mentioning that while the signaling is used to communicate all monitoring results, the monitoring itself is done on the actual data channel, or some range of bandwidth around the channel. Therefore, all network elements must be guaranteed to pass this bandwidth in order for monitoring to happen at any point in the network.

Several signaling flows have to be supported:

(a) Between the internetworking equipment and the photonic cross-connect.

(b) Between the photonic cross-connect and the DWDM transmission systems.

(c) Between the DWDM systems and optical amplifiers.

(d) Between the DWDM systems and optical add/drop multiplexers (OADM).

(e) Between the internetworking devices and optical add/drop multiplexers or DWDM transmission systems (if this connection does not run through a PXC).

The connection signaling is limited to exchanges between the internetworking device and a directly connected transmission network. This transmission element (e.g., an optical cross-connect) then interfaces with the DWDM systems (if present) and so forth. This allows the optical switches to discover the transmission network topology and characteristics prior to attached devices asking for connections. It also caters for the continued support of any proprietary signaling that may already exist between DWDM and/or other transmission systems (whether in-band or out-of-band). All that is required is support of the standard external signaling interface.

The above signaling flows should be supported on a dedicated wavelength, configured throughout the network. This dedicated control channel/wavelength can be part of the standard ITU grid considering that the combination of existing C-band (1530- to 1560-nm) and the emerging S- (upper 1400-nm region) and L- (1570- to 1625-nm) transmission bands will leave little room for suitable non-ITU wavelengths.

Since dedicating an entire wavelength might not always be viable, there exists a possibility of using this wavelength also for data traffic and envisage a way of sending the non-time-critical traffic in between the management traffic.

The signaling protocol can easily be based on existing protocols. A slightly modified OSPF can be used for optical network topology discovery and distribution, as well as for route computation and path selection. Topology advertisement includes not only the nodes and the links to the nodes, but also characteristics of the links. The actual signaling protocol can be RSVP as extended for MPLS/TE. Finally, path management includes monitoring the path for failures, knowledge of failure restoration policies, and path teardown.

3.5 Low-Level Signaling for Device/Subsystem Control

Low-level signaling is needed to assist real-time control of optical network devices such as erbium doped fiber amplifiers (EDFAs) that are not necessarily situated in an optical network node or part of an OLCX. Also, if a separate control wavelength is used, there has to be synchronization mechanism in place to synchronize the switching operations. One way to accomplish that is to provide smart signaling by the devices or subsystems in the data channels to work with the high-level signaling from the control channel for optical wavelength switching. Real-time parameters of the devices and subsystems to be monitored can be sent to the control channel via low-level signaling to aid in real-time performance monitoring.

4 Multi-Protocol Lambda Switching and Issues

4.1 Introduction

This section describes an IETF proposal for combining MPLS Traffic Engineering Control with Optical Crossconnects (OXCs) which leverages existing control plane techniques developed for MPLS Traffic Engineering. The main idea it to leverage recent advances in control plane technology developed for MPLS traffic engineering. This approach is driven by pragmatic considerations, as it exploits an existing technology base to foster rapid development and deployment of a new class versatile OXCs that address the optical transport needs of the rapidly evolving Internet. This approach can assist in optical channel layer bandwidth management, dynamic provisioning of optical channels, and network survivability through enhanced protection and restoration capabilities in the optical domain.

For the purpose of discussing this approach, an OXC is a path switching element in an optical transport network that establishes routed paths for optical channels by locally connecting an optical channel from an input port (fiber) to an output port (fiber) on the switch element. The proposed OXC control plane uses the IGP extensions for MPLS traffic engineering (with additional enhancements) to distribute relevant optical transport network state information, including topology state information. This state information is subsequently used by a constraint-based routing system to compute paths for point-to-point optical channels through the optical transport network. The proposed OXC control plane also uses an MPLS signaling protocol to instantiate point-to-point optical channels between access points in the optical transport network. This proposal does not specify the details of the extensions and domain specific adaptations required to map the MPLS traffic engineering control plane model onto the optical domain.

The proposed approach combines recent advances in MPLS traffic engineering control plane constructs with OXC technology to:

(a) provide a framework for real-time provisioning of optical channels in automatically switched optical networks,

(b) foster the expedited development and deployment of a new class of versatile OXCs, and

(c) allow the use of uniform semantics for network management and operations control in hybrid networks consisting of OXCs and label switching routers (LSRs).

The proposed approach is particularly advantageous for OXCs intended for data-centric optical internetworking systems. In such environments, it will help to simplify network administration. This approach also paves the way for the eventual incorporation of DWDM multiplexing capabilities in IP routers. The advantages of the proposed approach are as follows:

(a) It offers a framework for optical bandwidth management and the real-time provisioning of optical channels in automatically switched optical networks.

(b) It exploits recent advances in MPLS control plane technology and also leverages accumulated operational experience with IP distributed routing control.

(c) It obviates the need to reinvent a new class of control protocols for optical transport networks and allows reuse of software artifacts originally developed for the MPLS Traffic Engineering application. Consequently, it fosters the rapid development and deployment of a new class of versatile OXCs.

(d) It facilitates the introduction of control coordination concepts between data network elements and optical network elements.

(e) It simplifies network administration in facilities based service provider networks by providing uniform semantics for network management and control in both the data and optical domains.

(f) It paves the way for the eventual introduction of DWDM multiplexing capabilities on IP routers

(g) Lastly, it establishes a preliminary framework for the notion of an optical Internet.

4.2 OXCs, LSRs, Optical Trails, and Explicit LSPs

The concept IP (Internet Protocol) switching for IP traffic is well documented. Recently, a new protocol known as MPLS has been proposed to the Internet Engineering Task Force (IETF) to improve on the efficiency and scalability of IP data routers and switches. The Multi-protocol Label Switching (MPLS) architecture has been defined to support the forwarding of data based on a label. In this label-based architecture, Label Switching Routers (LSRs) have a forwarding plane that is capable of (a) recognizing either packet or cell boundaries, and (b) being able to process either packet headers (for LSRs capable of recognizing packet boundaries) or cell headers (for LSRs capable of recognizing cell boundaries).

Consider a hybrid, IP-centric optical internetworking environment consisting of both label switching routers (LSRs) and OXCs, where the OXCs are programmable and support wavelength conversion/translation. At a level of abstraction, an LSR and an OXC exhibit a number of isomorphic relations. It is important to enumerate these relations because they help to expose the reusable software artifacts from the.

MPLS traffic engineering control plane model. Architecturally, both LSRs and OXCs emphasize problem decomposition by decoupling the control plane from the data plane. The data plane of an LSR uses the label swapping paradigm to transfer a labeled packet from an input port to an output port. The data plane of an OXC uses a switching matrix to connect an optical channel trail from an input port to an output port.

An LSR performs label switching by first establishing a relation between an <input port, input label> tuple and an <output port, output label> tuple. Likewise, an OXC provisions optical channel trails by first establishing a relation between an <input port, input optical channel> tuple and an <output port, output optical channel> tuple. These relations are determined by the control plane of the respective network elements, and are locally instantiated on the device through a switch controller. In the LSR, the next hop label forwarding entry (NHLFE) maintains the input-output relations. In the OXC, the switch controller reconfigures the internal interconnection fabric to establish the relations. These relations cannot be altered by the payload of the data plane.

The functions of the control plane (for both LSRs and OXCs) include resource discovery, distributed routing control, and connection management. In particular, the control plane of the LSR is used to discover, distribute, and maintain relevant state information associated with the MPLS network, and to instantiate and maintain label switched paths (LSPs) under various MPLS traffic engineering rules and policies. An LSP is the path through one or more LSRs followed by a specific forwarding equivalence class (FEC). An explicit LSP is one whose route is defined at its origination node.

The control plane of the OXC, on the other hand, is used to discover, distribute, and maintain relevant state information associated with the OTN, and to establish and maintain optical channel trails under various optical internetworking traffic engineering rules and policies. An optical channel trail provides a unidirectional point-to-point optical connection between two access points. An optical channel trail may consist of just one wavelength or a concatenation of multiple wavelengths.

If an optical trail consists of just one wavelength, then it is said to satisfy the “wavelength continuity property.” At each intermediate OXC along the route of an optical channel trail, the trail is routed from an input port to an output port. A distinction between the current generation of OXCs and LSRs is that the former does not perform packet level processing in the data plane, while the later are datagram devices which may perform certain packet level operations in the data plane. The really significant conceptual difference, however, is that with LSRs the forwarding information is carried explicitly as part of the labels appended to data packets, while with OXCs the switching information is implied from the wavelength or optical channel.

4.2.1 Review of Relevant OXC Characteristics

This section contains a brief overview of relevant OXC characteristics, focusing on the switching functions and underlying technologies. The switching function of an OXC may be electrical or optical. If the switching fabric is purely electrical, then the crossconnect is referred to as a digital crossconnect (DXC), or a broadband digital cross-connect (BBDXC)-if the capacity and port density are sufficiently high. Optical-Electrical-Optical (OEO) conversion is required in BBDXCs.

A BBDXC may or may not have WDM multiplexing capabilities. If a BBDXC has WDM multiplexing capabilities, then it may be connected directly to other compatible WDM devices through optical fiber links that carry multiple wavelengths per fiber. If a BBDXC does not have WDM multiplexing capabilities, then it may be connected to an external DWDM multiplexer through a set of discrete fibers, where each fiber carries only one wavelength. A BBDXC may also perform regeneration, reshaping, and re-timing functions.

If the switching fabric of an OXC is completely photonic, then we refer to the cross-connect as a pure OXC. If the granularity of channel switching is the wavelength, then the OXC is called a wavelength routing switch (WRS), or simply a wavelength router. The problem of establishing optical channel trails using WRS is called the “Routing and Wavelength Assignment problem” (RWA). An OXC may also be equipped with both electrical and optical switching capabilities. In this situation, some channels may be switched in the electrical domain and others in the optical domain. Other terms commonly used within the context of optical transport network switching elements include: wavelength selective crossconnects (WSXC) and wavelength interchanging crossconnects (WIXC). In this section, we use the generic term OXC to refer to all categories of programmable and reconfigurable crossconnects for optical transport networks, irrespective of the technologies that underlie them.

The OXC control plane design approach described in this document is independent of the underlying OXC switch technologies. It is also independent of specific OXC implementation details. Local adaptation mechanisms can be used to tailor the control plane onto various OXC implementations with different hardware capabilities. As an example, a local adaption function can map a channel/port input/output relation into specialized low level instructions to actuate a rearrangement of the crossconnect switch fabric such that the required input/output relation is realized.

4.2.2 Explicit LSPs and Optical Channel Trails

At a conceptual level, explicit LSPs and optical channel trails exhibit certain commonalities. Essentially, they are both fundamentally unidirectional, point-to-point virtual path connection abstractions. An explicit LSP provides a parameterized packet forwarding path (traffic-trunk) between an ingress LSR and an egress LSR. Correspondingly, an optical channel trail provides a (possibly parameterized) optical channel between two endpoints for the transport of client digital signals. The payload carried by both LSPs and optical trails are transparent to intermediate nodes along their respective paths. Both LSPs and optical trails can be parameterized to stipulate their performance, behavioral, and survivability requirements from the network.

A set of LSPs induces a virtual graph on a data network topology, while a set of optical trails induce a virtual graph on the topology of a fiber plant. A constraint-based routing scheme can be used to select appropriate paths for both LSPs and optical trails. Generally such paths may satisfy some demands and policy requirements subject to some constraints imposed by the operational environment.

There are also commonalities in the allocation of labels to LSPs and in the allocation of wavelengths to optical trails. Two different LSPs that traverse through a given LSR port or interface cannot be allocated the same label. The exception is for LSP aggregation using label merge or label stacking. Similarly, two different optical trails that traverse through a given OXC port cannot be allocated the same wavelength. It is significant to note, however, that an analog to label stacking does not exist in the optical domain at this time.

4.3 Generic Requirements for the OXC Control Plane

The following section contains the requirements for the OXC control plane, with emphasis on the routing components of these requirements. There are three key aspects to these requirements:

(a) The capability to establish optical channel trails expeditiously, (in seconds or even milliseconds rather than days or months).

(b) The capability to support traffic engineering functions, (see note below)

(c) The capability to support various protection and restoration schemes.

Note: the introduction of DWDM and automatically switched optical networks is unlikely to eliminate the need for traffic engineering. Instead, it will simply mandate OXCs to also support some traffic engineering capabilities.

Historically, the “control plane” of optical transport networks has been implemented via network management. This approach has the following detrimental effects:

(a) It leads to relatively slow convergence following failure events (typical restoration times are measured in minutes, or even days and weeks especially in systems that require explicit manual intervention).

(b) The only way to expedite service recovery in such environments is to pre-provision dedicated protection channels.

(c) It complicates the task of interworking equipment from different manufacturers, especially at the management level (generally, a custom “umbrella NMS or OSS” is required to integrate otherwise incompatible Element Management Systems from different vendors)

(d) It precludes the use of distributed dynamic routing control in such environments.

(e) It complicates the task of inter-network provisioning (due to the lack of EDI between operator NMSs).

Another important motivation for the approach described in this section is to improve the responsiveness of the optical transport network, and to increase the level of interoperability within and between service provider networks.

4.4 MPLS Traffic Engineering as a Generic Control Plane for OXCs

4.4.1 Overview of the MPLS Traffic Engineering Control Plane

The MPLS traffic engineering control plane is a synthesis of new concepts in IP traffic engineering (enabled by MPLS) and the conventional IP network layer control plane. The high level requirements for traffic engineering over MPLS were articulated in IETF RFC-2702. It is the combination of the notions defined in RFC-2702 (including relevant extensions) with the conventional IP control plane constructs that effectively establishes a framework for the MPLS traffic engineering control plane model. The components of the MPLS traffic engineering control plane model include the following modules:

(a) Resource discovery.

(b) State information dissemination, which is used to distribute relevant information concerning the state of the network, including topology and resource availability information. In the MPLS context, this is accomplished by extending conventional IP link state interior gateway protocols to carry additional information in their link state advertisements.

(c) Path selection, which is used to select an appropriate route through the MPLS network for explicit routing. It is implemented by introducing the concept of constraint-based routing which is used to compute paths that satisfy certain specifications subject to certain constraints, including constraints imposed by the operational environment.

(d) Path management, which includes label distribution, path placement, path maintenance, and path revocation. These are used to establish, maintain, and tear down LSPs in the MPLS context. The label distribution, path placement, and path revocation functions are implemented through a signaling protocol, such as the RSVP extensions or through CR-LDP.

These components of the MPLS traffic engineering control plane are separable, and independent of each other. This is a very attractive feature because it allows an MPLS control plane to be implemented using a composition or synthesis of best of breed modules. In RFC-2702, several new MPLS control plane capabilities were proposed that allow various traffic engineering policies to be actualized in MPLS networks. Many of these capabilities are also relevant and applicable to automatically switched optical transport networks with reconfigurable OXCs.

We will summarize some of these capabilities below, focusing on the set of attributes that can be associated with traffic-trunks. A traffic-trunk is an aggregation of traffic belonging to the same class which are forwarded through a common path. In general, the traffic-trunk concept is a technology independent abstraction. In RFC 2702, it was used within the context of MPLS and allowed certain attributes of the traffic transported through LSPs to be parameterized. The traffic-trunk concept can also be extended, in an obvious manner, to the optical transport network.

As stipulated in RFC-2702, the attributes that can be associated with traffic-trunks include:

(1) traffic parameters which indicate the bandwidth requirements of the traffic-trunk,

(2) adaptivity attributes which specify the sensitivity of the traffic-trunk to changes in the state of the network and in particular indicates whether the traffic-trunk can be re-routed when “better” paths become available,

(3) priority attributes which impose a partial order on the set of traffic-trunks and allow path selection and path placement operations to be prioritized,

(4) preemption attributes which indicate whether a traffic-trunk can pre-empt an existing traffic-trunk from its path,

(5) resilience attributes which stipulate the survivability requirements of the traffic-trunk and in particular the response of the system to faults that impact the path of the traffic-trunk, and

(6) resource class affinity attributes which further restrict route selection to specific subsets of resources and in particular allow generalized inclusion and exclusion policies to be implemented.

(7) Concepts of subscription (booking) factors are also supported to either bound the utilization of network resources through under-subscription or to exploit statistical multiplexing gain through over-subscription (this aspect is also not very relevant in the OXC context).

It should be clear that a subset of these capabilities can be mapped onto an optical transport network by substituting the term “traffic-trunk” with the term “optical channel trail.” The MPLS control plane also supports the notion of abstract nodes. An abstract node is essentially a set of nodes (e.g., a subnet, an autonomous system, etc) whose internal topology is opaque to the origination node of an explicit LSP. So, in the most general manner, the route of an explicit LSP (or traffic-trunk) can be specified as a sequence of single hops and/or as a sequence of abstract nodes.

The MPLS control plane is very general and is also oblivious of the specifics of the data plane technology. In this regard, the MPLS control plane can be used in conjunction with a data plane that (a) does not necessarily process IP packet headers and (b) does not know about IP packet boundaries. For an existence proof, note that the MPLS control plane has been implemented on IP-LSRs, ATM-LSRs, and Frame Relay-LSRs. The MPLS control plane may also be implemented on OXCs.

4.4.2 Synthesizing the MPLS Traffic Engineering Control Plane with OXCs

Given that that both OXCs and LSRs require control planes, one option would be to have two separate and independent control planes—one for OXCs, and another for LSRs. To understand the drawbacks of this approach, especially in IP-centric optical internetworking systems, one need to look no further than the experience with IP over ATM, where IP has its own control plane (BGP, IS-IS, OSPF), and ATM its own control plane (PNNI). Given that the control planes for both OXCs and LSRs have relatively similar requirements, an alternative approach is to develop a uniform control plane that can be used for both LSRs and OXCs.

Such a uniform control plane will eliminate the administrative complexity of managing hybrid optical internetworking systems with separate, dissimilar control and operational semantics. Specializations may be introduced in the control plane, as necessary, to account for inherent peculiarities of the underlying technologies and networking contexts.

All of the above observations suggest, therefore, that the MPLS Traffic Engineering control plane (with some minor extensions) would be very suitable as the control plane for OXCs. An OXC that uses the MPLS traffic engineering control plane would effectively become an IP addressable device. The establishment of optical channel trails, OTN traffic engineering functions, and protection and restoration capabilities would be provided by the MPLS Traffic Engineering control plane.

An out-of-band IP communications system can be used to carry and distribute control traffic between the control planes of OXCs, perhaps through dedicated supervisory channels (using dedicated wavelengths or channels, or an independent out-of-band IP network). In this environment, SNMP, or some other network management technology, could be used for element management. From the perspective of control semantics, an OXC with an MPLS Traffic Engineering control plane would resemble a Label Switching Router.

If the OXC is a wavelength routing switch, then the physical fiber between a pair of OXCs would represent a single link in the OTN network topology. Individual wavelengths or channels would be analogous to labels. IS-IS or OSPF, with extensions for traffic engineering would be used to distribute information about the optical transport network topology and information about available bandwidth and available channels per fiber, as well as other OTN network topology state information. This information will then be used to compute explicit routes for optical channel trails. An MPLS signaling protocol, such as RSVP extensions, will be used to instantiate the optical channel trails. Using the RSVP extensions, for example, the wavelength information or optical channel information (as the case may be) will be carried in the LABEL object, which will be used to control and reconfigure the OXCs.

The use of a single control plane for both LSRs and OXCs introduces a number of interesting (and potentially advantageous) possibilities. A single control plane (MPLS Traffic Engineering) would be able to span both routers and OXCs. In such an environment a Label Switching Path could traverse an intermix of routers and OXCs, or could span just routers, or just OXCs. This offers the potential for real bandwidth-on-demand networking, in which an IP router may dynamically request bandwidth services from the optical transport network. To bootstrap the system, OXCs must be able to exchange control information. One way to support this is to pre-configure a dedicated control wavelength between each pair of adjacent OXCs, or between an OXC and a router, and to use this wavelength as a supervisory channel for exchange of control traffic. Another possibility, which has already been mentioned, is to construct a dedicated out of band IP network for the distribution of control traffic.

Even though an OXC equipped with an MPLS traffic engineering control plane would (from a control perspective) resemble a Label Switching Router, there are some important distinctions and limitations. One distinction concerns the fact that there are no analogs of label merging in the optical domain. This implies that an OXC cannot merge several wavelengths into one wavelength. Another distinction is that an OXC cannot perform the equivalent of label push and pop operations in the optical domain. This is because the analog of a label in the OXC is a wavelength or an optical channel, and the concept of pushing and popping wavelengths is infeasible with contemporary commercial optical technologies.

In the proposed control plane approach, an OXC will maintain a WFIB (Wavelength Forwarding Information Base) per interface (or per fiber). This is because lambdas and/or channels (labels) are specific to a particular interface (fiber), and the same lambda and/or channel (label) could be used concurrently on multiple interfaces (fibers). The MPLS traffic engineering control plane is already being implemented on data plane technologies that exhibit some of the aforementioned distinctions. For example, an ATM-LSR supports only a subset of the MPLS functionality. In particular, most ATM-LSRs are incapable of merging Label Switching Paths, and may not be able to perform label push/pop operations as well. Also, similar to the approach proposed here for OXCs, ATM-LSRs have per interface LFIB (Label Forwarding Information Base).

Yet another important distinction concerns the granularity of resource allocation. An MPLS Label Switching Router which operates in the electrical domain can potentially support an arbitrary number of LSPs with arbitrary bandwidth reservation granularities (bounded by the maximum reserveable bandwidth per interface and the amount of required control overhead). In sharp contrast, an OXC can only support a relatively small number of optical channel trails (this may change as the technology evolves), each of which will have coarse discrete bandwidth granularities (e.g., OC-12, OC-48, and OC-192). A special degenerate case occurs when the control plane is used to establish optical channel trails which all have a fixed bandwidth (e.g., OC-48). If the bandwidth associated with an LSP is small relative to the capacity of an optical channel trail, then very inefficient utilization of network resources could result if only one LSP is mapped onto a given optical channel trail. To improve utilization of resources, therefore, it is necessary to be able to map several low bandwidth LSPs onto a relatively high capacity optical channel trail.

For this purpose, a generalized notion of “nested LSPs” may be used. Note that since an OXC cannot perform label push/pop operations, the start/end of a nested LSP has to be on a router (as nesting requires label push/pop). Also note that in this nesting situation, it is the wavelength of the “container” optical channel trail itself that effectively constitutes the outermost label. The transparency and multi-protocol properties of the MPLS Control Plane approach would allow an OXC to route optical channel trails carrying various types of digital payloads (including IP, ATM, SONET) in a coherent and uniform way.

4.5 Control Adaptation

This section provides a high level overview of the architectural considerations involved in tailoring the MPLS traffic engineering control plane model to the optical domain. In adapting the MPLS traffic engineering control plane model to OXCs, a number of critical issues needs to be considered. One critical issue concerns the development of OTN specific domain models which abstracts and captures relevant characteristics of the OTN. The domain models help to delineate the design space for the control plane problem in OXCs, and to construct domain specific software reference architectures.

A domain model includes functional and structural aspects. For the purpose of the present discussions, however, we have grouped the considerations pertaining to OTN domain models into two categories: (1) a horizontal dimension and (2) a vertical dimension. The horizontal dimension pertains to the specific networking requirements of the OTN environment. It indicates the enhancements needed to the MPLS TE control plane model to address the peculiar OTN networking requirements. The vertical dimension pertains to specific localized hardware and software characteristics of the OXCs, which helps to determine the device specific adaptations and mechanisms needed to port the MPLS TE control plane model software artifacts onto an OXC.

Horizontal dimension considerations include the following aspects:

(a) What type of OTN state information needs to be discovered and disseminated to support path selection for optical channel trails? Such state information may include domain specific characteristics of the OTN (encoded as metrics), such as attenuation, dispersion (chromatic, polarization), etc. This aspect will determine the type of additional extensions that are required for IGP link state advertisements to distribute such information.

(b) What infrastructure will be used to propagate the control information?

(c) How are constrained paths computed for optical channel trails which fulfill a set of performance and policy requirements subject to a set of system constraints?

(d) What are the domain specific requirements for setting up optical channel trails and what are the enhancements needed to existing MPLS signaling protocols to address these requirements?

Vertical dimension considerations include the aspects required to practically port MPLS control plane software onto an OXC.

In terms of vertical dimensions, a candidate system architecture for an OXC equipped with an MPLS control plane model is shown in FIG. 5 below.

4.6 Architectural Considerations for Deployment in Operational Networks

This section provides a high level overview of the architectural considerations for deployment of the proposed control plane in operational networks consisting of LSRs and OXCs. These architectural issues have implications on the degree of control isolation and control cohesion between LSRs and OXCs.

Essentially, there are two basic architectural options for deployment of the proposed control plane in an operational context consisting of LSRs and OXCs.

(a) One option is to use different instances of the control plane in the OTN (OXC) and IP (LSR) domains. In this situation, each instance of the control plane will operate independent of the other. Interworking (including control coordination) between the two domains can be established through static configuration or through some other procedures that are outside the scope of this document. This partitioned deployment option allows maximal control isolation between the OTN and IP domains. This scheme is conceptually similar to the model in use today, whereby the OTN simply provides point-to-point channels between IP network elements with very minimal control interaction between the two domains.

(b) Another option is to use a single instance of the control plane that subsumes and spans LSRs and OXCs.

To improve scalability the control plane may use routing hierarchy (e.g., routing areas). Hierarchy may be applied in either situation.

Furthermore, in the option with multiple control plane instances, hierarchy could be enabled for each control plane instance independent of the others. In the deployment option with a single instance of the control plane, each routing area may maintain a link state database that contains:

(a) physical LSPs (fiber links),

(b) optical LSPs (optical channel trails), and

(c) logical LSPs (conventional label switched paths).

As a general rule, all these path-oriented connection entities could simply be considered as LSPs with different characteristics. The origination LSR (the head-end) of each LSP entity may locally decide whether to advertise the LSP (with appropriate attributes), so that other LSRs could use it as a link for subsequent path computations.

There are significant tradeoffs to the above deployment options, including aspects related to fault isolation. There are also some details that have been left out of these discussions. One of the advantages of the control plane design approach described in this memo is that it potentially allows network administrators the option to make these deployment architectural decisions based on their specific objectives and service models.

4.7 The Concept of a TI-LSR Domain

This section introduces terminology that is pertinent to the Multi-protocol Lambda Switching concept. We discuss the notions of termination-capable interfaces and termination-incapable interfaces, and a related concept of termination-incapable domain.

A termination-capable (TC) interface on an LSR is an interface which is capable of terminating a label switched path (LSP) and subsequently demultiplexing the data carried by the LSP to make further routing/switching decisions. This definition does not pertain to management and control traffic destined for the LSR. A point-to-point interface terminating on an IP router that implements MPLS is an example of a TC interface. A termination-incapable (TI) interface is one which is incapable of terminating LSPs and demultiplexing the data carried by the LSPs to make further routing/switching decisions. A fiber connected to a pure OXC is an example of a TI interface. The definition of TI does not pertain to interfaces which terminate management and control traffic destined for the LSR. For a given bi-directional link, the interfaces associated with the endpoints of the link may be of different types with respect to their capability to terminate LSPs. For example, consider a link between a pure OXC and a (frame-based) LSR (e.g., an IP router); the interface with the OXC is TI while the interface with the frame-based LSR is TC.

A single network element may simultaneously have both TC and TI interfaces. For example, it is easy to envision an optical device that switches traffic on some interfaces based on the wavelength or the optical channel trail through which the traffic was received, and switches traffic on other interfaces based on the label information carried by packets. A hybrid physical interface in which traffic on certain wavelengths or optical channel trails are forwarded based on the wavelength or optical channel trail through which the traffic was received, and traffic on other wavelengths or optical channel trails are forwarded based on the label information carried by the packets. Such physical interfaces may be considered as two separate logical interfaces, one TC and the other TI.

If all the interfaces on an LR are TI interfaces, then such an LSR will be referred to as a TI-LSR. A contemporary OXC-LSR that provides transit services for data traffic is an example of a TI-LSR (an ATM-LSR within the context of IP-over-ATM is another example of a TI-LSR). If an LSR has at least one TC interface, then such an LSR is referred to as a TC-LSR. A router that implements MPLS is an example of a TC-LSR.

A TI-LSR domain is a set of TI-LSRs which are mutually interconnected by TI interfaces. A transit optical transport network (OTN) composed of contemporary OXC-LSRs is an example of a TI-LSR domain. The Edge set of a TI-LSR domain is the set of TC-LSRs that are interconnected to members of the domain by links with a TC interface on a TC-LSR and a TI interface on a TI-LSR. A TC-LSR which is a member of an Edge set of a TI-LSR domain is called an Edge LSR.

Examples of edge LSRs include client network elements and access devices that interconnect to the OTN. FIG. 6 below depicts an illustrative network with a single TI-LSR domain consisting of OXCs (O1 through O8) surrounded by an Edge set of TC-LSRs consisting of access routers (M0 through M4). By definition LSPs cannot start/terminate on LSRs within a TI-LSR domain. LSPs can, however, start and terminate on TC-LSRs belonging to the Edge set of a TI-LSR domain as well as on devices situated beyond the edge set.

4.8 Required Enhancements to OXCs and WDM Devices to Support MPLS

The following discussion contains a list of some basic required enhancements to OXCs and other WDM devices to support MPL(ambda)S:

(a)There should be a mechanism to exchange control information between OXCs, and between OXCs and other LSRs. This can be accomplished in-band or quasi-in-band using the same links

(fibers) that are used to carry data-plane traffic, or out-of-band via a separate network. A combination of in-band and out-of-band mechanisms may also be appropriate under certain circumstances.

(b) An OXC must be able to provide the MPLS Traffic Engineering control plane with pertinent information regarding the state of individual fibers attached to that OXC, as well the state of individual lightpaths or optical channel trails within each fiber.

(d) An edge LSR might not have intrinsic WDM capabilities. Instead, it might interface to an external WDM device, using a suitable technology such as SONET, GigEthernet, etc.

Even when an edge LSR does not have WDM capabilities, it should still have the capability to exchange control information with the OXCs in the domain.

4.9 Required Enhancements to the Current MPLS Control Plane.

This section describes some basic required enhancements to the MPLS traffic engineering control plane components (including ISIS/OSPF and RSVP) in order to support MPL(ambda)S. Part (A) of this section covers general enhancements while part (B) covers enhancements that are specific to the nesting of LSPs.

(a) General Enhancements

An MPLS domain may consist of links with different properties depending upon the type of network elements at the endpoints of the links (e.g., some of links may interconnect OXCs, some links may interconnect frame-based LSRs and OXCs, while other links may interconnect frame-based LSRs). Within the context of Multi-protocol Lambda Switching, the properties of a link consisting of a fiber with WDM that interconnects two OXCs are different from the properties of a SONET link that interconnects two LSRs. For example, a conventional LSP cannot be terminated on a link connected to a pure OXC.

However, a conventional LSP can certainly be terminated on a link connected to a frame-based LSR. These differences should be taken into account when performing path computations to determine an explicit route for an LSP. Additionally, since the performance characteristics of an LSP will depend on the characteristics of the links traversed by the LSP, it may be useful to have the capability to restrict the path of some LSPs to links with certain characteristics. The concept of resource class attributes is one approach to accomplish this containment, but other mechanisms may also be feasible. Thus, for example, it may be desirable for an IGP to carry information regarding whether a particular link is TC or TI. Path computation algorithms may then take this information into account when computing paths LSPS.

In certain contexts there may be multiple control channels and bearer channels between a pair of adjacent OXCs. Procedures are needed, therefore, to associate control channels to bearer channels in such circumstances. Furthermore, if a control channel is associated with multiple bearer channels, then procedures are required to demultiplex the control traffic for different bearer channels. Procedures are also needed to activate and deactivate bearer channels, to verify proper operation of bearer channels, and to assign bearer channels to an LSP during the process of LSP establishment.

The procedures needed to accomplish the objectives include the following aspects: a method to identify the bearer channels associated with any given physical link, methods to identify spare bearer channels for protection purposes (e.g., 1+1, 1:1, and 1:N protection schemes), and methods to identify an impaired bearer channel (especially in the situation where the physical links carrying the bearer channel are not impaired).

To perform the signaling function in Multi-Protocol Lambda Switching networks, RSVP should be extended with Objects, such that when used in conjunction with available information propagated through the IGP, the RSVP Objects will be able to provide sufficient details to establish reconfiguration parameters for OXC switch elements.

When a pair of OXCs are directly connected by multiple links (fibers), an IGP needs to carry information about the physical diversity of the fibers. Because conventional LSRs and OXCs may support different granularities of bandwidth allocation, an IGP should be able to distribute information regarding the allocatable bandwidth granularity of any particular link. This information should allow multiple granularities within a single link. It should also allow different granularities per priority.

(b) Specific Enhancements for LSP

The capability to aggregate LSPs through the notion of nested LSPs is an important aspect of using the MPLS traffic engineering control plane with OXCs. Using the MPLS traffic engineering control plane, several methods can be used to implement nested LSPs.

One way to accomplish this is to have a single MPLS traffic engineering control plane instance for both conventional LSRs and OXCs, but to allow the control plane to treat subsets of the LSPs as links for the purpose of establishing new LSPs (by the same control plane).

In this way, the MPLS traffic engineering control plane could use an LSP (which it had previously instantiated) as a link to establish a new LSP. In principle, this technique can be applied recursively to form several depths of LSP nesting.

Another way to accomplish LSP nesting is to have more than one instance of the MPLS traffic engineering control plane, and to allow LSPs created by one instance of the control plane to be used as links by another instance of the control plane. The following paragraphs present a list of required enhancements to the MPLS traffic engineering control plane components (ISIS/OSPF and RSVP) in order to support the capability to aggregate and nest LSPs in MPL(ambda)S:

(a) The LSP setup procedures should include support for an LSR at the edge of a TI-LSR domain to aggregate multiple LSPs coming from outside of the TI-LSR domain into an LSP that consists of an optical channel trail.

(b) An LSR should be able to advertise into an IGP a link that is formed from an LSP originated by the LSR, The IGP should be able to advertise the link state for such links. The link state information can be used subsequently for path computations for other LSPs.

(c) In scenarios with more than one instance of the MPLS traffic engineering control plane, one instance of the control plane should be able to advertise LSPs created and maintained by that instance as links to another instance of the MPLS traffic engineering control plane. The instances of the control plane may reside on the same network element or on different network elements.

It should be noted that the capability to aggregate LSPs through nesting may be useful in contexts outside of the OXC environment. Therefore the required enhancements specified above to support aggregation of LSPs through nesting should be implemented in a manner such that they remain applicable in conventional non-OXC environments.

5 Generalized MPLS-Signaling Functional Description

5.1 Overview

The MPLS architecture has recently been extended to include LSRs whose forwarding plane recognizes neither packet, nor cell boundaries, and therefore, cannot forward data based on the information carried in either packet or cell headers. Specifically, such LSRs include devices where the forwarding decision is based on time slots, wavelengths, or physical ports. The extended architecture is known as Generalized MPLS to differentiate it from the traditional MPLS. Generalized MPLS extends the traditional MPLS protocol to encompass time-division-multiplexing (e.g. SONET ADMs), wavelength (optical Lambdas) and spatial switching (e.g. incoming port or fiber to outgoing port or fiber).

This section presents a functional description of the Generalized MPLS signaling for optical networking using DWDM. Only the MPLS extensions applicable to Optical Networking are described in detail. With the extensions to MPLS, the Generalized MPLS LSRs, or more precisely interfaces on LSRs, can be subdivided into the following classes:

1. Interfaces that recognize packet/cell boundaries and can forward data based on the content of the packet/cell header. Examples include interfaces on routers that forward data based on the content of the “shim” header, interfaces on ATM-LSRs that forward data based on the ATM VPI/VCI. Such interfaces are referred to as Packet-Switch Capable (PSC).

2. Interfaces that forward data based on the data's time slot in a repeating cycle. An example of such an interface is that of a SONET Cross-Connect. Such interfaces are referred to as Time-Division-Multiplex Capable (TDM).

3. Interfaces that forward data based on the wavelength on which the data is received. An example of such an interface is an interface on an Optical Cross-Connect that can operate at the level of an individual wavelength. Such interfaces are referred to as Lambda Switch Capable (LSC).

4. Interfaces that forward data based on a position of the data in the real world physical spaces. An example of such an interface is an interface on an Optical Cross-Connect (OXC) that can operate at the level of a single (or multiple) fibers. Such interfaces are referred to as Fiber-Switch Capable (FSC).

Using the concept of nested LSPs (with a label stack) allows the system to scale by building a forwarding hierarchy. At the top of this hierarchy are FSC interfaces, followed by LSC interfaces, followed by TDM interfaces, followed by PSC interfaces. This way, an LSP that starts and ends on a PSC interface can be nested (together with other LSPs) into an LSP that starts and ends on a TDM interface. This LSP, in turn, can be nested (together with other LSPs) into an LSP that starts and ends on a LSC interface, which in turn can be nested (together with other LSPs) into an LSP that starts and ends on a FSC interface.

Generalized MPLS differs from traditional MPLS in that it supports multiple types of switching, e.g., the addition of support for TDM, Lambda, and fiber (port) switching. The support for the additional types of switching has driven generalized MPLS to extend certain base functions of MPLS and, in some cases, to add functionality.

These changes and additions impact basic LSP properties, how labels are requested and communicated, the unidirectional nature of LSPs, how errors are propagated, and information provided for synchronizing the ingress and egress ports. In traditional MPLS traffic engineering, links traversed by an LSP can include an inter-mix of links with heterogeneous label encoding. For example, an LSP may span links between routers, links between routers and ATM-LSRs, and links between ATM-LSRs. Generalized MPLS extends this by including links where the label is encoded as a time slot, or a wavelength, or a position in the real world physical space.

As with traditional MPLS traffic engineering, where not all LSRs are capable of recognizing (IP) packet boundaries (e.g., an ATM-LSR) in their forwarding plane, generalized MPLS includes support for LSRs that cannot recognize (IP) packet boundaries in their forwarding plane. In traditional MPLS traffic engineering an LSP that carries IP has to start and end on a router. Generalized MPLS extends this by requiring an LSP to start and end on similar type of LSRs. Also, in generalized MPLS the type of payload that can be carried by an LSP is extended to allow such payloads as SONET/SDH, or 1 Gb or 10 Gb Ethernet. These changes from traditional MPLS are reflected in how labels are requested and communicated in generalized MPLS, see Sections 3.1 and 3.2. A special case of Lambda switching called Waveband switching is also described in Section 3.3.

Generalized MPLS allows for a label to be suggested by an upstream node, see Section 3.4. This suggestion may be overridden by a downstream node but in some cases at the cost of higher LSP setup time. The suggested label is valuable when establishing LSPs through certain kinds of optical equipment where there may be a lengthy (in electrical terms) delay in configuring the switching fabric. For example micro mirrors may have to be elevated or moved, and this physical motion and subsequent damping takes time. If the labels and hence switching fabric are configured in the reverse direction (the norm) the MAPPING/Resv message may need to be delayed by 10's of milliseconds per hop in order to establish a usable forwarding path.

Generalized MPLS extends on the notion of restricting the range of labels that may be selected by a downstream node, see Section 3.5. In generalized MPLS, an ingress node or other upstream node may restrict the labels that may be used by an LSP along either a single hop or along the whole LSP path. This feature is driven from the optical domain where there are cases where wavelengths used by the path must be restricted either to a small subset of possible wavelengths, or to one specific wavelength. This requirement occurs because some equipment may only be able to generate a small set of the wavelengths that intermediate equipment may be able to switch, or because intermediate equipment may not be able to switch a wavelength at all, being only able to redirect it to a different fiber.

While traditional traffic engineered MPLS (and even LDP) are unidirectional, generalized MPLS supports the establishment of bi-directional LSPs, see Section 4. The need for bi-directional LSPs come from non-PSC applications. There are multiple reasons why such LSPs are needed, particularly possible resource contention when allocating reciprocal LSPs via separate signaling sessions, and simplifying failure restoration procedures in the non-PSC case. Bi-directional LSPs also have the benefit of lower setup latency and lower number of messages required during setup. Other features supported by generalized MPLS are rapid failure notification, see Section 5, and termination of an LSP on a specific egress node, see Section 6.

5.2 Label Related Formats

To deal with the widening scope of Generalized MPLS into the optical and time domain, several new forms of “label” are required. These new forms of label are collectively referred to as a “generalized label”. A generalized label contains enough information to allow the receiving node to program its cross connect, regardless of the type of this cross-connect, such at the ingress segments of the path are properly joined.

The next section defines a generalized label request, a generalized label, support for waveband switching, suggested label and label sets. Note that since the nodes sending and receiving the new form of label know what kinds of link they are using, the generalized label does not contain a type field, instead the nodes are expected to know from context what type of label to expect.

5.3 Generalized Label Request

The Generalized Label Request supports communication of characteristics required to support the LSP being requested. These characteristics include desired link protection, LSP encoding, and LSP payload.

The Generalized Label Request indicates the link protection type desired for the LSP. If a particular protection type, e.g., 1+1, or 1:N, is requested, then a connection request is processed only if the desired protection type can be honored. Note that the protection capabilities of a link may be advertised in routing. Path computation algorithms may take this information into account when computing paths for setting up LSPs.

The Generalized Label Request also carries an LSP encoding parameter, called LSP Encoding Type. This parameter indicates the encoding type, e.g., SONET/SDH/GigE etc., that will be used with the data associated with the LSP. The LSP Encoding Type represents the nature of the LSP, and not the nature of the links that the LSP traverses. A link may support a set of encoding formats, where support means that a link is able to carry and switch a signal of one or more of these encoding formats depending on the resource availability and capacity of the link. For example, consider an LSP signaled with “photonic” encoding.

It is expected that such an LSP would be supported with no electrical conversion and no knowledge of the modulation and speed by the transit nodes. If the bit rate is known but not the modulation then a Clear encoding suffixed with the rate may be signaled. For example, a bit rate of OC-1 but an encoding type of clear can be signaled.

The transit nodes would not look at the frames, but would know the bit rate and as a result can do OEO switching but not OXO switching. All other formats require framing knowledge, and field parameters are broken into the framing type and speed as shown below. A REQUEST/Path message SHOULD contain as specific a LSP Encoding Type as possible to allow the maximum flexibility in switching by transit LSRs.

5.3.1 Required Information

The Generalized Label Request object/TLV carries the desired information, the format of which is as follows:

FIG. 7 shows the format of a Generalized Label Request in RSVP. FIG. 8 shows the format of a Generalized Label Request in CR-LDP.

5.3.2 Link Protection Type: 8 Bits

Indicates the desired link protection type of the connection setup. A value of 0 implies that this connection does not care about the available protection type.

5.3.3 LSP Encoding Type: 16 Bits

Indicates the required encoding. This field is set by the ingress node, transparently passed by transit nodes, and used by the egress node. The following shows permitted values and their meaning:

| Value | Bit Rate | Encoding |
|---|---|---|
| 0 | N/A | Packets |
| <n> | OC-<n> | SONET 1 <= <n> <= 3072 |
| 3072 + <n> | STS-<n> | SDH 1 <= <n> <= 3072 |
| 6144 + <n> | OC-<n> | Clear 1 <= <n> <= 3072 |
| 9217 | DS0 | DS0 |
| 9218 | DS1 | DS1 |
| 9219 | E1 | E1 |
| 9220 | DS2 | DS2 |
| 9221 | E2 | E2 |
| 9222 | DS3 | DS3 |
| 9223 | E3 | E3 |
| 9224 | J3 | J3 |
| 9225 | DS4 | DS4 |
| 9226 | E4 | E4 |
| 9227 | J4 | J4 |
| 9228 | 1Gbps | GigE |
| 9229 | 10Gbps | 10GigE |
| 9230 | VT-1.5/TU-11; | |
| 9231 | VT-2/TU-12; | |
| 9232 | VT-3 | |
| 9233 | VT − 6/TU − 2 | |
| 9234 | TU-3 | |
| 9235 | Photonic Lambda | |

5.3.4 Generalized PID (G-PID): 16 Bits

An identifier of the payload carried by an LSP. Standard Ethertype values are used with new Ethertype values defined as needed. The G-PID field is set by the ingress node transparently passed by transit nodes and used by the egress node.

5.3.5 Procedures

A node processing the Path/REQUEST message containing the Generalized Label Request must verify that the requested parameters can be satisfied by the node and by the outgoing interface. The node may either directly support the LSP or it may use a tunnel (FA), e.g. another class of switching. In either case, each parameter must be checked. Transit and egress nodes MUST verify that the node itself and, where appropriate, that the outgoing interface or tunnel can support the requested LSP Encoding Type. If encoding cannot be supported, the node MUST generate a PathErr/NOTIFICATION message, with a “Routing problem/Unsupported encoding” indication.

The G-PID parameter is normally only examined at the egress node. If the indicated G-PID cannot be supported then the egress MUST generate a PathErr/NOTIFICATION message, with a “Routing problem/Unsupported GPID” indication. In the case of PSC and when penultimate hop popping (PHP) is requested, the penultimate hop also examines the (stored) G-PID during the processing of the Resv/MAPPING message.

In this case if the G-PID is not supported, then the penultimate hop MUST generate a ResvErr/NOTIFICATION message with a “Routing problem/Unacceptable label value” indication. When an error message is not generated, normal processing occurs. In the transit case this will typically result in a Path/REQUEST message being propagated. In the egress case and PHP special case this will typically result in a Resv/MAPPING message being generated.

5.4 Generalized Label

The Generalized Label extends the traditional Label Object in that it allows the representation of not only labels that travel in-band with associated data packets, but also labels which identify time-slots, wavelengths, or space division multiplexed positions.

For example, the Generalized Label may carry a label that represents (a) a single fiber in a bundle, (b) a single waveband within fiber, (c) a single wavelength within a waveband (or fiber), or (d) a set of time-slots within a wavelength (or fiber).

It may also carry a label that represents a generic MPLS label, a Frame Relay label, or an ATM label (VCI/VPI).

A Generalized Label does not identify the “class” to which the label belongs. This is implicit in the multiplexing capabilities of the link on which the label is used. A Generalized Label object only carries a single level of label e.g. it is non-hierarchical. When multiple levels of label (LSPs within LSPs) are required, each LSP must be established separately.

The Generalized Label supports link bundling by carrying the identity of the component link. In the presence of link bundling, each Generalized Label indicates label(s) within the context of a specific component link, which is identified by the Link ID (which is carried as part of Generalized Label). The values used to indicate Link ID have local significance between two neighbors. Each Generalized Label object carries a variable length label parameter.

5.4.1 Required Information

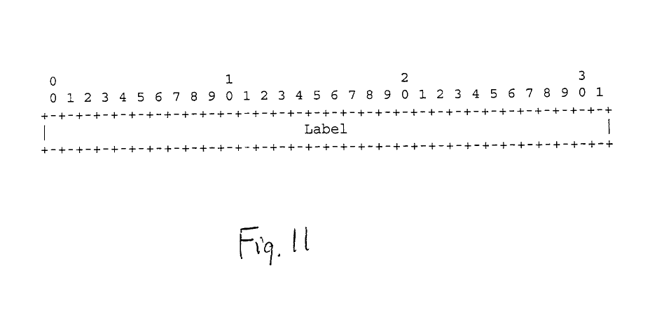

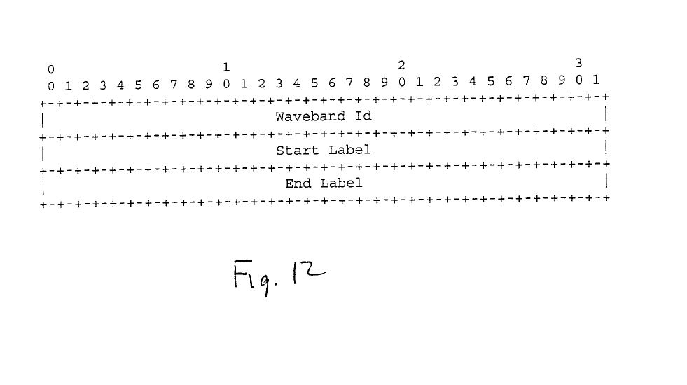

FIG. 9 shows the format of a Generalized Label in RSVP. FIG. 10 shows the format of a Generalized Label in CR-LDP.

5.4.2 Link ID: 32 Bits

Indicates link on which label is being request, from the message sender's perspective. Used when bundling several (parallel) links. MUST be zero when bundling is not used. Values only have significance between two neighbors. The receiver may need to convert the received value into a value with has local significance.

5.4.3 Label: Variable

The Variable field carries label information. The semantics of this field depends on the type of the link over which the label is used.

5.4.4 Port and Wavelength Labels

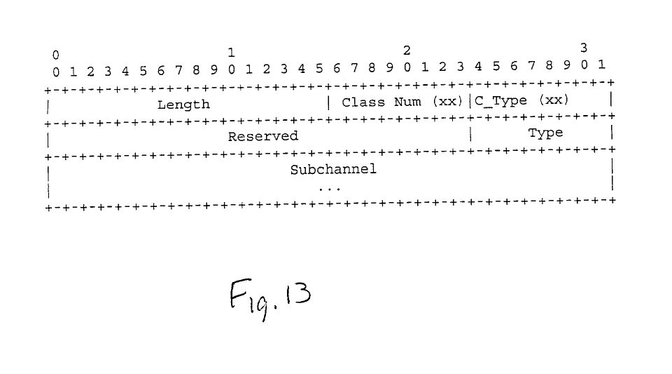

Some configurations of fiber switching (FSC) and lambda switching(LSC) use multiple data channels/links controlled by a single control channel. In such cases, the label indicates the data channel/link to be used for the LSP. FIG. 11 shows the format of a Port and Wavelength label.

5.4.5 Label: 32 Bits

Indicates port/fiber or lambda to be used, from the sender's perspective. Values used in this field only have significance between two neighbors, and the receiver may need to convert the received value into a value that has local significance. Values may be configured or dynamically determined using the LMP protocol.

5.4.6 Procedures

The Generalized Label travels in the upstream direction in MAPPING/Resv messages. The presence of both a generalized and normal label object in a Path/REQUEST message is a protocol error and should treated as a malformed message by the recipient. If link bundling is not being used, the Link ID MUST be zero on transmission and ignored when received. When link bundling is being used, the Link ID MUST contain a non zero value that uniquely identifies which link (e.g. fiber, waveband or wavelength) is to contain the label(s). In the case where the Link ID uniquely identifies the LSP (e.g. wavelength) the label parameter SHOULD be set to zero (0) and MUST be ignored when received. The recipient of a Resv/MAPPING message containing a Generalized Label verifies that the values passed are acceptable. If the Link ID is being used and the value is unknown, the recipient MUST generate a ResvErr/NOTIFICATION message with a “Routing problem/Unknown Link ID” indication. If the combination of the Link ID value and label is unacceptable then the recipient MUST generate a ResvErr/NOTIFICATION message with a “Routing problem/MPLS label allocation failure” indication.

5.5 Waveband Switching

A special case of lambda switching is waveband switching. A waveband represents a set of contiguous wavelengths that can be switched together to a new waveband. For optimization reasons it may be desirable for an optical cross-connect switch to optically switch multiple wavelengths as a unit. This may reduce the distortion on the individual wavelengths and may allow tighter separation of the individual wavelengths. The Waveband Label is defined to support this special case. Waveband switching naturally introduces another level of label hierarchy and as such the waveband is treated the same way all other upper layer labels are treated. As far as the MPLS protocols are concerned there is little difference between a waveband label and a wavelength label except that semantically the waveband can be subdivided into wavelengths whereas the wavelength can only be subdivided into time or statistically multiplexed labels.

5.5.1 Required Information

Waveband switching uses the same format as the generalized label, see section 3.2.1. For compatibility reasons, a new RSVP c-type and CR-LDP type is assigned for the Waveband Label.

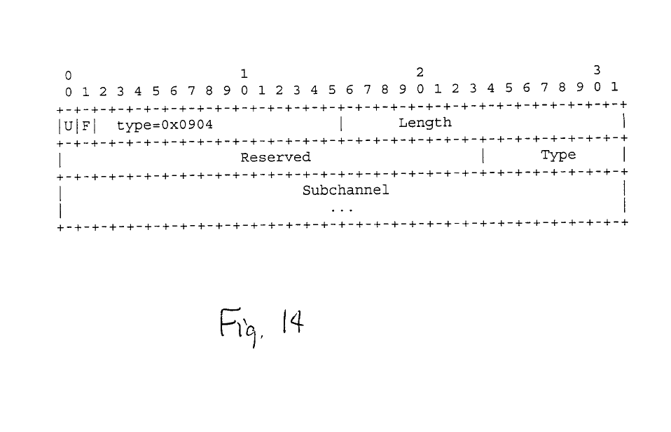

The format of a generalized label is shown in FIG. 12 in the context of waveband switching.

5.5.2 Waveband Id: 32 Bits

A waveband identifier. The value is selected by the sender and reused in all subsequent related messages.

5.5.3 Start Label: 32 Bits

Indicates the channel identifier, from the sender's perspective, of the lowest value wavelength making up the waveband.

5.5.4 End Label: 32 Bits

Indicates the channel identifier, from the sender's perspective, of the highest value wavelength making up the waveband. Channel identifiers are established either by configuration or by means of a protocol such as LMP [LMP]. They are normally used in the link id parameter of the Generalized Label Request when bundling is being used or the label parameter for PSC and LSC links when bundling is not being used.

5.5.5 Procedures

The procedures defined in Section 3.2.2 apply to waveband switching. This includes generating a ResvErr/NOTIFICATION message with a “Routing problem/MPLS label allocation failure” indication if any of the label fields are unrecognized or unacceptable. Additionally, when a waveband is switched to another waveband, it is possible that the wavelengths within the waveband will be mirrored about a center frequency. When this type of switching is employed, the start and end label in the waveband label object MUST be flipped before forwarding the label object with the new waveband Id. In this manner an egress/ingress LSR that receives a waveband label that has these values inverted, knows that it must also invert its egress association to pick up the proper wavelengths. Without this mechanism and with an odd number of mirrored switching operations, the egress LSRs will not know that an input wavelength of say L1 will emerge from the waveband tunnel as L100. This operation MUST be performed in both directions when a bi-directional waveband tunnel is being established.

5.6 LabelSet

The LabelSet is used to limit the label choices of a downstream node to a set of acceptable labels. This limitation applies on a per hop basis. There are four cases where a LabelSet is useful in the optical domain. The first case is where the end equipment is only capable of transmitting and receiving on a small specific set of wavelengths/bands. The second case is where there is a sequence of interfaces that cannot support wavelength conversion (CI-incapable) and require the same wavelength be used end-to-end over a sequence of hops, or even an entire path. The third case is where it is desirable to limit the amount of wavelength conversion being performed to reduce the distortion on the optical signals. The last case is where two ends of a link support different sets of wavelengths. LabelSet is used to restrict label ranges that may be used for a particular LSP between two peers. The receiver of a LabelSet must restrict its choice of labels to one that is in the LabelSet. Much like a label, a LabelSet may be present across multiple hops. In this case each node generates it's own outgoing LabelSet, possibly based on the incoming LabelSet and the node's hardware capabilities. This case is expected to be the norm for nodes with conversion incapable (Cl-incapable) interfaces. The use of LabelSet is optional, if not present, all labels from the valid label range may be used. Conceptually the absence of a LabelSet implies a LabelSet whose value is {U}, the set of all valid labels.

5.6.1 Required Information

This LabelSet is used in Path/REQUEST messages. The data required to support the LabelSet consists of a variable sized array of labels, or label ranges. These labels are subchannel identifiers and MUST lie within the link identified in Generalized Label Request.

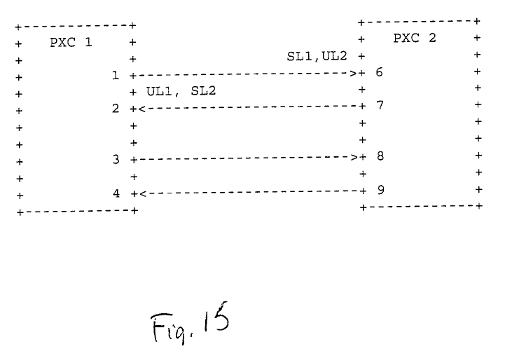

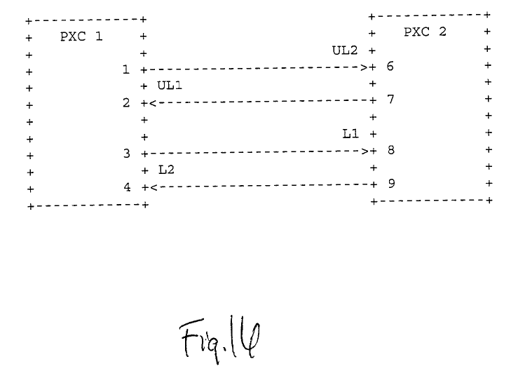

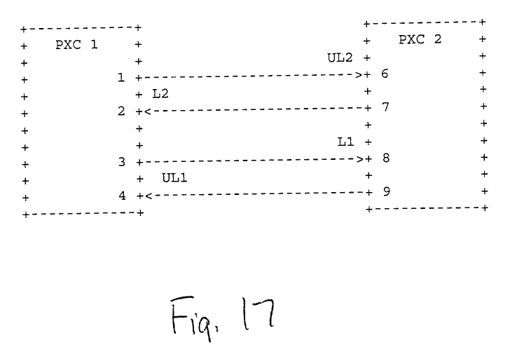

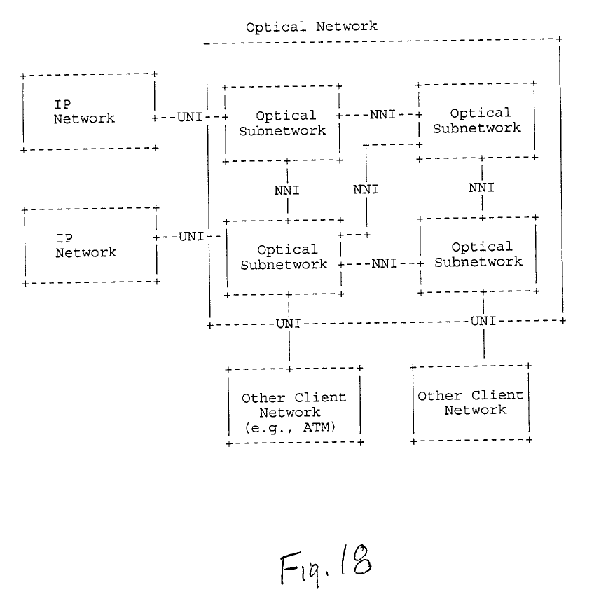

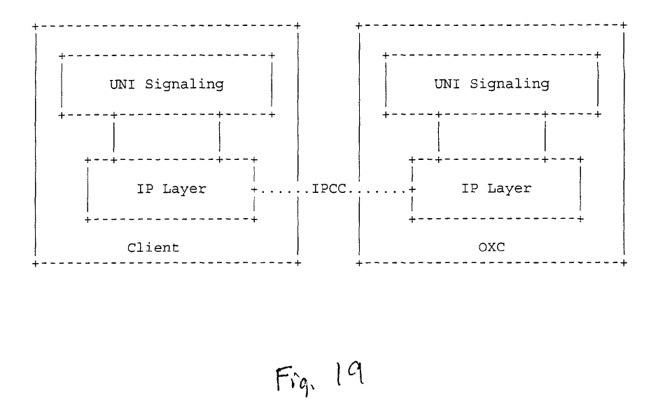

The format of a LabelSet in RSVP is shown in FIG. 13. The format of a LabelSet in CR-LDP is shown in FIG. 14.

5.6.2 Type: 2 Bits

0x00 means subchannel is a single element (inclusive)

0x01 means subchannel is a start element (inclusive)

0x02 means subchannel is an end element (inclusive)

0x03 means subchannel is a single element (exclusive)

5.6.3 Subchannel:

The subchannel represents the label (wavelength, fiber . . . ) which is eligible for allocation. This field has the same format as described for labels under section 3.2. Since subchannel to local channel identifiers (e.g. wavelength) mappings are a local matter, when a LabelSet is propagated from one node to the next, the subchannels may have to be remapped to new subchannel values for consistency.

A LabelSet can be just a series of single elements (Type=0x00) sorted in increasing order of subchannel value. A LabelSet can be a set of ranges (Type=0x01 followed by Type=0x02). The ranges MUST be sorted. A range that is missing a beginning or an end implies no bound where the bound is missing. A range which contains a Type=0x03 (exclusive) means all subchannels in the range except that subchannel are eligible.

5.6.4 Procedures

The absence of a LabelSet implies that all labels are acceptable. A LabelSet is included when a node wishes to restrict the label(s) that may be used downstream.

On reception of a Path/REQUEST message a CI-capable interface will restrict its choice of labels to one which is in the LabelSet. The CI-capable receiver may also remove the LabelSet prior to forwarding the Path/REQUEST message. If the node is unable to pick a label from the LabelSet, then the request is terminated and a PathErr/NOTIFICATION message with a “Routing problem/LabelSet” indication MUST be generated. It is a local matter if the LabelSet is stored for later selection on the RESV/Mapping or if the selection is made immediately for propagation in the RESV/Mapping.

On reception of a Path/REQUEST message for a CI-incapable interface, the LabelSet in the message is compared against the set of available labels at the downstream interface and the resulting intersecting LabelSet is forwarded in a Path/REQUEST message. If the resulting LabelSet is empty, the Path/REQUEST must be terminated, and a PathErr/NOTIFICATION message, and a “Routing problem/LabelSet” indication MUST be generated. Note that LabelSet intersection is based on the physical labels (actual wavelength/band values) that may have different logical values on different links. As a result, it is the responsibility of the node to map these values so that they have a consistent physical meaning, or to drop the particular values from the set if no suitable logical label value exists.

On reception of a Resv/MAPPING message at an intermediate node, the label to propagate upstream is selected from within the (stored) LabelSet (preferred) or may be preselected from that set to save memory.

Note, on reception of a Resv/MAPPING message for an interface which is Cl-incapable it has no other choice than to use the same physical label (wavelength/band) as received in the Resv/MAPPING. In this case, the use and propagation of a LabelSet will significantly reduce the chances that this allocation will fail when CI-incapable nodes are traversed.

5.7 Bi-directional LSPs

In the remainder of this section, the term “initiator” is used to refer to a node that starts the establishment of an LSP and the term “terminator” is used to refer to the node that is the target of the LSP. Note that for bi-directional LSPs, there is only one “initiator” and one “terminator”. Normally to establish a bi-directional LSP when using [RSVP-TE] or [CR-LDP] two unidirectional paths must be independently established. This approach has the following disadvantages:

The latency to establish the bi-directional LSP is equal to one round trip signaling time plus one initiator-terminator signaling transit delay. This not only extends the setup latency for successful LSP establishment, but it extends the worst-case latency for discovering an unsuccessful LSP to as much as two times the initiator-terminator transit delay. These delays are particularly significant for LSPs that are established for restoration purposes.

The control overhead is twice that of a unidirectional LSP. This is because separate control messages (e.g. Path and Resv) must be generated for both segments of the bi-directional LSP.

Because the resources are established in separate segments, route selection is complicated. There is also additional potential race for conditions in assignment of resources, which decreases the overall probability of successfully establishing the bi-directional connection.

It is more difficult to provide a clean interface for SONET equipment that may rely on directional hop-by-hop paths for protection switching. Note that existing SONET gear transmits the control information in-band with the data.

Bi-directional optical LSPs (or lightpaths) are seen as a requirement for many optical networking service providers.

With bi-directional LSPs both the downstream and upstream data paths, e.g., from initiator to terminator and terminator to initiator, are established using a single set of Path/REQUEST and Resv/MAPPING messages. This reduces the setup latency to essentially one initiator-terminator round trip time plus processing time, and limits the control overhead to the same number of messages as a unidirectional LSP.

5.7.1 Required Information

For bi-directional LSPs, two labels must be allocated. Bi-directional LSP setup is indicated by the presence of an Upstream Label in the REQUEST/Path message. An Upstream Label has the same format as the Generalized Label, see Section 3.2. In RSVP the Upstream Label uses a new class number (TBD of form 0bbbbbbb) and the C-type of the label being suggested. In CR-LDP, Upstream Label uses type=0x0906.

5.7.2 Procedures

The process of establishing a bi-directional LSP follows the establishment of a unidirectional LSP with some additions. To support bi-directional LSPs an Upstream Label is added to the Path/REQUEST message. The Upstream Label MUST indicate a label that is valid for forwarding at the time the Path/REQUEST message is sent. When a Path/REQUEST message containing an Upstream Label is received, the receiver first verifies that the upstream label is acceptable. If the label is not acceptable, the receiver MUST issue a PathErr/NOTIFICATION message with a “Routing problem/Unacceptable label value” indication. An intermediate node must also allocate a label on the outgoing interface and establish internal data paths before filling in an outgoing Upstream Label and propagating the Path/REQUEST message. If an intermediate node is unable to allocate a label or internal resources, then it MUST issue a PathErr/NOTIFICATION message with a “Routing problem/Label allocation failure” indication. Terminator nodes process Path/REQUEST messages as usual, with the exception that the upstream label can immediately be used to transport associated data upstream to the initiator. When a bi-directional LSP is removed, both upstream and downstream labels are invalidated and it is no longer valid to send data using the associated labels.

5.7.3 Contention Resolution

Contention for labels may occur between two bi-directional LSP setup requests traveling in opposite directions. This contention occurs when both sides allocate the same resources (ports) at effectively the same time. If there is no restriction on the ports that can be used for bi-directional LSPs and if there are alternate resources, then both nodes will pass different labels upstream and the contention will be resolved naturally. However, if there is a restriction on the ports that can be used for the bi-directional LSPs (for example, if they must be physically coupled on a single I/O card), or if there are no more resources available, then the contention must be resolved by other means.

To resolve contention, the node with the higher node ID will win the contention and it MUST issue a PathErr/NOTIFICATION message with a “Routing problem/Label allocation failure” indication. Upon receipt of such an error, the node SHOULD try to allocate a different Upstream label (and a different Suggested Label if used) to the bi-directional path. However, if no other resources are available, the node must proceed with standard error handling. For the purposes of RSVP contention resolution, the node ID is the IP address used in the RSVP_HOP object.

To reduce the probability of contention, one may impose a policy that the node with the lower ID never suggests a label in the downstream direction and always accepts a Suggested Label from an upstream node with a higher ID. Since the label sets are exchanged using LMP, an alternative local policy could further be imposed. This means that the higher numbered node could allocate labels from the high end of the label range while the lower numbered node allocates labels from the low end of the label range. This mechanism would augment any close packing algorithms that may be used for bandwidth (or wavelength) optimization.

An example of contention between two nodes (PXC 1 and PXC 2) is shown in FIG. 15. In this example PXC 1 assigns an Upstream Label for the channel corresponding to local BCId=2 (local BCId=7 on PXC 2) and sends a Suggested Label for the channel corresponding to local BCId=1 (local BCId=6 on PXC 2).

Simultaneously, PXC 2 assigns an Upstream Label for the channel corresponding to its local BCId=6 (local BCId=1 on PXC 1) and sends a Suggested Label for the channel corresponding to its local BCId=7 (local BCId=2 on PXC 1). If there is no restriction on the ports that can be used for bi-directional LSPs and if there are alternate resources available, then both PXC 1 and PXC 2 will pass different labels upstream and the contention is resolved naturally (see FIG. 5.2). However, if there is a restriction on the ports that can be used for bi-directional LSPs (for example, if they must be physically coupled on a single I/O card), then the contention must be resolved using the router Id (see FIG. 5.3).

In this example, PXC 1 assigns an Upstream Label using BCId=2 (BCId=7 on PXC 2) and a Suggested Label using BCId=l (BCId=6 on PXC 2). Simultaneously, PXC 2 assigns an Upstream Label using BCId=6 (BCId=1 on PXC 1) and a Suggested Label using BCId=7 (BCId=2 on PXC 1). In this example, there is no restriction on the ports that can be used by the bi-directional connection and contention is resolved naturally.

In this example, ports 1,2 and 3,4 on PXC 1 (ports 6,7 and 8,9 on PXC 2, respectively) must be used by the same bi-directional connection. Since PXC 2 has a higher node ID, it wins the contention and PXC 1 must use a different set of labels.

5.8 Notification

This section defines two signaling extensions that enable expedited notification of failures and other events to nodes responsible for restoring failed LSPs. The first extension, the Notify message, provides for general event notification. The second allows for the combining of such notifications in a single message. These extensions are RSVP specific.

5.8.1 Notify Message

The Notify message provides a mechanism to inform non-adjacent nodes of LSP related events. This message differs from the currently defined error messages (e.g., PathErr and ResvErr messages of RSVP) in that it can be “targeted” to a node other than the immediate upstream or downstream neighbor and that it is a generalized notification mechanism.

The Notify message does not replace existing error messages. The Notify message may be sent either (a) normally, where non-target nodes just forward the Notify message to the target node, similar to ResvConf processing in [RSVP]; or (b) encapsulated in a new IP header who's destination is equal to the target IP address.

Regardless of the transmission mechanism, nodes receiving a Notify message not destined to the node forward the message, unmodified, towards the target. To support reliable delivery of the Notify message, an Ack Message [RSVP-RR] is used to acknowledge the receipt of a Notify Message. A node that receives a Notify message MUST send a Notify_Ack message confirming receipt of the Notify message.

5.8.2 Required Information

The Notify message is a generalized notification message. The IP destination address is set to the IP address of the intended receiver. The Notify message is sent without the router alert option.

<Notify message> ::= <Common Header> [<INTEGRITY>]
<MESSAGE_ID>

<SESSION> <ERROR_SPEC> [<POLICY_DATA>...]
[<sender descriptor>]

<sender descriptor> ::= <SENDER_TEMPLATE> <SENDER_TSPEC>

[<ADSPEC>] [<RECORD ROUTE>]

The ERROR_SPEC object specifies the error and includes the IP address of either the node that detected the error or the link that has failed. The MESSAGE_ID object is defined in [RSVP-RR].

Note: for CR-LDP there is not currently a similar mechanism. In CR-LDP, when a failure is detected it will be propagated with RELEASE/WITHDRAW messages radially outward from the point of failure.

Resources are to be released in this phase and actual resource information is fed back to the source using the feedback mechanisms of [FEEDBACK]. In this manner the source will have an accurate view of available resources and can start rerouting much sooner.

5.8.3 Non-Adjacent Message Bundling

RSVP-RR] defines the bundle message that can be used to aggregate multiple signaling messages into a single packet. The defined mechanism is limited to adjacent RSVP nodes. This section defines the use of the bundle message between non-adjacent nodes. This is accomplished by setting the IP destination address of the bundle message to the address of the target node.

The non-adjacent bundle message may be sent either (a) normally, where non-target nodes just forward the message to the target node (see ResvConf processing in [RSVP] for reference); or (b) encapsulated in a new IP header who's destination is equal to the target IP address. Regardless of the transmission mechanism, nodes receiving a bundle message not destined to the node just forward the message, unmodified, towards the target. The motivation for supporting non-adjacent message bundling is to support the bundling of Notify Messages. Non-adjacent bundle messages can only be sent to RSVP nodes that support bundling. Currently, the only method for discovering such information about a non-adjacent node is through manual configuration.

5.8.4 Required Information

The RSVP bundle message is defined in [RSVP-RR]. The only modification from what is specified in [RSVP-RR] is that the IP destination address does not have to be an immediate upstream/downstream neighbor.

6 Signaling Requirements at the Optical UNI

6.1 Introduction

This section describes the domain services model and the signaling requirements at the client-optical interface, called the User-Network Interface (UNI). The objective is two-fold: to guide the adaptation of RSVP/LDP for UNI signaling and to harmonize the signaling mechanisms and parameter encoding under UNI signaling and peer model lightpath set-up. This section reflects the ongoing work at the Optical Internet Forum (OIF) and the Optical Domain Services Interconnect (ODSI), and the contents are expected to evolve as work progresses on UNI signaling.

The network model considered here consists of client networks (IP and others) attached to an optical core network, and connected to their peers over dynamically established and/or switched lightpaths. The optical core itself is assumed to be incapable of processing individual IP packets. The optical network is assumed to consist of multiple optical sub-networks interconnected by optical links in a general topology (referred to as an optical mesh network). This network may be multi-vendor. Each sub-network itself contains a mesh-connected set of optical cross-connects (OXCs). This network model is shown in FIG. 18.

There are two logical control interfaces identified in FIG. 18. Besides the client-optical network interface, also referred as the User-Network Interface (UNI), there is the optical sub-network interface, also referred to as the Network-Network Interface (NNI). The services defined at these interfaces to a large extent determine the type and amount of control flow across them. It is possible to have a unified service definition across both these interfaces such that there is virtually no difference in the control flow across them. In this section, however, these interfaces are treated as distinct and the focus is on the UNI.

The physical control structure used to realize these logical interfaces may vary. For the client-optical interface, some of the possibilities are:

(a) Direct Interface: An in-band or out-of-band IP control channel (IPCC) may be implemented between a client and each OXC that it connects to. With in-band signaling, the signaling messages are carried over a logical communication channel embedded in the physical optical links between the client device and OXC. For example, this could be the overhead bytes in SONET framing or a dedicated optical wavelength. With out-of-band signaling, the signaling messages are transmitted over a separate communication infrastructure that is independent of the optical data links between the client devices and OXC. For example, this could be a LAN/WAN based management network infrastructure separate from the optical network.

This control channel, in-band or out-of-band, is used for exchanging signaling and routing messages directly between the client and the OXC. With a direct interface, the client and the OXC it connects to support the control plane information exchange. This is shown in FIG. 19.

The type of signaling information exchange across the direct interface would vary depending on the service definition. In addition, routing information may be exchanged at this interface. Some choices for the routing protocol are OSPF/ISIS (with traffic engineering extensions) or BGP. Other directory-based routing information exchanges are also possible in the near term.

(b) Indirect interface: An out-of-band IP control channel may be implemented between the client and a controlling device in the optical network to signal service requests and responses. For example, a control plane server in the optical network may receive service requests from clients.

Similarly, out-of-band signaling may be used between a device in the client network (e.g., a management system) and the OXC, or between devices in client and optical networks to signal service requests. In these cases, there is no direct control interaction between clients and respective OXCs. One reason to have an indirect interface would be that the OXCs and/or clients do not support a direct interface.

(c) Provisioned interface: In this case, the optical network services are provisioned and there is no control interaction between the client and the optical network.

It is essential that both direct and indirect interfaces be supported by any UNI signaling protocol. under both these interfaces, the entity that performs UNI signaling on the client side is referred to as UNI-C. The corresponding entity on the network side is referred to as UNI-N. In the case of the direct interface, each client device attached to the optical network will have an UNI-C instance and each OXC attached to a client will have an UNI-N instance. In the case of the indirect interface, these entities may be located outside of the client device and OXC, as per the description in (b) above.

In the next section, the service definition and signaling requirements for realizing the UNI are described.

6.2 Optical Network Services

The optical network primarily offers discrete capacity, high bandwidth connectivity in the form of lightpaths. A lightpath is established between two termination points in the optical network to which client devices are attached. The properties of the lightpaths are defined by the attributes specified during lightpath establishment or via acceptable modification requests.

The notion of “user groups” is considered as integral to lightpath establishment in this draft. A user group defines a community of client devices with restrictions on connectivity from devices outside this group. The requirements on lightpath termination point and user group identification are described in the next section. The following actions support lightpath services:

(a) Lightpath creation: This action allows a lightpath with the specified attributes to be created between a pair of termination points. Each lightpath is assigned a unique identifier by the optical network, called the lightpath ID, which is used in UNI signaling messages to reference the lightpath in further transactions. Lightpath creation may be subject to network-defined policies (e.g., user group connectivity restrictions) and security procedures.

(b) Lightpath deletion: This action allows an existing lightpath (referenced by its ID) to be deleted. (c) Lightpath modification: This action allows certain parameters of the lightpath (referenced by its ID) to be modified. Lightpath modification may be subject to network-defined policies. Lightpath modification must be non-destructive, e.g., the success or failure of the modification procedure must not result in the loss of the original lightpath.

(d) Lightpath status enquiry: This service allows the status of certain parameters of the lightpath (referenced by its ID) to be queried.

Additionally, the following “neighbor discovery” procedures may be made available over the UNI:

(a) Client Registration: This service allows a client to register its address(es) and user group identifier(s) with the optical network.

(b) Client De-Registration: This service allows a client to withdraw its address(es) and user group identifier(s) from the optical network.

The registration procedure aids in verifying local port connectivity between the optical and client devices and allows each device to learn the IP address of the other to establish a UNI control channel. Also, it aids the implementation of a directory service (if desired) that would allow clients to learn about the accessibility of other remote clients belonging to the same user group.

Finally, a “service discovery” procedure may be employed as a precursor to obtaining UNI services. Service discovery allows a client to determine the static parameters of the interconnection with the optical network, including the UNI signaling protocols supported. The protocols for neighbor and service discovery are different from the UNI signaling protocol itself.

6.3 Identification of Lightpath Termination Points and User Groups

It is assumed that each OXC in an optical network has one or more IP addresses assigned to it. The address assigned to an OXC is assumed to be unique within the service domain that supports the UNI. Lightpath termination points are identified by internal optical network interface identifiers. It is possible that a physical OXC interface may in fact contain more than one logical interface on which lightpaths terminate. For instance, an OC-192 port may terminate four OC-48 lightpaths. Also, depending on the granularity of bandwidth allocation, a lightpath may refer to a sub-channel in a multiplexed stream.

The concept of a logical port may be used to generically identify the local termination point of a lightpath at an OXC. The complete termination point is therefore identified by the pair, {IP address, logical port ID}, where the IP address is associated with the OXC that contains the physical interface and the logical port ID is an (optional) addressing structure used to identify a logical port in the OXC. The logical port ID structure will consist of physical port, channel and sub-channel identifiers.

Because the logical port ID is of local significance only, it must be unique only with respect to a specific OXC. Furthermore, the logical port ID is not used for routing a lightpath within the optical network, but only to identify a termination point within an OXC. It is, however, possible to directly assign an IP address to physical or logical ports. In this case, the logical port ID need not be used. It is required that every client be assigned one or more user group identifiers. User group identification allows the formation of closed user groups, or virtual private networks of clients. The user group identifier(s) for each client-optical interface is required to be registered during UNI neighbor discovery.

6.4 Signaling Requirements

This section describes the mechanisms that must be available in a UNI signaling protocol.

6.4.1 UNI Control Channel

The transport of UNI signaling messages requires a UNI control channel between the UNI-C and the corresponding UNI-N entities. To implement the control channel, it is necessary for UNI-C and UNI-N to know each other's IP address.

In the case of the direct interface, the UNI neighbor discovery protocol can be used for this. The same protocol would allow the optical network to identify the client and apply any policies that may relate to the establishment of the UNI control channel. In the case of the indirect interface, the IP address information must be obtained administratively.

An in-band or an out-of-band transport link should exist between UNI-C and UNI-N to establish the control channel. To use such a link for the UNI control channel, the following requirements must be met:

(a) The link must be able to carry IP packets from UNI-C to UNI-N;

(b) The bit rate and minimum transfer size (in bytes) of the link must be adequate to support this function;

(c) The link must be secure, or UNI-C and UNI-N must implement procedures to recognize authorized messages and to prevent unauthorized access;

(d) It must be possible for both UNI-C and UNI-N to detect the failure of the link quickly.

In the case of direct interface, there could be multiple interfaces between the client and the OXC. In this case, there need be only a single UNI control channel between them. This control channel can utilize any one of the many in-band and/or out-of-band transport links between the devices. Furthermore, as long as there is at least one link available, the UNI control channel must be maintained without break.

The UNI-C and UNI-N entities must be able to determine quickly the failure of an already established UNI control channel. The failure of the control channel or the inaccessibility of the peer UNI signaling entity does not imply the removal of established lightpaths. On the other hand, since signaling can be initiated from either side of the lightpath for lightpath deletion or modification of certain parameters, it is possible for the lightpath state information to be different in the network and client sides when the UNI control channel is not functional. Thus, when the UNI control channel is affected by a failure (e.g., the failure of the transport link or the inaccessibility of the peer UNI signaling module), a procedure to synchronize lightpath state must be implemented after recovery.

6.4.2 UNI Signaling (Abstract) Messages

The UNI signaling messages that must be supported are described below. These messages are denoted “abstract”, in reference to the fact that they may be realized in different ways depending on the signaling protocol used. In the following description, the terms “initiating UNI-C” and “terminating UNI-C” are used to identify the entities at two ends of a lightpath which initiate and terminate signaling actions. With the direct interface, a UNI-C entity at either end of a lightpath can initiate a signaling action. The UNI-C entity at the other end then becomes the terminating client. With some indirect interfaces, the initiating and terminating UNI-C could be the same entity.

(a) Lightpath Create Request: Sent from the initiating UNI-C to UNI-N to create a lightpath.

(b) Lightpath Create Response: Sent from

1. The terminating UNI-C to UNI-N to accept an incoming lightpath create request.

2. The UNI-N to the initiating UNI-C to indicate the successful creation of (or failure to create) the lightpath as requested in (a).

(c) Lightpath Delete Request: Sent from

1. The initiating UNI-C to UNI-N to delete a lightpath.

2. The UNI-N to a UNI-C to indicate the deletion of a lightpath by the network.

(d) Lightpath Delete Response: Sent from

1. The terminating UNI-C to UNI-N to acknowledge an incoming lightpath delete request.

2. The UNI-N to the initiating UNI-C to indicate the successful deletion of the lightpath as requested in (c).

(e) Lightpath Modification Request: Sent from the initiating UNI-C to UNI-N to modify the specified lightpath parameters. Modification must be non-destructive.

(f) Lightpath Modification Response: Sent from UNI-N to the initiating UNI-C to indicate the successful modification of (or failure to modify) the lightpath parameters requested in (e).

(g) Lightpath Status Enquiry: Sent from

1. The initiating UNI-C to UNI-N to inquire about the status and/or the parameters of the specified lightpath, or all lightpaths owned by the UNI-C.

2. The UNI-N to either UNI-C to inquire about the status of the parameters of the specified lightpath, or all lightpaths owned by the UNI-C.

(h) Lightpath Status Response: Sent from the UNI-N to the initiating UNI-C to indicate the status of lightpath parameters as requested in (g). Multiple “Lightpath Status Response” messages (one per lightpath) may be sent by UNI-N when the initiating UNI-C requests the status of all lightpaths terminating at a particular interface.

(i) Notification: This message is sent autonomously by UNI-N to UNI-C to indicate a change in the status of the lightpath (e.g., unrestorable lightpath failure).

How these messages are mapped to actions within the optical network, and the signaling protocol used within the optical network to realize the actions are not concerns at the UNI. Similarly, the resolution of conflicts when UNI signaling is concurrently invoked on both sides of a lightpath to perform certain actions is not considered to be a UNI signaling issue.

6.4.3 UNI (Abstract) Message Parameters

The following parameters must be encoded in UNI signaling messages. Formats for the parameters must be reconciled with the format of similar parameters being developed for MPLambdaS signaling.

(a) Identification

1. Lightpath ID: A network-wide unique identifier for a lightpath. This identifier is assigned by the optical network. It consists of the IP address of an OXC along with a locally unique index.

2. Contract ID: A carrier-assigned identification that identifies the service contract.

3. Source/destination lightpath termination point ID: This is a composition of two IDs, an identifier indicating OXC/physical or logical port (an IP address) and (optional) logical port information. The latter consists of a port index, a channel.

4. User group ID: A VPN identifier as defined in IETF RFC 2685.

5. UNI-C ID: IP address of the UNI-C entity.

(b) Service-Related

1. Directionality: Flag that indicates whether the lightpath is uni or bi-directional. Default is bi-directional.

2. Framing: Framing specifies the format of the signal to be transported across the UNI. The valid framing options considered are:

PDH

SONET

SDH

Digital Wrapper

LAN Ethernet

WAN Ethernet

Note that framing represents the framing of the service to be carried across the optical network. There are often a variety of physical interfaces and framing formats that can carry the signal across the UNI between the client and the OXC. For instance, a DS-3 can be carried in a T3 or within an STS-1 in an OC-48.

So, for example, the source UNI may have a PDH T3 physical line carrying a DS-3 whereas the destination UNI may have a SONET OC-48 interface. A DS-3 connection between the source and destination would be delivered within an STS-1 of the OC-48 at the destination. The framing of such a lightpath would be of type PDH. Two SONET interfaces may request either any STS-1 or a DS-3, depending on whether the optical network and client devices distinguish between the two cases.

3. Bandwidth: This specifies the bandwidth of the service and is interpreted with respect to the framing. Note that this is the bandwidth of the service, not the bandwidth of the physical interfaces. The latter may differ on each end of the connection.

For PDH, the options are DS-0, DS-1, DS-3 . . . , E1, E3, . . . ,

For SONET, the options are STS-1, STS-2, STS-3, . . . , STS-N

For SDH, the options are STM-1, STM-2, . . . STM-N

For digital wrapper, the options are TBD, possible values are 2.5 Gbps, 10 Gbps and 40 Gbps.

For LAN Ethernet the options are 10 Mbps, 100 Mbps, 1 Gbps, and 10 Gbps

For WAN Ethernet the options are 10 Gbps

4. Transparency: This is interpreted with respect to the framing.

For SONET/SDH Framing, the options are: PLR-C, STE-C, and LTE-C.

PLR-C: Physical Layer Regenerator Circuit (PLR-Circuit); A PLR-Circuit is a SONET/SDH rate and framed point-to-point circuit. The circuit preserves all SONET/SDH overhead bytes between clients. The SONET/SDH signal may be concatenated or channelized but cannot be SONET/SDH TDM de-multiplexed or multiplexed within the optical network.

STE-C: An STE-Circuit is a SONET/SDH rate and framed point-to-point circuit. The circuit preserves all SONET/SDH line overhead bytes between clients but is not required to preserve the section overhead bytes. The SONET/SDH signal may be concatenated or channelized but cannot be SONET/SDH TDM de-multiplexed or multiplexed within the optical network.

LTE-C: An LTE-Circuit is a SONET/SDH rate and framed point-to-point circuit between two UNIs. The circuit preserves the SONET/SDH payload, but is not required to preserve the section or line overhead bytes. The SONET/SDH signal may be concatenated or channelized and may be SONET/SDH TDM de-multiplexed or multiplexed within the optical network to allow the sub-rate circuits to be individually routed, or to allow multiple LTE-Circuits to be multiplexed within the network to better utilize a network link. Thus, an LTE-Circuit implies timing and synchronization requirements not required in PLR-Circuits or STE-Circuits.

It is part of the call acceptance process of the optical network to determine if the requested service, bandwidth and transparency can be supported by the network and the physical interfaces at the UNI. For instance, if the requested circuit is a SONET OC-48c and both physical interfaces are SONET OC-48 interfaces, then it may be possible for the network to support PLR-C transparency. However, if one of the two interfaces is an OC-192 interface, then LTE-C is the only currently defined option.

There are no transparency options for PDH, Digital Wrapper, LAN Ethernet, WAN Ethernet.

5. Propagation delay: This specifies the maximum acceptable propagation delay in milliseconds. Defaults to infinity.

6. Service level: An integer specifying the service level requested for the lightpath.

The optical network service provider may define different service levels for priority, preemption, protection and other service-distinguishing parameters. The “service level” parameter encodes the service type and it is interpreted by the provider. Some values (e.g., 0-255) should be reserved for future use. The remaining values are provider specific. Default set by provider. It is also possible that priority, preemption, etc., could be separately specified as (optional) parameters.

(c) Routing-related

1. Diversity: A list of n lightpath IDs from which the present lightpath must be physically diverse in the network. For each lightpath ID it may specified whether the diversity desired is link, node or SRLG disjointness.

(d) Miscellaneous

1. Result Code: A code indicating success or failure of certain operations. For example, a lightpath create request could result in success or failure. This code may indicate the result as well as the reason for failure.

2. Status: A code that indicates the status of a lightpath in the “Lightpath Status Response” message.

(e) Security-related

These parameters are TBD; since the security features provided by individual protocols (RSVP/LDP) should be used where possible.

(f) Policy, accounting and authorization related: These parameters are TBD.

6.4.4 Contents of UNI Abstract Messages

The message contents described below may evolve based on ongoing work, and on the development of security, policy, accounting and other parameters.

(a) Lightpath Create Request: UNI-N may assign the channel and/or the sub-channel for the lightpath being established and return it to the terminating UNI-C (in the destination channel, sub-channel parameters). This message contains:

1. Source Termination Point, IP address (mandatory)

2. Destination Termination Point, IP address (mandatory)

3. Source Termination Point, Port, Channel, Sub-channel IDs (optional)

4. Destination Termination Point, Port, Channel, Sub-channel IDs (optional)

5. Source User Group Identifier (mandatory)

6. Destination User Group Identifier (mandatory)

7. Contract ID (mandatory)

8. Framing (mandatory)

9. Bandwidth (mandatory)

10. Transparency (mandatory)

11. Directionality (optional)

12. Propagation Delay (optional)

13. Service level (optional)

14. Diversity (optional)

(b) Lightpath Create Response: This message contains:

1. Source Termination Point, IP address (mandatory)

2. Destination Termination Point, IP address (mandatory)

3. Source Termination Point, Port, Channel, Sub-channel IDs (optional)

4. Destination Termination Point, Port, Channel, Sub-channel IDs (optional)

5. Source User Group Identifier (mandatory)

6. Destination User Group Identifier (mandatory)

7. Lightpath ID (mandatory)

8. Result code (mandatory)

The lightpath ID is filled in by UNI-N and conveyed to both initiating and terminating clients. In addition, UNI-N may assign the channel and/or the sub-channel for the lightpath being established and return it to the initiating UNI-C (in the source logical port ID field).

(c) Lightpath Delete Request: This message contains:

1. Lightpath ID (mandatory)

(d) Lightpath Delete Response: This message contains:

1. Lightpath ID (mandatory)

2. Result Code (mandatory)

(e) Lightpath Modify Request: This message contains:

1. Lightpath ID (mandatory)

2. Contract ID (mandatory)

3. Lightpath Bandwidth (optional)

4. Service Level (optional)

5. Diversity (optional)

These parameters specify the new values desired for the lightpath identified.

(f) Lightpath Modify Response: This message contains:

1. Lightpath ID (mandatory)

2. Lightpath Bandwidth (optional)

3. Service Level (optional)

4. Diversity (optional)

5. Result code (mandatory)

These parameters indicate the new values of the parameters after the success or failure of the modification attempt (as indicated in the result code)

(g) Lightpath Status Enquiry: This message contains:

1. Lightpath ID (optional)

2. UNI-C ID (optional, mandatory if (1) is not present)

If the lightpath ID is not present, then the parameters of all lightpaths owned by the UNI-C is returned by the network. Otherwise, the status of the indicated lightpath is returned.

(h) Lightpath Status Response: This message contains:

1. Status (mandatory)

2. Lightpath ID (optional)

3. Source Termination Point, IP address (optional)

4. Destination Termination Point, IP address (optional)

5. Source Termination Point, Logical Port ID (optional)

6. Destination Termination Point, Logical Port ID (optional)

7. Source User Group Identifier (optional)

8. Destination User Group Identifier (optional)

9. Contract ID (optional)

10. Framing (optional)

11. Bandwidth (optional)

12. Transparency (optional)

13. Directionality (optional)

14. Propagation Delay (optional)

15. Service level (optional)

16. Diversity (optional)

The status parameter indicates the lightpath status, up/non-existent/failed/in recovery, etc.

(i) Notification: This message contains:

1. Lightpath ID (mandatory)

2. Status (mandatory)

7 Hierarchical DSP Optical Networking Solutions

7.1 Legacy Network Architecture Issues

Before we describe how the novel DSP optical signal processing techniques can help with DWDM optical networking issues, we will provide a quick overview of the broader issues of legacy optical networks currently deployed. These issues directly point to the need of a programmable software architecture and hardware platform for flexible implementations and upgrades of optical networks using DWDM. This leads to an intelligent optical adaptation layer to support the newer optical switching protocol stacks and the underlying programmable hardware for flexible support.

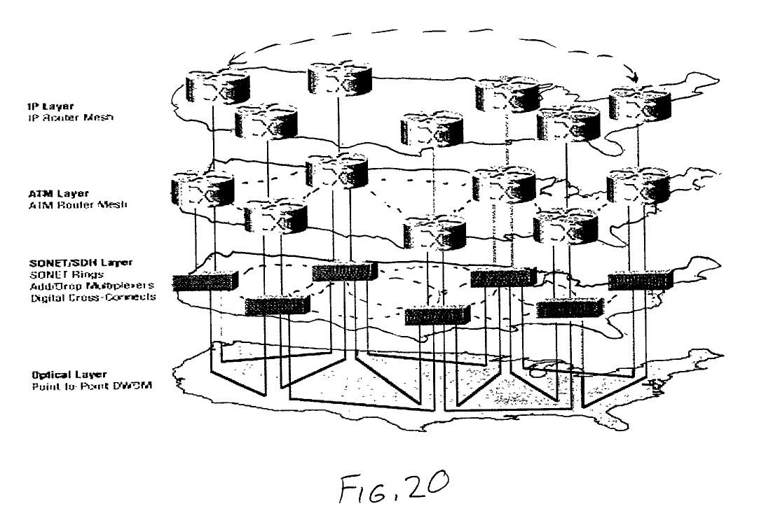

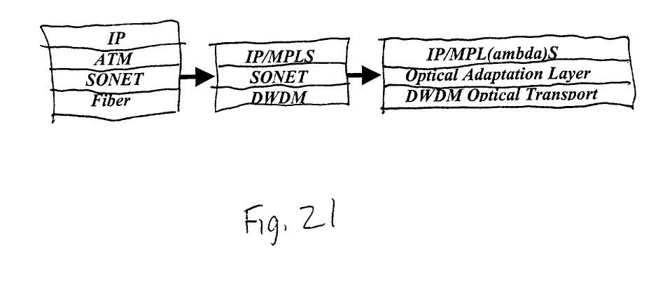

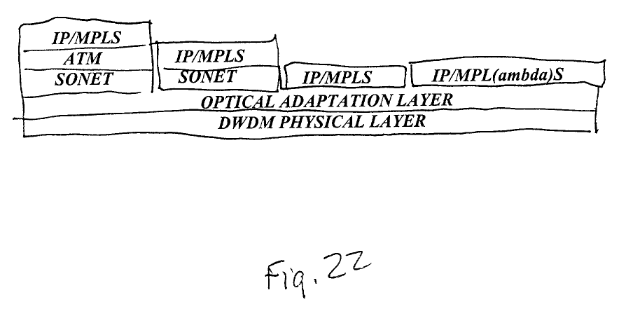

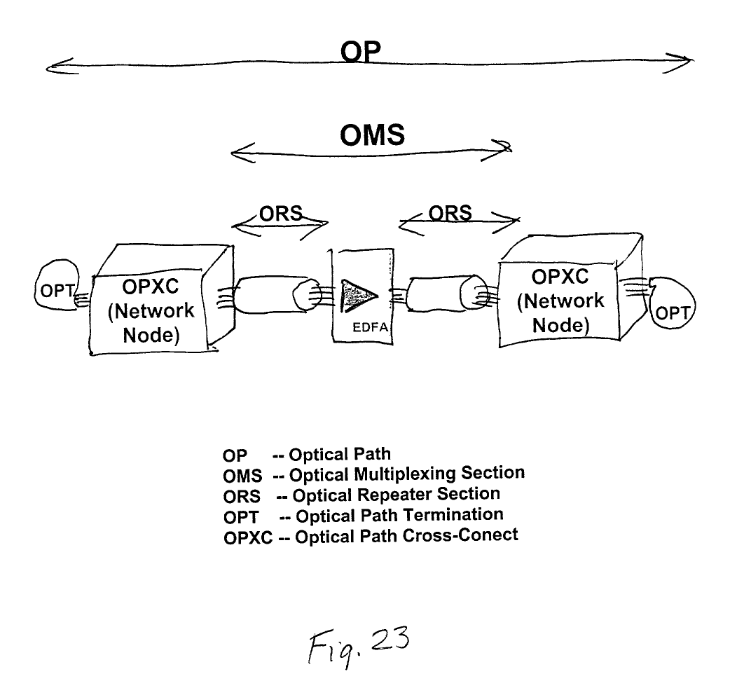

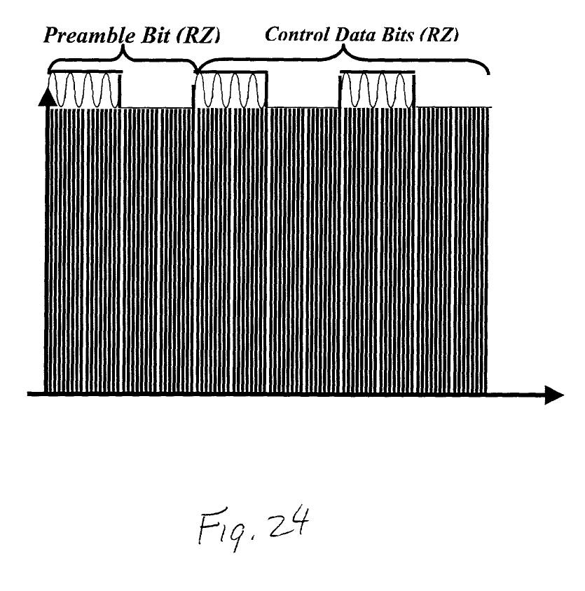

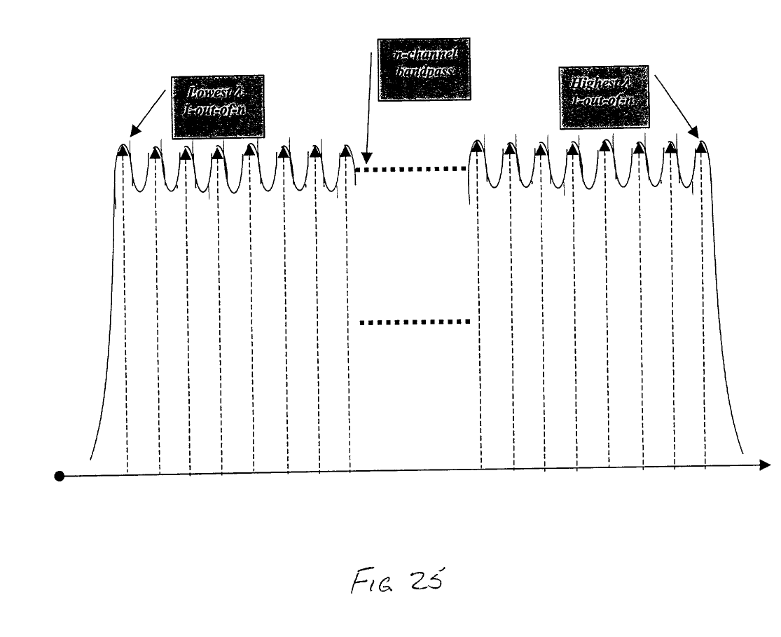

Today's core optical network architecture is basically a layered model with four protocol and transport layers: IP and other content-bearing traffic, ATM for traffic engineering, a Synchronous Optical Network/Synchronous Digital Hierarchy (SONET/SDH) transport network, and dense wave division multiplexing (DWDM) for fiber capacity. A typical example is depicted in FIG. 20. This approach has functional overlap among its layers, contains outdated functionality, and is too slow to scale. Therefore the current network model is ineffective as the architecture for DWDM optical data networks.

7.1.1 Current Networks Are too Slow to Scale

In the four-layer core network architecture, provisioning a connection between a pair of IP routers in two cities is cumbersome. The provisioning of multi-gigabit bandwidth across the SONET/SDH transport layer, which is a highly manual process, can take months. Therefore scaling the network can take a long time. The reason lies in SONET/SDH's interconnected-ring architecture.

The desired multi-gigabit bandwidth must be allocated across all rings along the connection route, a process that is determined manually. Physical connections must be made manually at the junctions where the rings meet. Even for the fastest SONET/SDH ring (OC-192 at 10 Gbps) deployed today, only four OC-48c channels at 2.5 Gbps each can be provisioned. Therefore, the availability of a coast-to-coast OC-48c bandwidth service would have to depend on the simultaneous availability of one OC-48c time slot on each SONET/SDH ring along the route. If one ring does not have availability, bandwidth on all other rings must be reserved for the duration it takes to construct a whole new ring.

The process involves deploying expensive, repetitive SONET/SDH add/drop multiplexers (ADMs) in a full “loop” configuration around multiple cities. This practice is particularly cumbersome causing service providers to frequently double the number of SONET/SDH devices to extend full physical line protection to all traffic. Furthermore, if DWDM wavelength capacity is not available all the way around the loop, then new DWDM equipment must be put in service first. Also, if the bandwidth on the other rings cannot be reserved, then the waiting cycle continues until bandwidth is available on all rings along the route. Even with the availability of bandwidth on all rings, a network technician must place fiber jumpers among the backs of the SONET/SDH ADMs at all of the junctions where the rings meet because SONET/SDH cross-connects with OC-48/STM-16 ports have not been deployed.

At the pace of several months per OC-48c connection deployment, despite the availability of raw DWDM bandwidth, the exponential growth in bandwidth demand cannot be met. Even with the availability of bandwidth at the SONET/SDH layer, the ATM layer may not have sufficient capacity to support a connection. In other words, in the four-layer architecture, any one layer can limit the scalability of the entire network, despite the viability of the others.

7.1.2 Functional Overlap

In the four-layer architecture, bandwidth is managed at four distinct granularities:

Packets in the IP layer

Cells in the ATM layer

SONET/SDH time-division multiplexing (TDM) frames in the SONET/SDH layer

DWDM wavelengths in the physical layer.

Not all of these levels of granularities are needed. Functions from one layer are being incorporated in devices belonging to another layer. ATM switching functions are being incorporated into IP routers, SONET/SDH protection switching is being placed in ATM switches as well as IP routers, and IP and ATM functions are being placed in SONET/SDH devices. SONET/SDH functionality is being added to DWDM equipment. Unfortunately, the resulting functional overlap is creating new complications rather than simplifying the network.

Another key area of functional overlap is restoration. In the current model, an outage can trigger restoration activities at all layers. The SONET/SDH layer can perform a protection switch, while the ATM layer tries to reroute its virtual circuits, and finally, the IP layer runs its routing protocols to discover alternate routes. The resulting interactions between the restoration mechanisms of each layer and their effects on network reliability and stability are not yet well understood. Deadlocks and other complications can lock up the network for long periods without resolution.

Finally, with the growth in the number of wavelengths per strand of fiber with DWDM, outages can be massive. A single fiber conduit, when damaged, can drop hundreds of wavelengths—all carrying IP traffic. The behavior of restoration algorithms under such circumstances is yet unknown.

7.1.3 Outdated Functions

SONET/SDH TDM capability has been critical in voice and leased-line networks in which large numbers of lower-speed interfaces exist. In future data networks, this capability will be superfluous when routers are able to groom packets at the OC-48c and OC-192c levels. ATM has been widely accepted as a means of effectively engineering IP traffic by establishing connections or virtual paths between routers. ATM's automated connection recovery establishes a stable link infrastructure between switches, which presents the routers with restorable circuits. The characteristics of each such virtual path can be controlled through ATM's quality-of-service (QoS) constructs, thereby optimizing the sharing of bandwidth. Furthermore, the physical routes that the virtual paths traverse can be tracked for performance monitoring and traffic engineering.

As data network cores continue to scale and as traffic between pairs of backbone routers reaches just a single OC-48c/OC-192c volume, ATM's virtual path becomes equivalent to a DWDM wavelength. Hence, while the benefits of ATM's fine virtual path granularity, including QoS, make it eminently suitable for access use, it becomes irrelevant in the optical core, where the appropriate switching granularity is the wavelength. In addition, effective management of these large and numerous virtual paths depends on the widespread introduction of the private network-to-network interface (PNNI), which is ATM's dynamic virtual path provisioning and restoration protocol. Even then, PNNI's restoration times will be in seconds to minutes, far inferior to the 50-ms benchmark set by the SONET/SDH ring. As a result, ATM switches do not offer compelling value for inclusion as intermediaries in the optical core.

Finally, with advances in IP-based protocols like multi-protocol label switching (MPLS), traffic engineering can be split between the IP layer at the packet granularity level and the optical layer at the wavelength granularity level. In conclusion, TDM and ATM-based traffic engineering will give way to MPLS and its generalized version with wavelength-level traffic engineering in the core. The Generalized MPLS protocol is aimed at multi-protocol wavelength switching e.g. MPL(ambda)S.

7.2 Existing Issues with Current DWDM Network Deployment

Having examined the broader issues of legacy optical networks currently deployed, we will now look at the existing DWDM deployment issues. These issues range from new optical components design and control to signaling methodology and control mechanism from the physical DWDM fiber layer to the system IP software layer. These issues directly point to the need of new software programmable device control and management algorithms as well as signaling and protocol support.

Below outlines the issues and support requirements:

DWDM network deployment must transition from mostly point-to-point transport to multi-point and multi-wavelength network. This will allow regional and metro as well as mesh network deployment.

New network architectures and design beyond long haul require more sophisticated IP/DWDM routing with optical cross-connects (OXC), optical ADD/DROP multiplexing (OADM), remote/field testing, performance monitoring, network supervision, fault detection and management.

To support these requirements, more accurate network element/device control, fiber non-linearity management, as well as new supervisory and signaling methodology are needed. Deployment barriers at the all optical layer (both for national & regional WAN/MAN) translate to orders of magnitude increase in network complexity, provisioning, user-tunability, network traffic engineering, control and management.

OA&M requirements further compound the issues with network node management, secured networking, network maintenance & redundancy planning.

Current DWDM deployment/Infrastructure requires expensive switches and capacity planning is difficult. The O-E-O (optical-electrical-optical) 3R Functions (Data Re-timing, Regeneration and Clock Recovery) are very inflexible and expensive.

The O-E-O 3R functions performed between the electrical and optical layers consumes too much power and takes up too much space (inflexibility and lower overall channel capacity). These functions require costly radio-frequency speed ASICs with no signal processing capability for optical data processing.

Like the 3R Function in the electrical layer, the optical layer needs the 3M Functions (Monitoring, Measurement and Management) for performance monitoring and network element/device control. These functions currently require expensive optical and analog control electronics with auxiliary micro-controllers for management.

The 3M functions have outgrown the capability of traditional opto-analog means (assisted by RISC or micro-controllers) which apart from expensive also lacks accuracy, flexibility, reliability and programmability. High level system control/management functions performed with a RISC or micro-controller are typically 100,000 to a million times too slow for sophisticated signal processing.

Inherently the DWDM technology is a multi-channel e.g. multi-wavelength problem that requires wavelength specific solutions. Need optical tagging capability of the individual wavelengths for switching/routing, translation/conversion, cross-connect.

Processing individual channel or Lambda means manipulating optical data directly for signal identification and channel supervision.

Also all Lambdas have to be individually stabilized with channel spacing tracked/locked. Laser diodes, tunable lasers and filters all need more accurate control for stable/reliable field deployment of denser networks. Performance monitoring must also be Lambda specific for multiplexed channels.

Additional fiber non-linearity suppression (e.g. SBS), Xtalk (e.g. SRS) and supervisory functions (which often require a separate wavelength) further complicate the issues.

Multi-wavelength EDFA gain control and equalization requires more complex real-time control algorithm in the presence of channel switching, wavelength add/drop multiplexing or wavelength routing.

New optical signaling methodology is needed for IP over DWDM for Lambda switching/routing, packet routing, optical burst switching and MPL(ambda)S support.

In addition, a low level signaling support is required for the synchronization of the optical data packet and control channels as well as system/node (network Element) management.

Architecture is key to the new Regional WAN/MAN DWDM network deployment. TI can provide a new “hybrid” DWDM component: (DSP+micromirror) technology. The key is to have a new DSP approach for high-density channel card, new micromirror-based wavelength-selectable variable optical attenuator (VOA), and OADM. A new cDSP for the 3M Functions, optical control loop and EDFA gain management.

7.3 DSP Enhanced Optical Networking—A Paradigm Shift

Texas Instruments DSP and micromirror products can be utilized in novel Digital Signal Processing Solutions (DSPS) to improve on the architecture, design, deployment and management of optical networks. The techniques described further filter down to the design and implementation of individual network elements as well as system performance monitoring and device control.

7.3.1 Novel DSP Optical Signal Processing Techniques

To combat the issues discussed above, new DSP optical Signal Processing techniques have been developed to provide the resolution and programmability required in multi-channel DWDM network operations.

New DSP Optical Signal Processing techniques provide new capabilities and performance/price point for quick software programmable field upgrades and the next generation DWDM high-density deployment both at the national and regional (WAN/MAN) levels at lower system cost. Provides high channel density (number of data Lambdas) per card at minimum power dissipation and board space.

New DSP Optical Control/Management Protocol provides better network management, quick and low-cost network provisioning with user-tunability, redundancy planning, channel supervision, network control, remote fault diagnosis and maintenance.

New DSP Optical Signaling Methodology provides a novel DSP packet header using co-channel modulation for all-optical layer optical packet tagging/forwarding/routing/switching, multi-wavelength switching and optical cross-connect, as well as all new optical statistical ADD/DROP MUXs.

New DSP Optical Signaling Methodology can provide all-optical layer support for MPL(ambda)S/

wavelength routing/switching for IP over DWDM. Direct IP switching can save costs by eliminating costly O-E-O layers.

New DSP Optical Signaling supports low-level network protocol, wavelength or channel ID, node ID,

secured communication, system and node (network element) management, multi-wavelength performance monitoring (optical layer 3M Functions for individual Lambdas), as well as optical telemetry/supervisory services.

New DSP Optical Signal Processing techniques from TI allow more accurate device control, faster multi-wavelength EDFA transient and gain control with equalization for wavelength routing, optical add/drop multiplexing, fiber non-linearity suppression (e.g. SBS) and SNR improvement.

7.4 Intelligent Optical Adaptation Layer

7.4.1 Optical Layer Control Channel

Regional, lambda-routed networks will require more intelligent optical layer communications. As described in the previous sections, the IP/MPLS protocols have recently been studied by the IETF for generalization to become the generalized MPLS where L stands for Lambda and not only Label. The MPL(ambda)S protocol implementation and issues have also been discussed. Based on these requirements, the industry has gravitated towards using one separate channel (Lambda) for control and at the same time leaving the implementation details to the optical network vendors.

One way to accomplish this is to assign the supervisory control channel a wavelength that is different from all wavelengths assigned to the optical data channels. If the optical data channels are switched, this control channel must be switched along with the data to the next optical path node. In any event, the supervisory control channel cross-connect has to be transferred to the next optical data cross-connect node even under optical amplifier failure conditions—the transfer has to be guaranteed otherwise there would be no control data available.

Such a control wavelength is suitable for carrying large amount of high-speed control data for high-level network management such as section overhead information that must be received and processed at every network node. However, if the data channels are separate from the supervisory control channel, it is always a possibility that the control channel is totally unaware of any switching failure of the data channels. For example, if the optical space switch in the optical path cross-connect misrouted a data channel but its optical path ID in the control channel is correctly routed to where it is supposed to, the optical path can then be misidentified or failed to be identified by the destination node.

In addition, even if the switching has not failed, there remains the need for data channel synchronization to precisely switch the optical data paths correctly. The proposed Co-Channel Modulation/Signaling methodology to be described in details later on will both address the issues of lambda ID and synchronization.

7.4.2 Flexible Software Architecture

To harness the raw bandwidth of DWDM to build the core of the future network, today's architecture model must be streamlined. There should be no functional overlap between the layers and no outdated functions. Scalable equipment with new functionality must be utilized. One approach is to deploy an intelligent optical adaptation layer between the DWDM physical layer and the IP layer. With an intelligent DWDM software architecture, the scalability and function overlap issues of the four-layer model is eliminated. The flexible IP service layer will only be limited by the scalability of the optical layer.

In right hand side of this new model, SONET/SDH transport gives way to optical transport. Fast restoration (50 ms) is necessary; without it, a significant availability and reliability benchmark set by SONET/SDH would be lost. Bandwidth is provisioned not at TDM granularities, but rather at wavelength granularity.

Salient Features of the above software architecture:

IP/ATM/SONET stack: IP/PPP into the AAL5 layer over SONET e.g. four management layers.

Packet-over-SONET stack: IP/PPP/HDLC into SONET framing e.g. three management layers.

IP-over-DWDM stack: Current model has IP/PPP/HDLC packets directly over optical lightpaths. Major framing and fault recovery concerns for optical adaptation layer if SONET is replaced. Two management layers required.

Direct “Lambda Labeling” with the Generalized MPL(ambda)S protocol stack: This is ultimate goal with packet switching at the IP/MPLS level (electronic switching matrix) and wavelength switching or routing at the Generalized MPLS or MPL(ambda)S level (Wavelength switching/conversion matrix). In principle, there could be multiple fibers in the bundle and therefore another level of fiber switching with a multi-fiber spatial switch or a multi-fiber cross-connect.

The Optical Adaptation Layer is introduced for managing the DWDM channel setups and teardowns. It can also provide some level of protection and/or recovery. Finally, this layer can also introduce its own framing function to replace SONET-type framing. The upper edge of this software layer interfaces to the conventional electronic layers above and the lower edge of the software layer interfaces to the DWDM fiber e.g. the optical transport physical layer.

The DWDM physical layer: Performs functions such as the 3M functions and optical amplification and EDFA gain and switching transient control. Other network element functions include wavelength switching and conversion, optical add/drop and O-E-O conversion at the ingress and egress nodes of the optical networks.

To meet exponential growth rates, rapid provisioning must be an integral part of the new architecture. ATM cell granularity and traffic engineering will be made obsolete by the use of MPLS at the IP level and MPL(ambda)S or the Generalized MPLS for wavelength traffic engineering at the optical adaptation layer. This traffic engineering must be provided or bandwidth provisioning and management at the optical adaptation layer will be manual, too slow, and difficult to grow.

Finally, network restoration will take place at the optical adaptation layer in a fast and scalable manner. The service layer will only be informed of the event if the optical layer cannot restore operation due to lack of transport resources. Then, the service layer will be advised to perform its restoration functions. The two layers will perform in a non-overlapping, predictable, and scalable manner.

7.5 Co-Channel Modulation, Signaling, Frame Synchronization and Control

Photonic networks based on the optical path (lightpath) concept and dense wavelength division multiplexing (DWDM) technology require unique operation, administration, and maintenance (OA&M) functions. These functions, along with network performance monitoring, requires different levels of control and supervisory functions as well as signaling at different layers in the intelligent DWDM architecture described in the previous section.

For example, there are variations of the Co-Channel Modulation/Signaling methodology for the MPL(ambda)S layer and the optical adaptation layer in the IP/MPL(ambda)S over DWDM software architecture as well as that for the DWDM physical all optical layer.

This Co-Channel Modulation/Signaling methodology supports MPLS and tag switching in the electronic layer for IP/MPL(ambda)S over DWDM and optical intra-link communications with or without lasers, EDFA, and micromirror signal modulator. In all cases, the costly O-E-O and 3R functions are by and large avoided. New DSP Optical Signaling Methodology provides optical header for control of forwarding, routing, switching, and statistical Add/Drop Multiplexers.

The optical transport network shown above requires different management information for each transport network sub-layer: the optical path layer, the optical multiplex section sub-layer and the optical repeater section sub-layer. To satisfy all switching protocol e.g. MPL(ambda)S requirements, a separate supervisory control channel is more than likely be required by the various standards.

This means that the control channel has to go through O-E-O conversion at a network node to decode the control data for the data channels in the same fiber. Therefore the control data rate dictates the O-E-O conversion speed and, ultimately, the cost of the control channel. Consequently, if the cost of the O-E-O conversion is too high, it will only make sense for the control channel decoding to be done at a major network element e.g. a network node. Since the control channel is multiplexed over N data channels in the fiber, the speed of the control channel has to be N times that for a single data channel. On the other hand, if the control data rate is not that high, some optical network vendors will end up using the rest of the channel bandwidth for carrying data traffic.

Since the control data travels on a separate wavelength (different delay), another issue to contend with is the synchronization of its operation with the data channels. For example, if the control data decoded by a switching node indicates that a specific data channel has to be switched, then channel switching has to be synchronized with the start of an optical layer frame or packet in the data channel. Otherwise improper switching operations and data loss would result. Therefore, synchronization or control data has to be combined with the specific data channel for switching or routing.

Such control or synchronization data is provided by a novel Co-Channel Modulation scheme with a DSP. This Co-Channel Modulation is both linear in nature and can carry digital information in compressed format to provide hooks for supporting the MSL(ambda)S protocol. Optical label forwarding and/or wavelength switching is done with the help of this Co-Channel Modulation which provides an optical header with wavelength or Lambda ID, node ID and control info (e.g. gain control, number of wavelength present in the lightpath). In addition, any specific wavelength can be traced or tracked by tagging it will a label modulated on the channel data with the above Co-Channel Modulation technique.

New DSP Optical Signaling & Lambda Tagging supports:

Channel ID and Node ID

Secured communication

Optical telemetry and supervisory services

Supervisory Signaling by Co-Channel Modulation Permits:

Lambda-specific synchronization

Lambda-specific performance monitoring

7.5.1 Co-Channel λ-Selective Data Synchronization

DWDM control wavelength has to be synchronized with the data channels. A synchronization Preamble bit is intensity modulated (IM) at approximately 5 to 15% of optical data extinction ratio onto the specific optical data channel (lambda).

Each lambda has a unique frequency for the Preamble and Control data bits. IM modulation is linearly superimposed onto DWDM optical data via injection current dithering. Control data bits are digital modulation via binary OOK.

The Preamble is at least one NRZ bit modulating one frequency (lambda ID and packet sync) in the range of 10 k to 100 kHz (1 MHz possible with higher speed DSP). The Control data is least one NRZ bit modulating same frequency (lambda control). RZ format is shown.

The Co-channel Synchronization or Preamble bit and Control data bits can be easily detected with low-cost photodiode followed by a band-limited A/D conversion for DSP processing. A channel bandpass digital filter is used.

If N adjacent channels (similar delays) are used, N times the Control data rate can be achieved. For example, 8 wavelengths each with a Control byte give 8 bytes total.

Protocol Format: Preamble and Control Header

Preamble—A single digital data bit encoded with a unique frequency and linear modulation for:

Synchronization (synchronous switching/routing/conversion/detection of wavelengths).

Lambda (wavelength ID) Identification

Specific channel or wavelength tagging for tracking and tracing purposes

Synchronization Preamble bit can be a simple tone representing a binary bit.

Control header binary data bits are superimposed on individual lambdas each with its unique Preamble frequency and linear modulation for:

Lambda destination address, lambda tracking, optical packet forwarding, switching, tagging, bursting and multiplexing (e.g. statistical optical multiplexers).

Statistical Multiplexing is done with optical packet switching when user channel has new data. Asynchronous bursting of packets will also be possible.

7.5.2 Co-Channel 1-out-of-n IM Modulation

After the Synchronization Preamble, and instead of Control data bits, each DWDM wavelength can also be modulated with a set of n frequencies for an n-bit digit e.g. compressing n bits in one bit time.

For example, a set of 16 frequencies will give a Hex digit for each time period equal to that of the Preamble/Synchronization bit. This is a 1-out-of-16 IM modulation.

IM modulation is linearly superimposed onto DWDM optical data via injection current dithering. Control data bits are digital modulation via binary OOK.

The Control data is at least one NRZ bit modulating 1-out-of-16 frequencies (Node ID) in the range of 10 k to 100 kHz. RZ format is shown in the example.

The Co-channel-out-of-n Modulation can be easily detected with low-cost photodiode followed by a band-limited A/D conversion and a 1-out-of-16 digital bandpass filter.

7.5.3 Co-Channel m-out-of-n IM Digit Modulation

DWDM optical data can be treated as an optical carrier at 10 Gbps (e.g. OC-192). Control signal is intensity modulated (IM) at approximately 5 to 15% of data extinction ratio.

IM modulation is linearly superimposed onto DWDM optical data. Baseband control data is digital modulation with a Preamble and a Header field.

The IM signal linear modulates the DWDM data while the control baseband data (Preamble/Header) further digitally modulates the IM signal.

The Preamble is at least one NRZ bit modulating one frequency (Wavelength ID and packet sync) in the range of 10 k to 100 kHz. The Header is at least one NRZ bit modulating m frequencies each out from one out of m groups of n unique frequencies (Node ID and control) in the range of 80 k to 200 kHz.

The Co-channel modulation can be easily detected with low-cost PIN or photodiode followed by a band-limited A/D conversion for DSP processing.

The Preamble can be detected with a narrow-band band-pass filter while the Header can be detected with a High-band and Low-band band-pass filters.

7.5.4 Co-Channel 2-out-of Hex Digit Modulation

Special case of the m-out-of-n IM Digit Modulation with m=2 and n=4 e.g. two groups of four unique frequencies.

Each digit is made up of one frequencies from each of the two groups of four frequencies e.g. 2-out-of-8 (m×n=2×4=8 total and unique frequencies).

The Preamble is at least one NRZ bit modulating one frequency (Wavelength ID and packet sync) in the range of 10 k to 100 kHz. The Header is at least one NRZ bit modulating two frequencies (Node ID and control) in the range of 80 k to 200 kHz.

The Co-channel modulation can be easily detected with low-cost PIN or photodiode followed by a band-limited A/D conversion for DSP processing.

The Preamble can be detected with a narrow-band band-pass filter while the Header can be detected with a High-band and Low-band band-pass filters.

7.5.5 Co-Channel Digital Linear Hex Digit IM Modulation

Protocol Format: Preamble and Control Header

Preamble—A single digital data bit or multi-bit symbol encoded with linear tone modulation for:

Synchronization (synchronous switching/routing/conversion/detection of wavelengths).

Lambda (wavelength ID) Identification

Specific channel or wavelength tagging for tracking and tracing purposes

Synchronization Preamble bit can be a simple tone representing a binary bit.

Synchronization Symbol (transmitted in the same bit time interval) can be N-bit where the symbol binary value is one out of 2 to the power of N (e.g. 2**N) frequencies. For a 4-bit symbol, there are 16 unique frequencies required for encoding. An 8-bit symbol needs 256 unique frequencies. Alternatively, an 8-bit symbol can be broken down to two 4-bit symbols each requiring one out of 16 unique frequencies. The 8-bit symbol can be transmitted in two Preamble bit intervals or one if the 16 frequencies are high enough for decoding in one bit interval.

Control header info is encoded with linear dual tone modulation for:

Network element (e.g. Node ID) Identification

Each node has a set of eight frequencies (non-harmonically related to other node frequencies)

Control data is encoded as HEX digits. Each digit is comprised of two frequencies out of eight.

The control header info is for packet forwarding, switching, tagging, bursting and multiplexing (e.g. statistical optical multiplexers).

Since each node has a unique set of dual tones, old packet switching info can be overwritten with new header info without being erased first.

Protocol is such that node A to node B will be encoded with node A set of unique eight frequencies and new switching info from node B will be encoded with node B set of unique eight frequencies.

Tag switching is done by overwriting old tag in node A frequencies with a new tag in node B frequencies.

Statistical Multiplexing is done with packet switching when user channel has new data.

7.5.6 Summary of Co-Channel Modulation Schemes

DWDM control wavelength has to be synchronized with the data channels. A synchronization Preamble bit is used to synchronize the specific optical data channel (lambda) for switching.

Each lambda has a unique frequency for the Preamble and Control data bits. Co-Channel Modulation is decoded for lambda ID, tracking, lambda-specific performance monitoring (e.g. power spectrum measurement & equalization).

Co-Channel Modulation is linear (10 K to 1 MHz) vs. traditional non-linear RF (GHz) Subcarrier modulation. More bandwidth efficient compared to the double sideband requirement of Subcarrier modulation.

Subcarrier modulation has to be a higher frequency than the optical data baseband. This represents another expensive RF O-E-O conversion issue.

The Co-channel Control data bits can be easily detected with low-cost photodiode followed by a band-limited A/D conversion for high precision DSP processing. More cost-effective and no optical beat frequencies.

Compressed data modulation and parallel DWDM transmission possible with N adjacent channels to increase effective data rate. SBS suppression as a by product to reclaim SNR with small line width dilation vs. GHz subcarriers.

| Preamble | Power of SBS | Effective |
|---|---|---|
| (NRZ) Frequency | (Pump = +15.4 dbm, Leff = 40 km) | Linewidth |
| 1.0 kHz | −37 dbm | 900 MHz |
| 2.0 kHz | −42 dbm | 800 MHz |
| 3.0 kHz | −45 dbm | 750 MHz |
| 5.0 kHz | −55 dbm | 600 MHz |
| 6.0 kHz | −55 dbm | 500 MHz |
| 7.0 kHz | −62 dbm | 500 MHz |
| 9.0 kHz | −62 dbm | 450 MHz |
| 10.0 kHz | −62 dbm | 400 MHz |
| 20.0 kHz | −55 dbm | 300 MHz |
| 30.0 kHz | −47 dbm | 250 MHz |
| 40.0 kHz | −42 dbm | 250 MHz |
| 50.0 kHz | −42 dbm | 200 MHz |
| 100.0 kHz | −42 dbm | 200 MHz |

7.6 Optical Components for Co-Channel Modulation/Demodulation

Supervisory Signaling by Co-Channel Modulation Permits:

lambda-specific power spectrum analysis

lambda-selective Variable Optical Attenuation

lambda-selective gain equalization

Optical intra-link communications without lasers and without OEO

Micromirror Modulator can save cost and complexity of an additional laser

Micromirror Modulator can be used for inter-span EDFA communication

Control signal is intensity modulated (IM) at (10%) of data extinction ratio by sinusoidally varying (shutting off) 10% of the micromirror mirrors in a random pattern

Micromirror switching rate can be quadrupled by switching mirrors at 1.25% increments at 4us intervals e.g. 8 different sets of 1.25% mirrors will be switched per cycle

If micromirror switching cycle time is 16 us, the effective modulation period is 4 us.

Optical intra-link communications without lasers and without OEO

Micromirror Modulator can save cost and complexity of an additional laser

Micromirror Modulator can be used for inter-span EDFA communication

7.6.1 Outline of Supervisory Signal Transmission

7.7 Intelligent Optical Network Transport with Wavelength Routing

To build and scale new optical networks, a wavelength router interconnects backbone routers directly through optical paths to provide both reliable wavelength transport and wavelength-level traffic engineering (FIG. 7.3). With intermediate SONET/SDH and ATM devices eliminated, only two switching elements—the wavelength router and the IP router—are needed in the long-haul optical infrastructure with DWDM terminals. The architectural division of labor between the two is clear and highly efficient. The IP router grooms packets from DS-1, DS-3, OC-3, and OC-12 flows to OC-48c or OC-192c streams. The wavelength router maps these streams to wavelengths for end-to-end transport across the network. As traffic increases, additional wavelengths are provisioned between appropriate router pairs. More generally, multiple traffic types, including data (IP and other), voice, leased-line, and video can be carried across the optical network created by the Wavelength Router by attaching not only IP routers, but SONET/SDH/SDH elements, ATM switches, or any other service platform that requires access to multi-gigabit transport. Finally, the wavelength router in a mesh network delivers better bandwidth efficiencies than ring topologies, where utilization rates are limited to 75 to 80 percent of the ring capacity due to unbalanced traffic loads.

Optical Add/Drop Multiplexers and Optical Cross-Connects

Other optical transport devices will continue to exist as well. One such device is the Optical Add/Drop Multiplexer (OADM)—the optical counterpart to the SONET/SDH ADM. The OADM is most suitable for metropolitan-area applications, but it is not suited for the core connectivity network element, despite its significant scale advantage over SONET/SDH ADM. The OADM, as a core network element, still requires the creation of rings with their bandwidth inefficiencies. Provisioning OADMs is a manual process, and traffic-engineering capabilities are not built in. The OADM is a small port-count device. Consequently, at large junction points, the OADM causes blocking since many OADMs must be hooked up in parallel to get connectivity.

In the SONET/SDH network, vendors have provided digital cross-connects to support this type of large junction connectivity for TDM traffic at DS-3 or STS-1 granularity, and another element, the optical cross-connect (OXC), can provide this same functionality at the optical layer. It will provide scalable, non-blocking port density. However, the OXC is only self-aware; it does not have the intelligence to make network-wide decisions (FIG. 7.4). Provisioning and traffic engineering of OXCs has to be done manually, which limits the pace at which the network can scale. The ability to add network awareness to the OXC through a routing algorithm and to provision end-to-end paths intelligently would result in a device comparable to an intelligent wavelength router, another way of defining the wavelength routing solution (FIG. 7.5). A wavelength router provides an intelligent optical layer with quick end-to-end provisioning, fast restoration, indefinite scalability, and bandwidth efficiency. It eliminates functional overlap with the service layer network.

Wavelength routing does not prevent the use of SONET/SDH or optical rings. On the contrary, the two are complementary, and the Wavelength Router supports ring capabilities for access as well as for phased migration from a ring-based core to a mesh network. OADMs, in particular, serve as a means for delivering multi-gigabit bandwidth to metropolitan areas. This bandwidth is then aggregated at a local Wavelength Router for transport across the core network.

7.8 Optical Network Management System

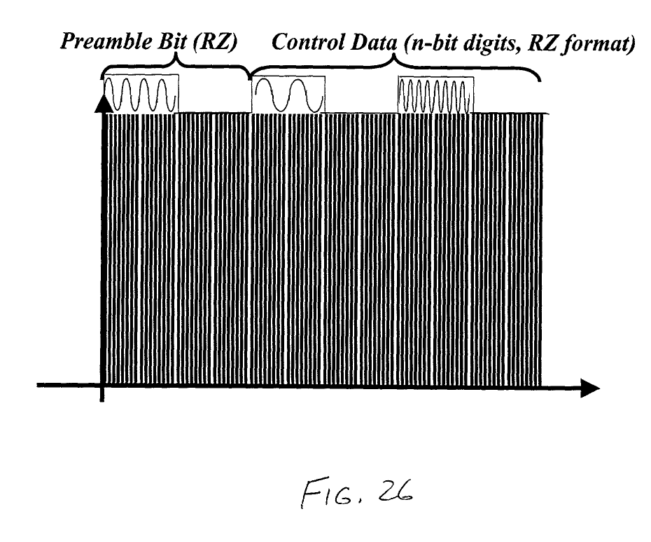

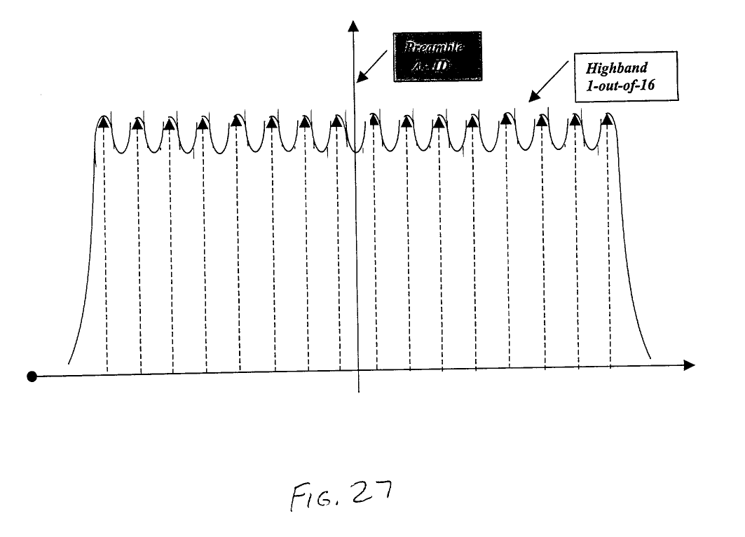

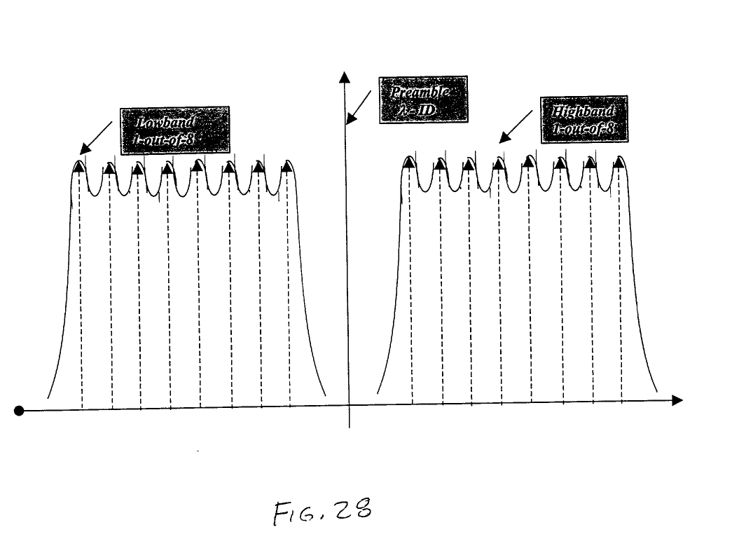

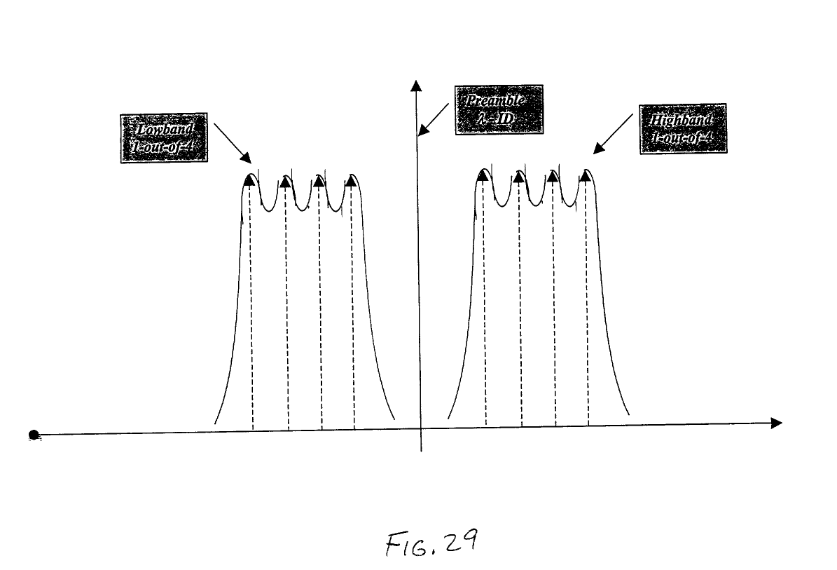

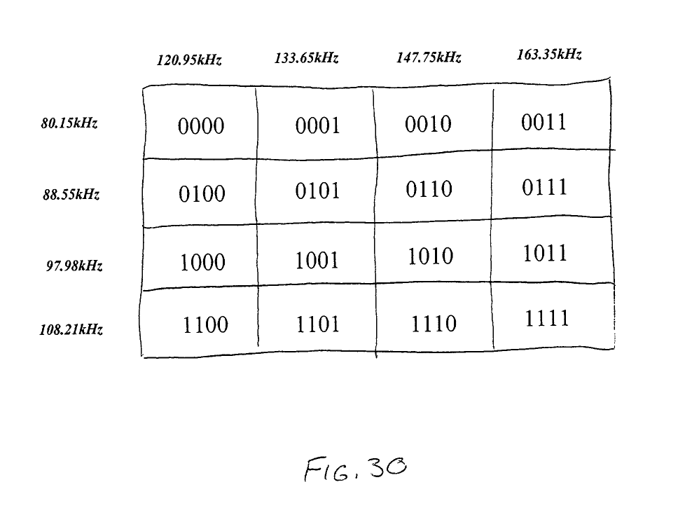

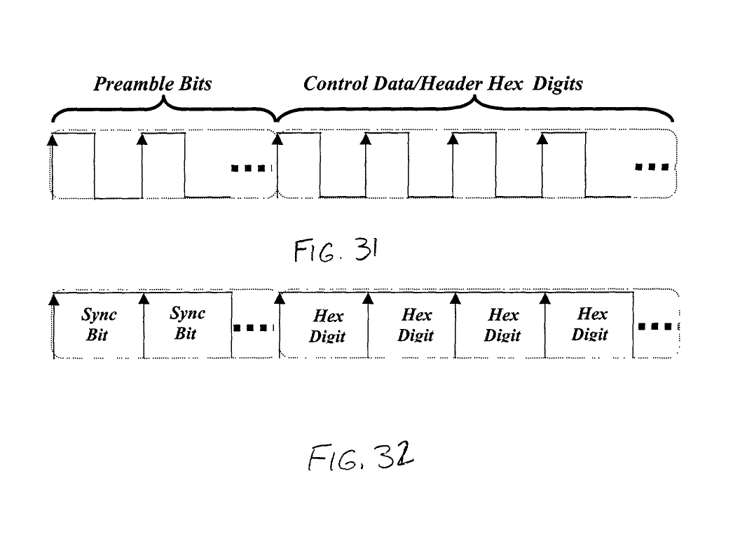

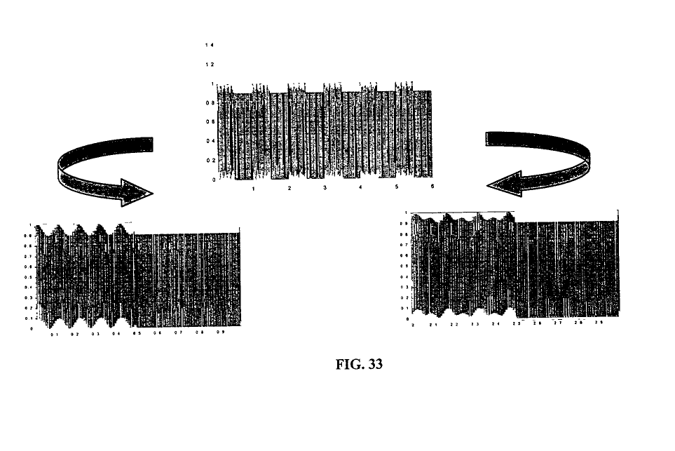

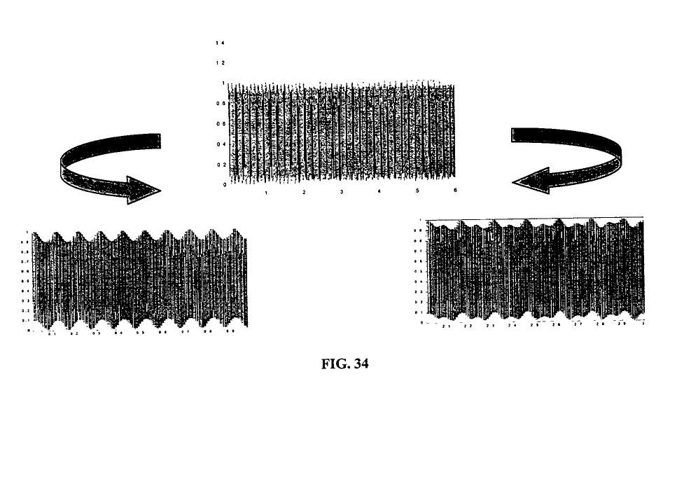

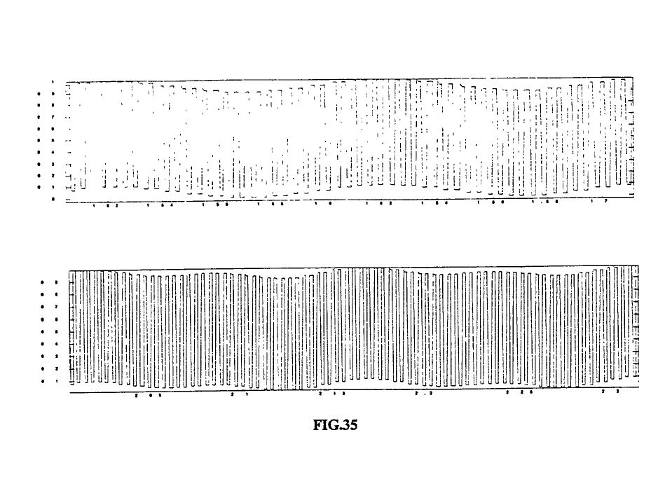

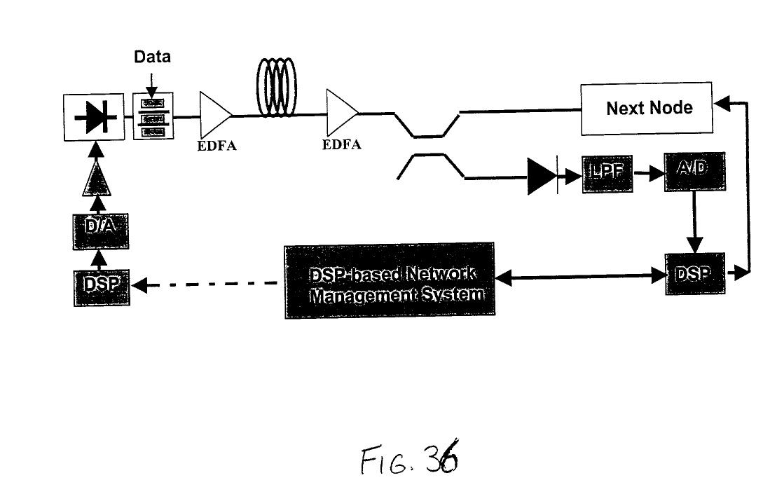

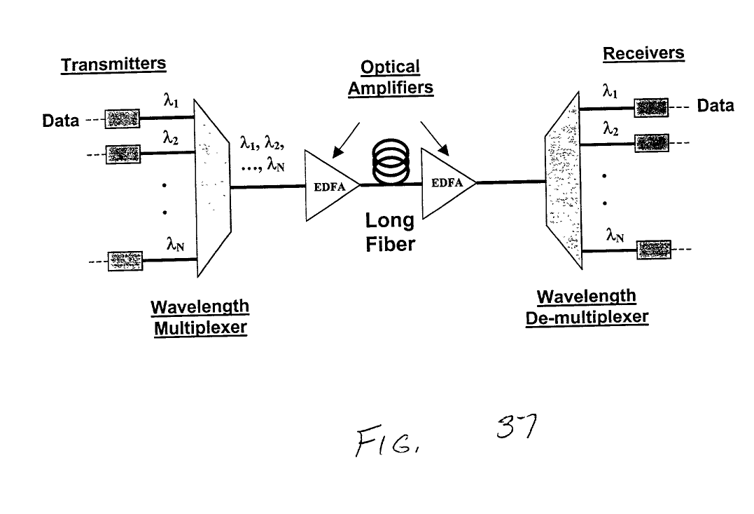

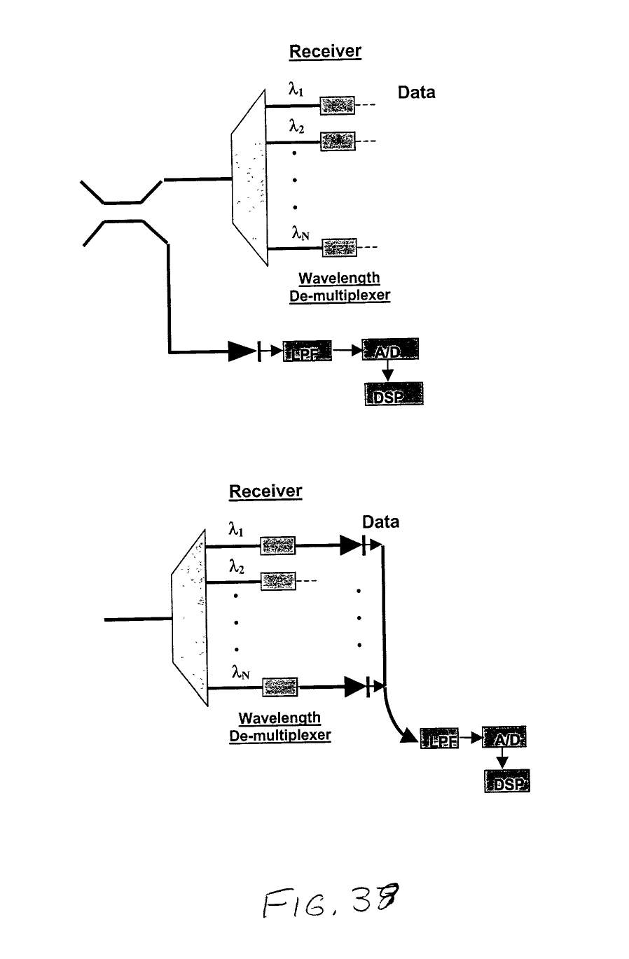

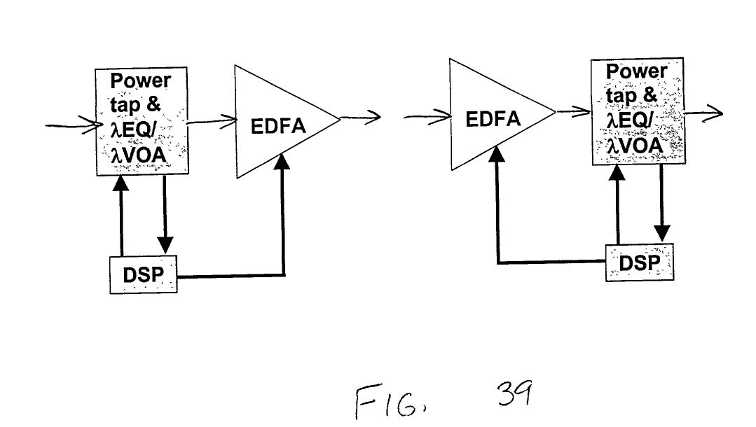

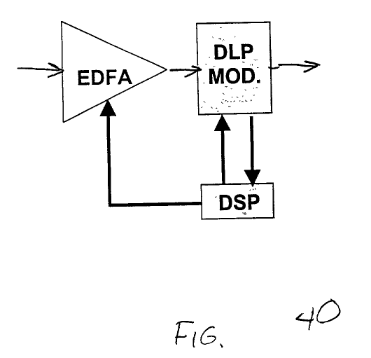

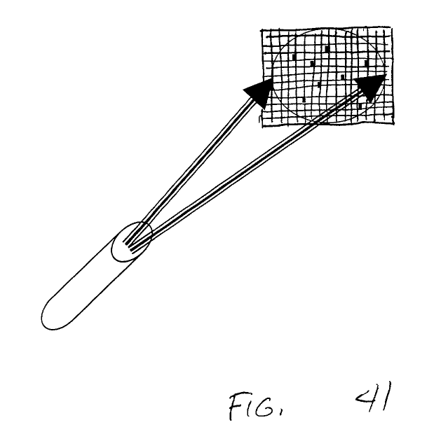

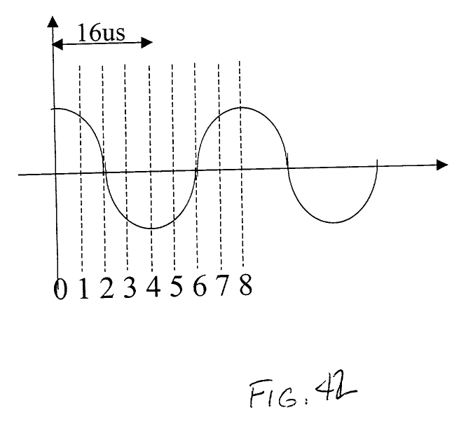

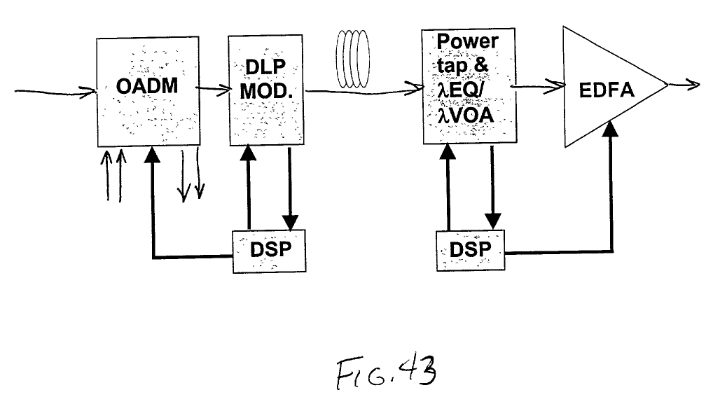

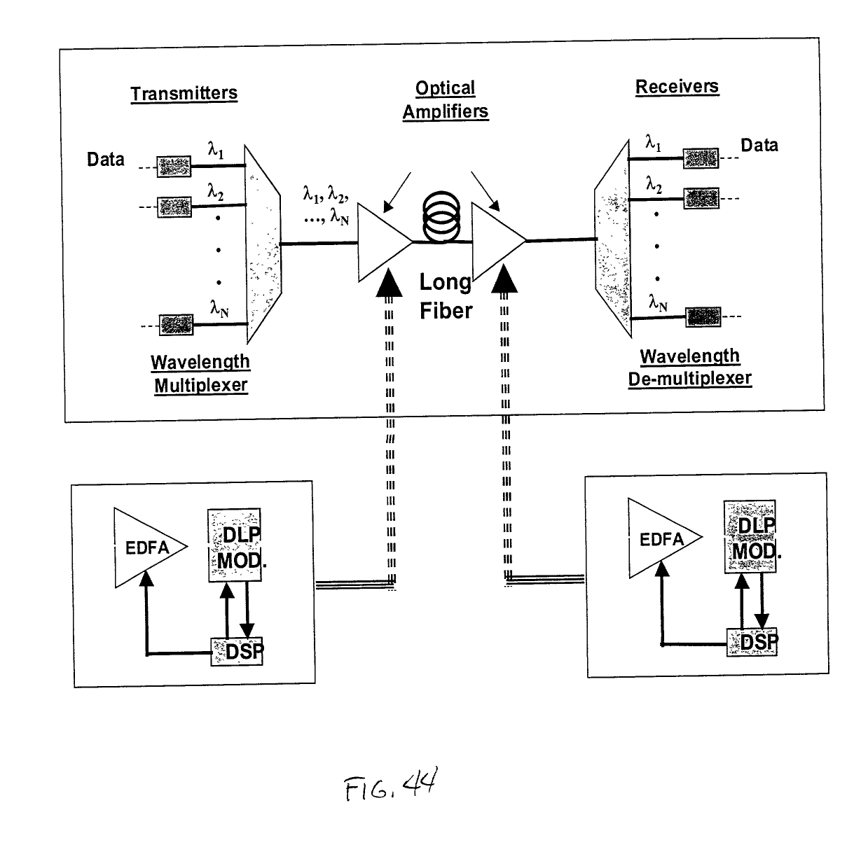

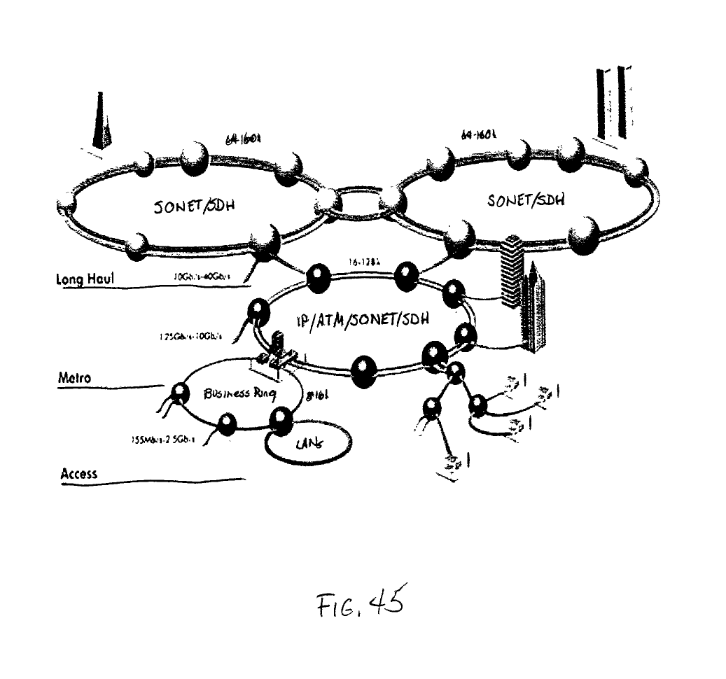

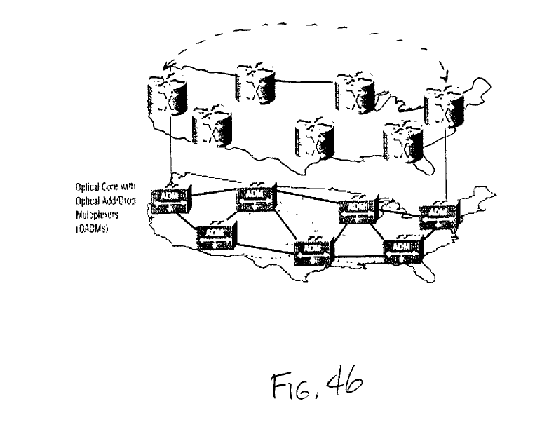

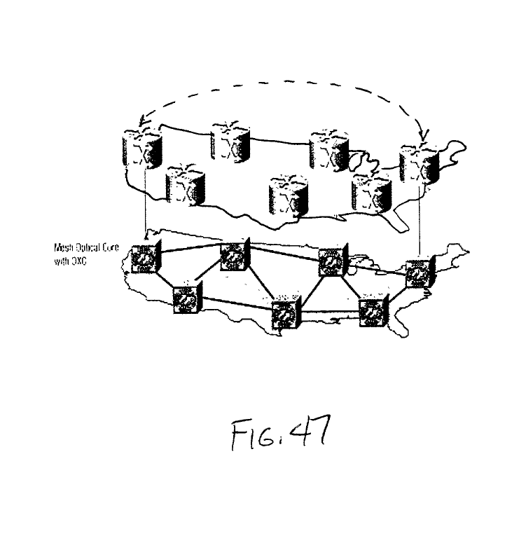

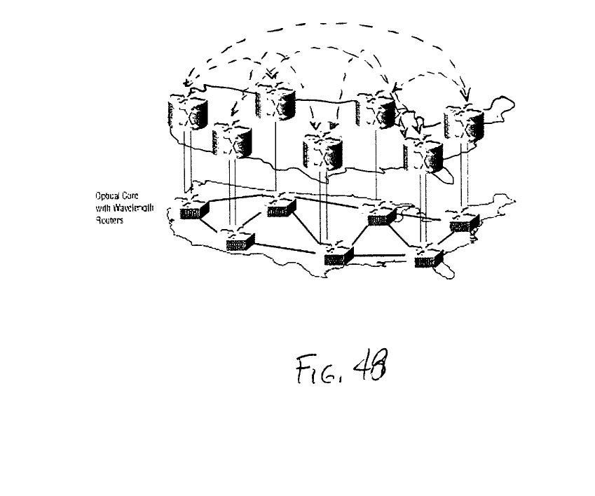

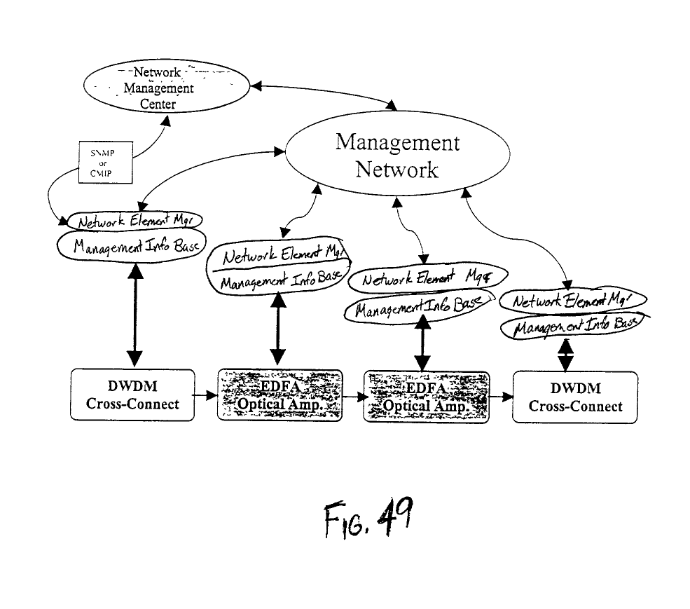

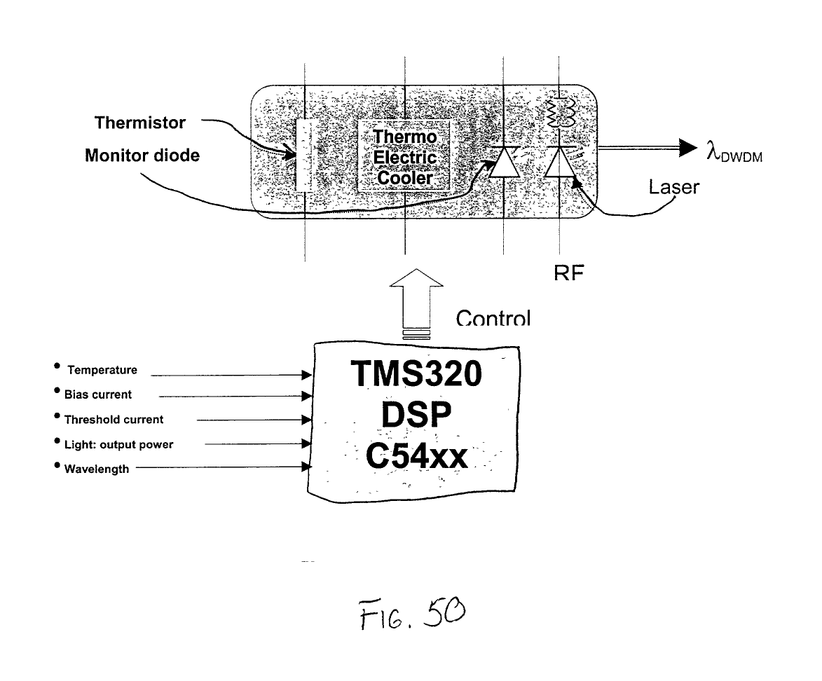

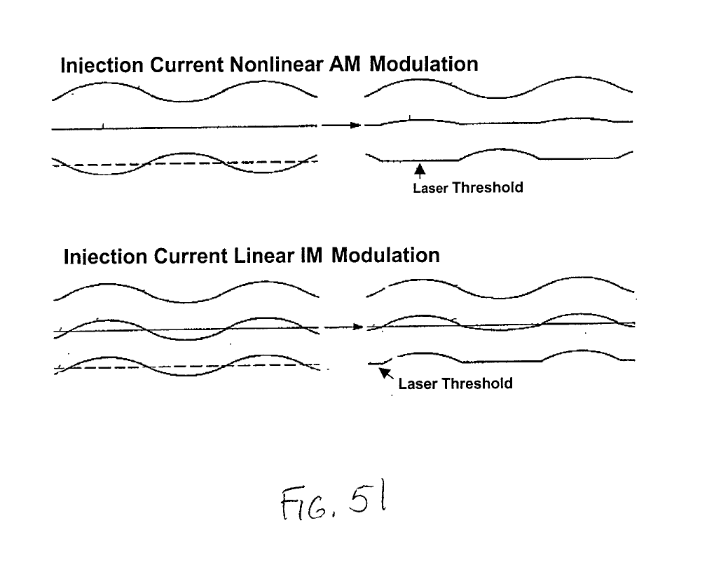

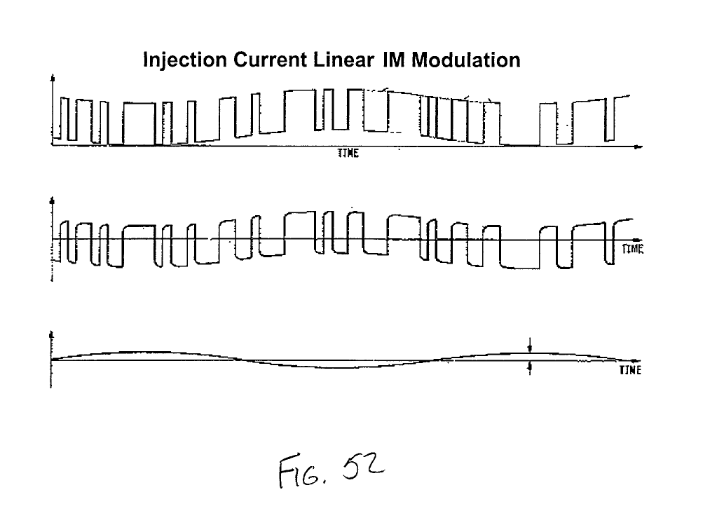

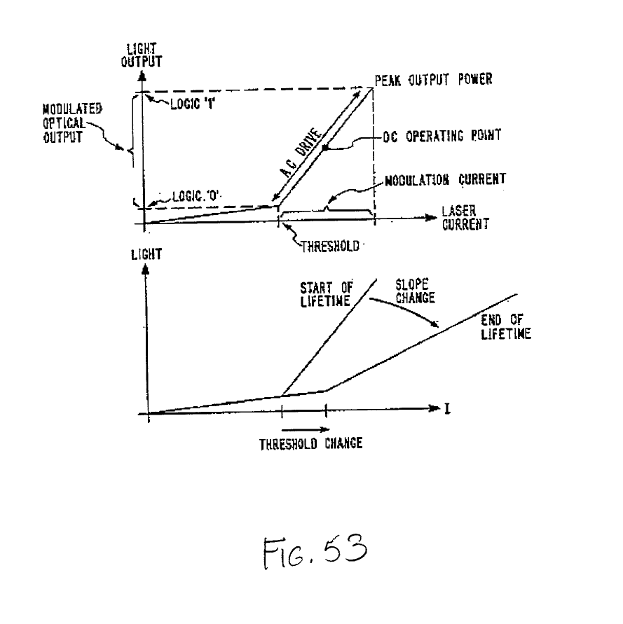

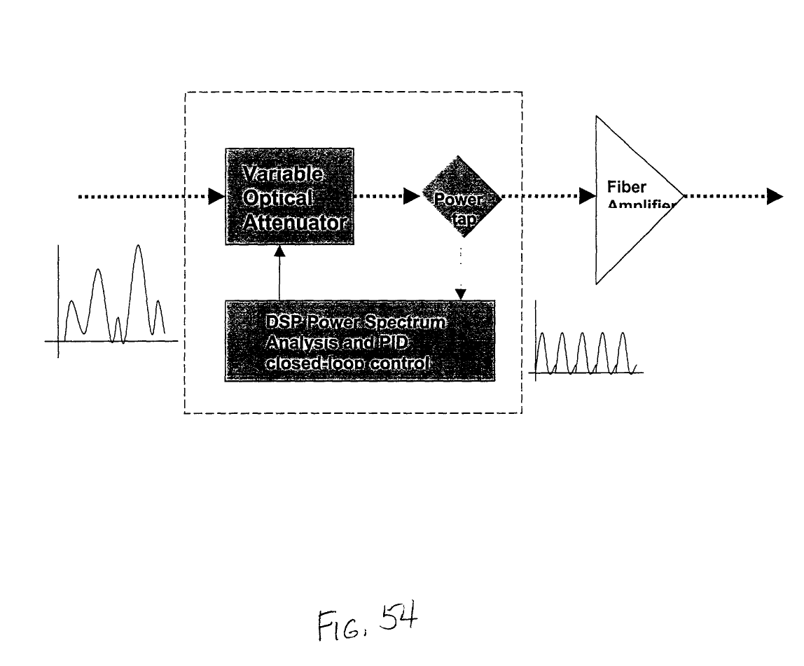

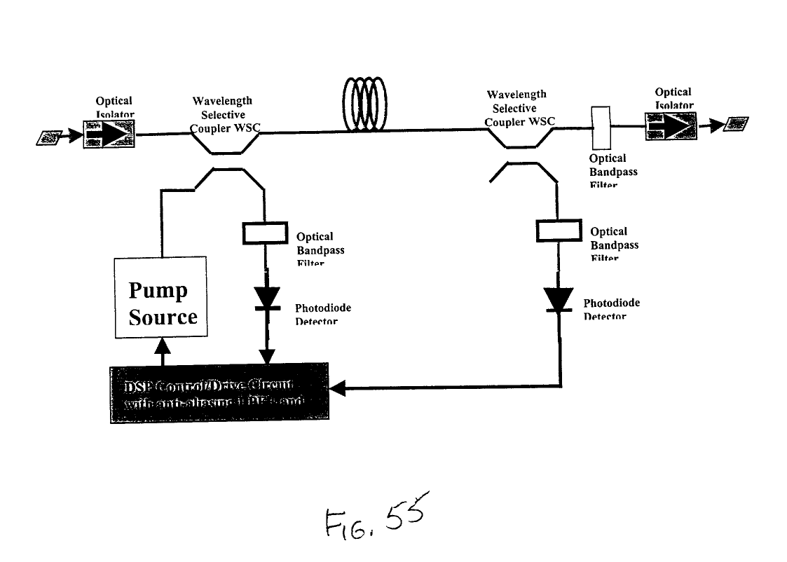

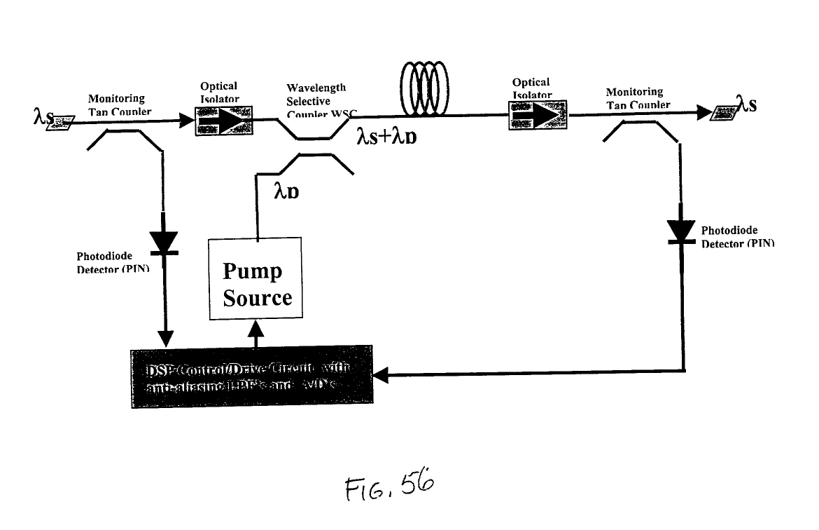

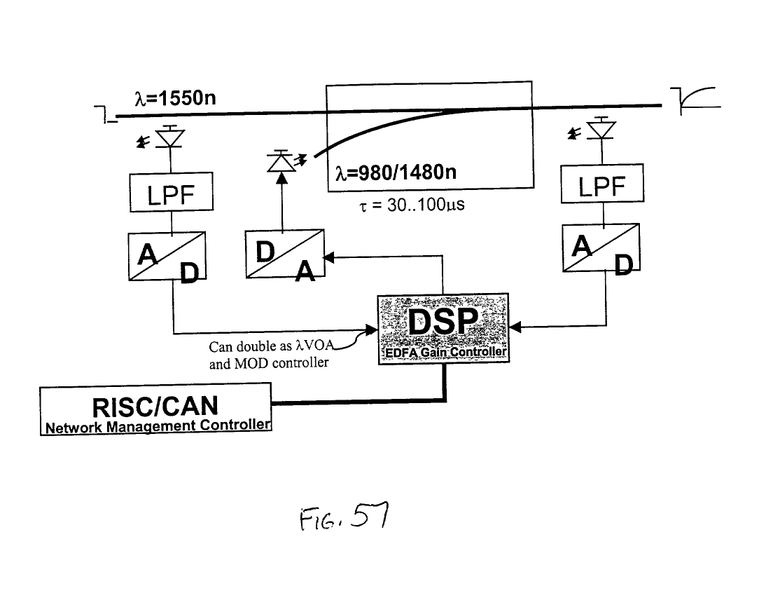

FIG. 25 gives an overview of how network management functions are deployed in a typical network. The individual network elements have their corresponding network element managers. Network elements are optical components such as optical amplifiers such as erbium doped fiber amplifiers (EDFA), optical cross-connects (OXC) and optical add/drop multiplexers (OADM). Also, each network element has a built-in agent which communicates with its network element manager. Typically, the agent is a software driver running on a microprocessor or a high-level DSP processor. The network element managers in turn communicate with a network management center through a management network. The communication between an agent and its manager may use an out-of-band network or one of the wavelengths (in-band or out-of-band) in the network as a supervisory/control channel. The information to be managed for each network element is represented in the form of a management information base (MIB). The MIB contains a set of variables representing the information to be managed. The information required or managed is for Configuration Management (both Equipment and Connection), Performance Monitoring, Fault Diagnosis (both Protection and Restoration), Security and Accounting Management. These variables will include various operating parameters to be monitored by the agent and the manager, as well as several parameters that are set by the manager to control the network element. The are two primary standards relating to network management. For the Internet world, a management framework based on the Simple Network Management Protocol (SNMP) is typically used. SNMP runs on top of the TCP/IP protocol stack and the network center manager communicates with the agents using SNMP. For the carrier world, a management framework called the Telecommunication Management Network (TMN) can be used. In TMN, the Common Management Information Protocol (CMIP) will be used. CMIP runs on top of the OSI protocol stack. OSI stands for Open Systems Interconnection.

7.8.1 Distributed Decentralized Intelligence

Decentralization allowed the flow of computing power to scale rapidly, then drove needs for connectivity between these systems. In the Internet age, centralized network management systems and network intelligence will also fade away much as earlier mainframe systems did, and more intelligent, network-aware systems will dominate. Distributed networking, like distributed computing, will allow networks to rapidly scale up in capacity and won't be limited by the ability of support systems (including technicians) to manage growth.

Most carriers' profitability is driven by their ability to lower the operational costs of their overall networks. Wavelength routing elements radically change the way bandwidth is managed, provisioned, and restored, thus reducing operations cost in a fundamental way. In addition to providing cost-effective architectures, a wavelength routing device attacks the high operational costs of managing data bandwidth in the traditional way. New wavelength routing technology builds on intelligent systems that are network-aware and can leverage optical internetworking in carrier networks. This flexible approach allows technology upgrades of computing platforms and software without impacting the network. Wavelength routing systems can support client-server applications where applicable for operations, maintenance, and provisioning.

Wavelength routing elements use distributed intelligence in the system architecture as well as the network to provide a platform for rapid service provisioning and restoration. There are direct, established communication paths between wavelength routing systems such that each element knows the configuration of the network and its neighboring systems. A wavelength routing system is truly a network-aware device. It knows the network configuration as well as the available bandwidth and configurations of the other nodes in the network.

A wavelength router is a network-aware device because the network is the database. It is inherently based on using distributed intelligence in the network in the tradition of IP routers. And clearly, any new optical technology must leverage the power of optical internetworking. True wavelength routing systems will predominate optical networking because they will trigger a move to a new operating model that is more cost effective, less labor intensive—one that leverages IP routing and ATM switching.

As carriers build wavelength-routed networks, they will provide new services by means of a simpler architecture, they will enjoy radically lower operational costs, and they will deliver superior service velocity. Moreover, they will be well positioned to meet the requirements of a rapidly growing but unpredictable network.

7.8.2 Link Performance

Need to manage each lambda for signal identification, channel supervision and suppression of fiber non-linearity (e.g. SBS). Non-linear optical signal processing in improved signal-to-noise margin in the presence of SBS and SRS Xtalk.

New DSP Optical Signal Processing techniques allow:

Faster EDFA transient and gain control with equalization

Fiber non-linearity suppression (SBS), SNR improvement

SRS cross-talk detection and management

Easy, low-cost network provisioning with user tunability, redundancy planning channel supervision and control, remote fault diagnosis and maintenance, improved wavelength tuning and stability.

7.8.3 Performance Monitoring

The 3M functions and nonlinear device control. 3M Functions (Optical Measurement, Monitoring and Management) for provisioning, user-tunability, secured optical networking, diagnostics and redundancy planning.

7.8.4 Device Control

Lasers and filters need more accurate control for stable and reliable deployment of denser networks.

Gain Control: Faster gain control and equalization of individual EDFAs in the optical chain to avoid optical transients and component failure.

Lambda Issues: Optical tagging of individual wavelengths for switching/routing, etc. Wavelength channel spacing must be monitored and stabilized.

Thus, although there has been disclosed to this point a particular embodiment for co-channel modulation and a method therefore, it is not intended that such specific references be considered as limitations upon the scope of this invention except insofar as set forth in the following claims. Furthermore, having described the invention in connection with certain specific embodiments thereof, it is to be understood that further modifications may now suggest themselves to those skilled in the art, it is intended to cover all such modifications as fall within the scope of the appended claims. In the following claims, only elements denoted by the words “means for” are intended to be interpreted as means plus function claims under 35 U.S.C. §112, paragraph six.

What is claimed is:

1. A method of providing network configuration data, the method comprising:
receiving a data-carrying optical signal;
providing control information;
modulating said data-carrying optical signal using said control information such that said optical signal carries both said data and said control information; and
transmitting said modulated optical signal.

2. The method of claim 1, wherein said modulating said data-carrying optical signal using said control information such that said optical signal carries both said data and said control information comprises:
providing said data-carrying optical signal to a spatial light modulator comprised of an array of modulator elements; and
providing said control data to said spatial light modulator array, said control data determining the state of said modulator elements such that said spatial light modulator modulates said optical signal.

3. The method of claim 2, wherein said providing said data-carrying optical signal to a spatial light modulator comprises:
providing said data-carrying optical signal to a digital micromirror device.

4. The method of claim 2, wherein said providing said control data to said spatial light modulator array, said control data determining the state of said modulator elements such that said spatial light modulator modulates said optical signal comprises:
providing said control data to said spatial light modulator array, said control data determining the state of said modulator elements such that said spatial light modulator modulates said optical signal at a 5% to 15% extinction level.
